(19) United States
(12) Patent Application Publication
(10) Pub. No.: US 2017/0250771 A1
(43) Pub. Date: Aug. 31, 2017

(54) SYNTAX AND SEMANTICS FOR DEVICE CAPABILITIES

(71) Applicant: Sharp Kabushiki Kaisha, Sakai-City, Osaka (JP)

(72) Inventor: Sachin G. DESHPANDE, Camas, WA (US)

(21) Appl. No.: 15/507,781

(22) PCT Filed: Sep. 7, 2015
(86) PCT No.: PCT/JP2015/004529

§ 371 Date: Mar. 1, 2017

Related U.S. Application Data
(60) Provisional application No. 62/046,771, filed on Sep. 5, 2014.
(60) Provisional application No. 62/049,905, filed on Sep. 12, 2014.
(60) Provisional application No. 62/066,831, filed on Oct. 21, 2014.

(51) Int. Cl. H04H 60/72; H04H 60/13; H04N 21/435

(52) U.S. Cl. CPC H04H 60/72; H04N 21/435; H04H 60/13

(57) ABSTRACT

A method for receiving a device capability associated with a service guide is described. The method may include (a) receiving a content fragment within said service guide; (b) receiving capabilities syntax element within said content fragment that indicates required capabilities for decoding and presenting signaled content; (c) wherein said capabilities syntax element includes: (i) an element capability code (ccode) that represents a certain capability or capability group defined by 1 to 4 hexadecimal digits (1*4HEXDIG); (ii) an element capability string code (capability_string_code) having a first operand (ubyte) that represents a registry identified by capability category code and a second operand (1*utf8) that specifies a capability or capability group within said registry, where said first operand (ubyte) is defined as 1 to 3 digits (1*3DIGIT) and said utf8 is defined as one or more UTF-8 characters (*(UTF8-char)); (d) decoding said service guide.

### TECHNICAL FIELD

The present disclosure relates generally to a service guide.

### BACKGROUND ART

A broadcast service is capable of being received by all users having broadcast receivers. Broadcast services can be roughly divided into two categories, namely, a radio broadcast service carrying only audio and a multimedia broadcast service carrying audio, video and data. Such broadcast services have developed from analog services to digital services. More recently, various types of broadcasting systems (such as a cable broadcasting system, a satellite broadcasting system, an Internet based broadcasting system, and a hybrid broadcasting system using both a cable network, Internet, and/or a satellite) provide high quality audio and video broadcast services along with a high-speed data service. Also, broadcast services include sending and/or receiving audio, video, and/or data directed to an individual computer and/or group of computers and/or one or more mobile communication devices.

In addition to more traditional stationary receiving devices, mobile communication devices are likewise configured to support such services. Such configured mobile devices have facilitated users to use such services while on the move, such as mobile phones. An increasing need for multimedia services has resulted in various wireless/broadcast services for both mobile communications and general wire communications. Further, this convergence has merged the environment for different wire and wireless broadcast services.

Open Mobile Alliance (OMA), is a standard for interworking between individual mobile solutions, serves to define various application standards for mobile software and Internet services. OMA Mobile Broadcast Services Enabler Suite (OMA BCAST) is a specification designed to support mobile broadcast technologies. The OMA BCAST defines technologies that provide IP-based mobile content delivery, which includes a variety of functions such as a service guide, downloading and streaming, service and content protection, service subscription, and roaming.

The foregoing and other objectives, features, and advantages of the invention will be more readily understood upon consideration of the following detailed description of the invention, taken in conjunction with the accompanying drawings.

### SUMMARY OF INVENTION

According to the present invention, there is a provided a method for receiving a device capability associated with a service guide: (a) receiving a content fragment within said service guide; (b) receiving capabilities syntax element within said content fragment that indicates required capabilities for decoding and presenting signaled content; (c) wherein said capabilities syntax element includes: (i) an element ca-pability code (ccode) that represents a certain capability or capability group defined by 1 to 4 hexadecimal digits (1*4HEXDIG); (ii) an element capability string code (capability_string_code) having a first operand (ubyte) that represents a registry identified by capability category code and a second operand (1*utf8) that specifies a capability or capability group within said registry, where said first operand (ubyte) is defined as 1 to 3 digits (1*3DIGIT) and said utf8 is defined as one or more UTF-8 characters (*(UTF8-char));(d) decoding said service guide.

### BRIEF DESCRIPTION OF DRAWINGS

FIG. 1 is a block diagram illustrating logical architecture of a BCAST system specified by OMA BCAST working group in an application layer and a transport layer.

FIG. 2 is a diagram illustrating a structure of a service guide for use in the OMA BCAST system.

FIG. 2A is a diagram showing cardinalities and reference direction between service guide fragments.

FIG. 3 is a block diagram illustrating a principle of the conventional service guide delivery method.

FIG. 4 illustrates description scheme.

FIG. 5 illustrates a ServiceMediaExtension with MajorChannelNum and MinorChannelNum.

FIG. 6 illustrates a ServiceMediaExtension with an Icon.

FIG. 7 illustrates a ServiceMediaExtension with a url.

FIG. 8 illustrates a ServiceMediaExtension with MajorChannelNum, MinorChannelNum, Icon, and url.

FIG. 9A illustrates AudioLanguage elements and TextLanguage elements.

FIG. 9B illustrates AudioLanguage elements and TextLanguage elements.

FIG. 9C illustrates AudioLanguage elements and TextLanguage elements.

FIG. 10A illustrates AudioLanguage elements and TextLanguage elements.

FIG. 10B illustrates AudioLanguage elements and TextLanguage elements.

FIG. 10C illustrates AudioLanguage elements and TextLanguage elements.

FIG. 11A illustrates a syntax structure for an access fragment.

FIG. 11B illustrates a syntax structure for an access fragment.

FIG. 11C illustrates a syntax structure for an access fragment.

FIG. 11D illustrates a syntax structure for an access fragment.

FIG. 11E illustrates a syntax structure for an access fragment.

FIG. 11F illustrates a syntax structure for an access fragment.

FIG. 11G illustrates a syntax structure for an access fragment.

FIG. 11H illustrates a syntax structure for an access fragment.

FIG. 11I illustrates a syntax structure for an access fragment.

FIG. 11J illustrates a syntax structure for an access fragment.

FIG. 11K illustrates a syntax structure for an access fragment.

FIG. 11L illustrates a syntax structure for an access fragment.

FIG. 11M illustrates a syntax structure for an access fragment.

FIG. 11N illustrates a syntax structure for an access fragment.

FIG. 11O illustrates a syntax structure for an access fragment.

FIG. 11P illustrates a syntax structure for an access fragment.

FIG. 11Q illustrates a syntax structure for an access fragment.

FIG. 12A illustrates syntax structures for a type element.

FIG. 12B illustrates syntax structures for a type element.

FIG. 12C illustrates syntax structures for a type element.

FIG. 13 illustrates MIMEType sub-element of a video element.

FIG. 14 illustrates MIMEType sub-element of an audio element.

FIG. 15A illustrates MIMEType processes.

FIG. 15B illustrates MIMEType processes.

FIG. 16A illustrates a media extension syntax.

FIG. 16B illustrates a media extension syntax.

FIG. 17 illustrates a closed captioning syntax.

FIG. 18A illustrates a media extension syntax.

FIG. 18B illustrates a media extension syntax.

FIG. 18C illustrates a media extension syntax.

FIG. 19 illustrates a capability indication syntax.

FIG. 20 illustrates a capability indication syntax.

FIG. 21 illustrates a capability indication syntax.

FIG. 22 illustrates a capability indication syntax.

FIG. 23 illustrates a capability indication syntax.

FIG. 24 illustrates a capability indication syntax.

### DESCRIPTION OF EMBODIMENTS

### Detailed Description of Preferred Embodiment

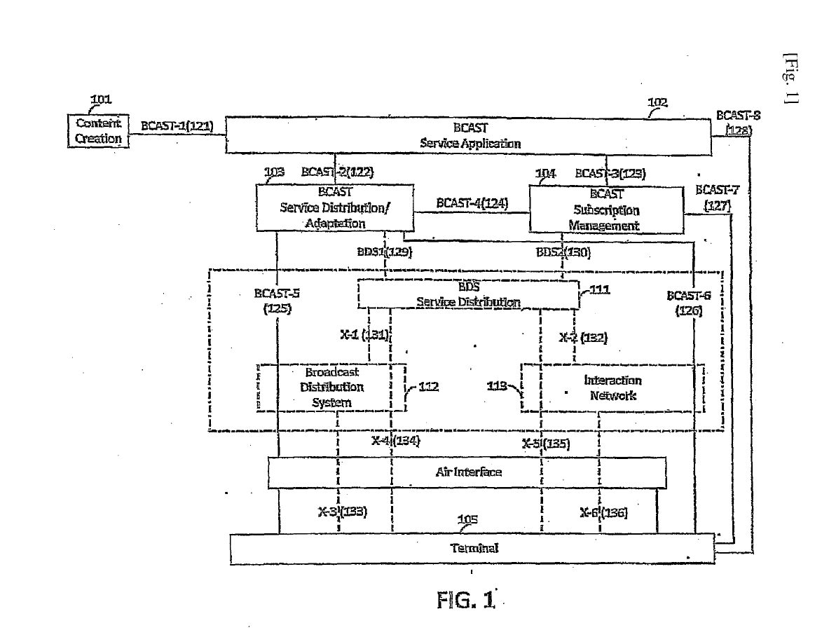

Referring to FIG. 1, a logical architecture of a broadcast system specified by OMA (Open Mobile Alliance) BCAST may include an application layer and a transport layer. The logical architecture of the BCAST system may include a Content Creation (CC) 101, a BCAST Service Application 102, a BCAST Service Distribution/Adaptation (BSDA) 103, a BCAST Subscription Management (BSM) 104, a Terminal 105, a Broadcast Distribution System (BDS) Service Distribution 111, a BDS 112, and an Interaction Network 113. It is to be understood that the broadcast system and/or receiver system may be reconfigured, as desired. It is to be understood that the broadcast system and/or receiver system may include additional elements and/or fewer elements, as desired.

In general, the Content Creation (CC) 101 may provide content that is the basis of BCAST services. The content may include files for common broadcast services, e.g., data for a movie including audio and video. The Content Creation 101 provides a BCAST Service Application 102 with attributes for the content, which are used to create a service guide and to determine a transmission bearer over which the services will be delivered.

In general, the BCAST Service Application 102 may receive data for BCAST services provided from the Content Creation 101, and converts the received data into a form suitable for providing media encoding, content protection, interactive services, etc. The BCAST Service Application 102 provides the attributes for the content, which is received from the Content Creation 101, to the BSDA 103 and the BSM 104.

In general, the BSDA 103 may perform operations, such as file/streaming delivery, service gathering, service protection, service guide creation/delivery and service notification, using the BCAST service data provided from the BCAST Service Application 102. The BSDA 103 adapts the services to the BDS 112.

In general, the BSM 104 may manage, via hardware or software, service provisioning, such as subscription and charging-related functions for BCAST service users, information provisioning used for BCAST services, and mobile terminals that receive the BCAST services.

In general, the Terminal 105 may receive content/service guide and program support information, such as content protection, and provides a broadcast service to a user. The BDS Service Distribution 111 delivers mobile broadcast services to a plurality of terminals through mutual communication with the BDS 112 and the Interaction Network 113.

In general, the BDS 112 may deliver mobile broadcast services over a broadcast channel, and may include, for example, a Multimedia Broadcast Multicast Service (MBMS) by 3rd Generation Project Partnership (3GPP), a Broadcast Multicast Service (BCMCS) by 3rd Generation Project Partnership 2 (3GPP2), a DVB-Handheld (DVB-H) by Digital Video Broadcasting (DVB), or an Internet Protocol (IP) based broadcasting communication network. The Interaction Network 113 provides an interaction channel, and may include, for example, a cellular network.

The reference points, or connection paths between the logical entities of FIG. 1, may have a plurality of interfaces, as desired. The interfaces are used for communication between two or more logical entities for their specific purposes. A message format, a protocol and the like are applied for the interfaces. In some embodiments, there are no logical interfaces between one or more different functions.

BCAST-1 121 is a transmission path for content and content attributes, and BCAST-2 122 is a transmission path for a content-protected or content-unprotected BCAST service, attributes of the BCAST service, and content attributes.

BCAST-3 123 is a transmission path for attributes of a BCAST service, attributes of content, user preference/subscription information, a user request, and a response to the request. BCAST-4 124 is a transmission path for a notification message, attributes used for a service guide, and a key used for content protection and service protection.

BCAST-5 125 is a transmission path for a protected BCAST service, an unprotected BCAST service, a content-protected BCAST service, a content-unprotected BCAST service, BCAST service attributes, content attributes, a notification, a service guide, security materials such as a Digital Right Management (DRM) Right Object (RO) and key values used for BCAST service protection, and all data and signaling transmitted through a broadcast channel.

BCAST-6 126 is a transmission path for a protected BCAST service, an unprotected BCAST service, a content-protected BCAST service, a content-unprotected BCAST service, BCAST service attributes, content attributes, a notification, a service guide, security materials such as a DRM RO and key values used for BCAST service protection, and all data and signaling transmitted through an interaction channel.

BCAST-7 127 is a transmission path for service provisioning, subscription information, device management, and user preference information transmitted through an interaction channel for control information related to receipt of security materials, such as a DRM RO and key values used for BCAST service protection.

BCAST-8 128 is a transmission path through which user data for a BCAST service is provided. BDS-1 129 is a transmission path for a protected BCAST service, an unprotected BCAST service, BCAST service attributes, content attributes, a notification, a service guide, and security materials, such as a DRM RO and key values used for BCAST service protection.

BDS-2 130 is a transmission path for service provisioning, subscription information, device management, and security materials, such as a DRM RO and key values used for BCAST service protection.

X-1 131 is a reference point between the BDS Service Distribution 111 and the BDS 112. X-2 132 is a reference point between the BDS Service Distribution 111 and the Interaction Network 113. X-3 133 is a reference point between the BDS 112 and the Terminal 105. X-4 134 is a reference point between the BDS Service Distribution 111 and the Terminal 105 over a broadcast channel. X-5 135 is a reference point between the BDS Service Distribution 111 and the Terminal 105 over an interaction channel. X-6 136 is a reference point between the Interaction Network 113 and the Terminal 105.

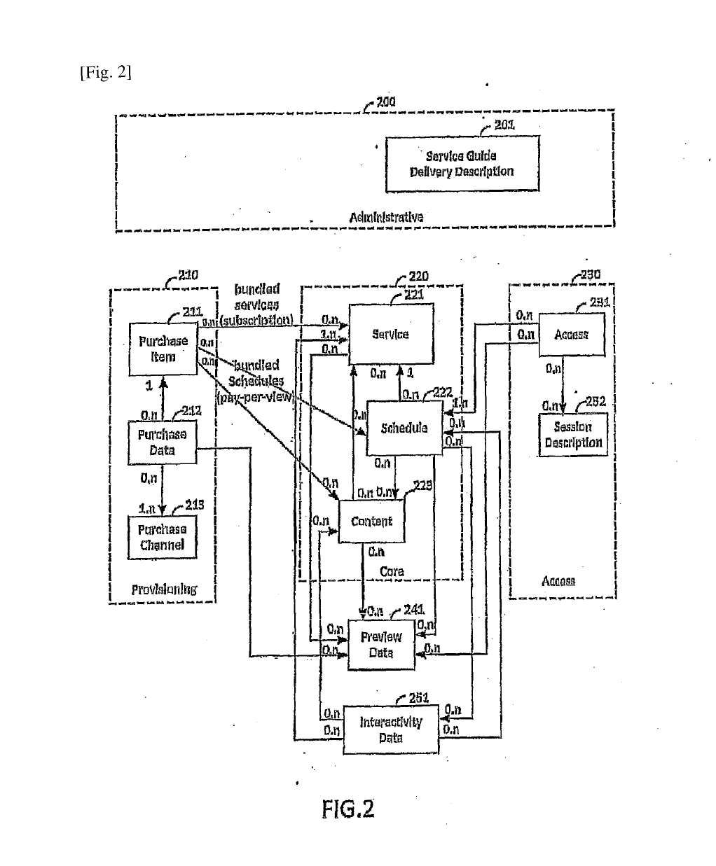

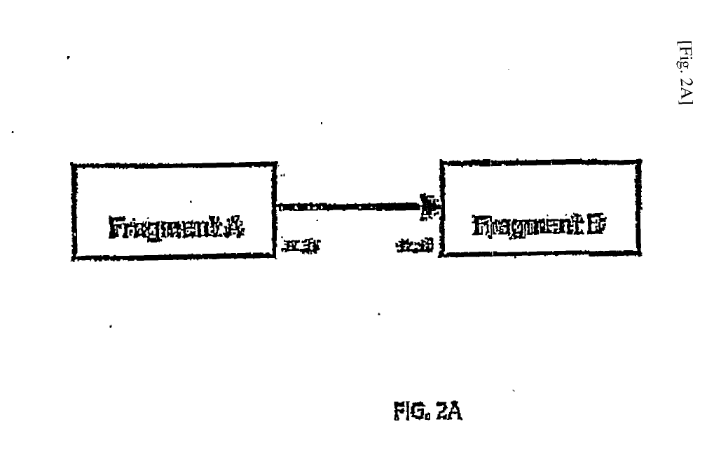

Referring to FIG. 2, an exemplary service guide for the OMA BCAST system is illustrated. For purposes of illustration, the solid arrows between fragments indicate the reference directions between the fragments. It is to be understood that the service guide system may be reconfigured, as desired. It is to be understood that the service guide system may include additional elements and/or fewer elements, as desired. It is to be understood that functionality of the elements may be modified and/or combined, as desired.

FIG. 2A is a diagram showing cardinalities and reference direction between service guide fragments. The meaning of the cardinalities shown in the FIG. 2 is the following: One instantiation of Fragment A as in FIG. 2A references c to d instantiations of Fragment B. If c=d, d is omitted. Thus, if c>0 and Fragment A exists, at least c instantiation of Fragment B must also exist, but at most d instantiations of Fragment B may exist. Vice versa, one instantiation of Fragment B is referenced by a to b instantiations of Fragment A. If a=b, b is omitted. The arrow connection from Fragment A pointing to Fragment B indicates that Fragment A contains the reference to Fragment B.

With respect to FIG. 2, in general, the service guide may include an Administrative Group 200 for providing basic information about the entire service guide, a Provisioning Group 210 for providing subscription and purchase information, a Core Group 220 that acts as a core part of the service guide, and an Access Group 230 for providing access information that control access to services and content.

The Administrative Group 200 may include a Service Guide Delivery Descriptor (SGDD) block 201. The Provision Group 210 may include a Purchase Item block 211, a Purchase Data block 212, and a Purchase Channel block 213. The Core Group 220 may include a Service block 221, a Schedule block 222, and a Content block 223. The Access Group 230 may include an Access block 231 and a Session Description block 232.

The service guide may further include Preview Data 241 and Interactivity Data 251 in addition to the four information groups 200, 210, 220, and 230.

The aforementioned components may be referred to as basic units or fragments constituting aspects of the service guide, for purposes of identification.

The SGDD fragment 201 may provide information about a delivery session where a Service Guide Delivery Unit (SGDU) is located. The SGDU is a container that contains service guide fragments 211, 212, 213, 221, 222, 223, 231, 232, 241, and 251, which constitute the service guide. The SGDD may also provide the information on the entry points for receiving the grouping information and notification messages.

The Service fragment 221, which is an upper aggregate of the content included in the broadcast service, may include information on service content, genre, service location, etc. In general, the ‘Service’ fragment describes at an aggregate level the content items which comprise a broadcast service. The service may be delivered to the user using multiple means of access, for example, the broadcast channel and the interactive channel. The service may be targeted at a certain user group or geographical area. Depending on the type of the service it may have interactive part(s), broadcast-only part(s), or both. Further, the service may include components not directly related to the content but to the functionality of the service such as purchasing or subscription information. As the part of the Service Guide, the ‘Service’ fragment forms a central hub referenced by the other fragments including ‘Access’, ‘Schedule’, ‘Content’ and ‘PurchaseItem’ fragments. In addition to that, the ‘Service’ fragment may reference ‘PreviewData’ fragment. It may be referenced by none or several of each of these fragments. Together with the associated fragments the terminal may determine the details associated with the service at any point of time. These details may be summarized into a user-friendly display, for example, of what, how and when the associated content may be consumed and at what cost.

The Access fragment 231 may provide access-related information for allowing the user to view the service and delivery method, and session information associated with the corresponding access session. As such, the ‘Access’ fragment describes how the service may be accessed during the lifespan of the service. This fragment contains or references Session Description information and indicates the delivery method. One or more ‘Access’ fragments may reference a ‘Service’ fragment, offering alternative ways for accessing or interacting with the associated service. For the Terminal, the ‘Access’ fragment provides information on what capabilities are required from the terminal to receive and render the service. The ‘Access’ fragment provides Session Description parameters either in the form of inline text, or through a pointer in the form of a URI to a separate Session Description. Session Description information may be delivered over either the broadcast channel or the interaction channel.

The Session Description fragment 232 may be included in the Access fragment 231, and may provide location information in a Uniform Resource Identifier (URI) form so that the terminal may detect information on the Session Description fragment 232. The Session Description fragment 232 may provide address information, codec information, etc., about multimedia content existing in the session. As such, the ‘SessionDescription’ is a Service Guide fragment which provides the session information for access to a service or content item. Further, the Session Description may provide auxiliary description information, used for associated delivery procedures. The Session Description information is provided using either syntax of SDP in text format, or through a 3GPP MBMS User Service Bundle Description [3GPP TS 26.346] (USBD). Auxiliary description information is provided in XML format and contains an Associated Delivery Description as specified in [BCAST10-Distribution]. Note that in case SDP syntax is used, an alternative way to deliver the Session Description is by en-capsulating the SDP in text format in ‘Access’ fragment. Note that Session Description may be used both for Service Guide delivery itself as well as for the content sessions.

The Purchase Item fragment 211 may provide a bundle of service, content, time, etc., to help the user subscribe to or purchase the Purchase Item fragment 211. As such, the ‘PurchaseItem’ fragment represents a group of one or more services (i.e. a service bundle) or one or more content items, offered to the end user for free, for subscription and/or purchase. This fragment can be referenced by ‘PurchaseData’ fragment(s) offering more information on different service bundles. The ‘PurchaseItem’ fragment may be also associated with: (1) a ‘Service’ fragment to enable bundled services subscription and/or, (2) a ‘Schedule’ fragment to enable consuming a certain service or content in a certain timeframe (pay-per-view functionality) and/or, (3) a ‘Content’ fragment to enable purchasing a single content file related to a service, (4) other ‘PurchaseItem’ fragments to enable bundling of purchase items.

The Purchase Data fragment 212 may include detailed purchase and subscription information, such as price information and promotion information, for the service or content bundle. The Purchase Channel fragment 213 may provide access information for subscription or purchase. As such, the main function of the ‘PurchaseData’ fragment is to express all the available pricing information about the associated purchase item. The ‘PurchaseData’ fragment collects the information about one or several purchase channels and may be associated with PreviewData specific to a certain service or service bundle. It carries information about pricing of a service, a service bundle, or, a content item. Also, information about promotional activities may be included in this fragment. The SGDD may also provide information regarding entry points for receiving the service guide and grouping information about the SGDU as the container.

The Preview Data fragment 241 may be used to provide preview information for a service, schedule, and content. As such, ‘PreviewData’ fragment contains information that is used by the terminal to present the service or content outline to users, so that the users can have a general idea of what the service or content is about. ‘PreviewData’ fragment can include simple texts, static images (for example, logo), short video clips, or even reference to another service which could be a low bit rate version for the main service. ‘Service’, ‘Content’, ‘PurchaseData’, ‘Access’ and ‘Schedule’ fragments may reference ‘PreviewData’ fragment.

The Interactivity Data fragment 251 may be used to provide an interactive service according to the service, schedule, and content during broadcasting. More detailed information about the service guide can be defined by one or more elements and attributes of the system. As such, the InteractivityData contains information that is used by the terminal to offer interactive services to the user, which is associated with the broadcast content. These interactive services enable users to e.g. vote during TV shows or to obtain content related to the broadcast content. ‘InteractivityData’ fragment points to one or many ‘InteractivityMedia’ documents that include xhtml files, static images, email template, SMS template, MMS template documents, etc. The ‘InteractivityData’ fragment may reference the ‘Service’, ‘Content’ and ‘Schedule’ fragments, and may be referenced by the ‘Schedule’ fragment.

The ‘Schedule’ fragment defines the timeframes in which associated content items are available for streaming, downloading and/or rendering. This fragment references the ‘Service’ fragment. If it also references one or more ‘Content’ fragments or ‘InterativityData’ fragments, then it defines the valid distribution and/or presentation timeframe of those content items belonging to the service, or the valid distribution timeframe and the automatic activation time of the InteractivityMediaDocuments associated with the service. On the other hand, if the ‘Schedule’ fragment does not reference any ‘Content’ fragment(s) or ‘InteractivityDat’a fragment(s), then it defines the timeframe of the service availability which is unbounded.

The ‘Content’ fragment gives a detailed description of a specific content item. In addition to defining a type, description and language of the content, it may provide information about the targeted user group or geographical area, as well as genre and parental rating. The ‘Content’ fragment may be referenced by Schedule, PurchaseItem or ‘InteractivityData’ fragment. It may reference ‘PreviewData’ fragment or ‘Service’ fragment.

The ‘PurchaseChannel’ fragment carries the information about the entity from which purchase of access and/or content rights for a certain service, service bundle or content item may be obtained, as defined in the ‘PurchaseData’ fragment. The purchase channel is associated with one or more Broadcast Subscription Managements (BSMs). The terminal is only permitted to access a particular purchase channel if it is affiliated with a BSM that is also associated with that purchase channel. Multiple purchase channels may be associated to one ‘PurchaseData’ fragment. A certain end-user can have a “preferred” purchase channel (e.g. his/her mobile operator) to which all purchase requests should be directed. The preferred purchase channel may even be the only channel that an end-user is allowed to use.

The ServiceGuideDeliveryDescriptor is transported on the Service Guide Announcement Channel, and informs the terminal the availability, metadata and grouping of the fragments of the Service Guide in the Service Guide discovery process. A SGDD allows quick identification of the Service Guide fragments that are either cached in the terminal or being transmitted. For that reason, the SGDD is preferably repeated if distributed over broadcast channel. The SGDD also provides the grouping of related Service Guide fragments and thus a means to determine completeness of such group. The ServiceGuideDeliveryDescriptor is especially useful if the terminal moves from one service coverage area to another. In this case, the ServiceGuideDeliveryDescriptor can be used to quickly check which of the Service Guide fragments that have been received in the previous service coverage area are still valid in the current service coverage area, and therefore don't have to be re-parsed and re-processed.

Although not expressly depicted, the fragments that constitute the service guide may include element and attribute values for fulfilling their purposes. In addition, one or more of the fragments of the service guide may be omitted, as desired. Also, one or more fragments of the service guide may be combined, as desired. Also, different aspects of one or more fragments of the service guide may be combined together, re-organized, and otherwise modified, or constrained as desired.

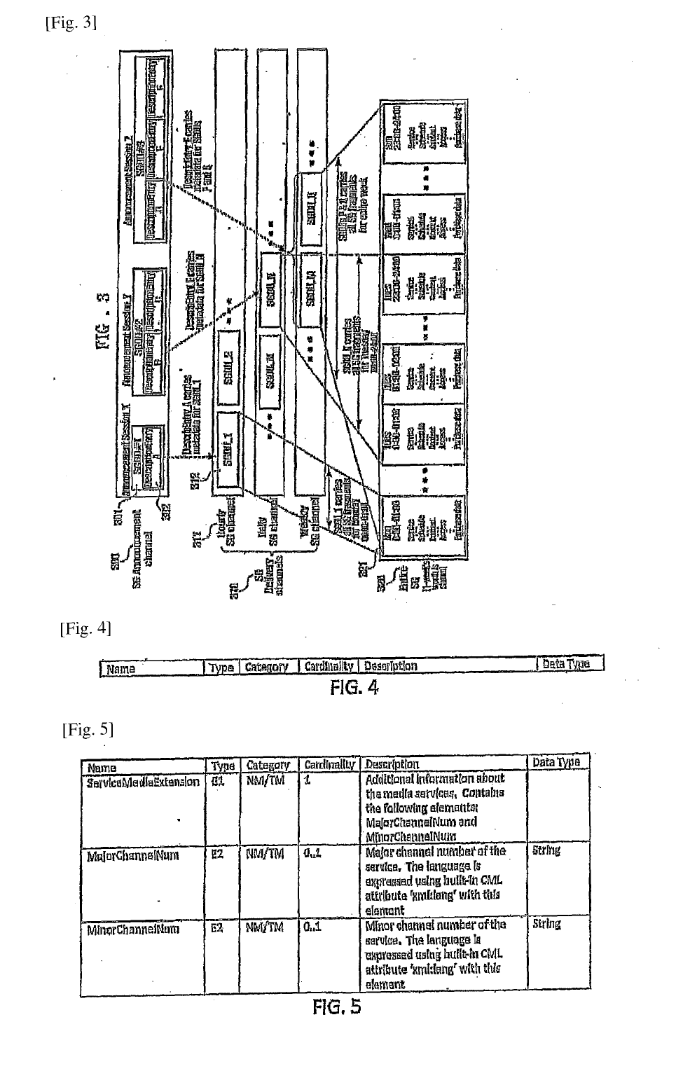

Referring to FIG. 3, an exemplary block diagram illustrates aspects of a service guide delivery technique. The Service Guide Deliver Descriptor fragment 201 may include the session information, grouping information, and notification message access information related to all fragments containing service information. When the mobile broadcast service-enabled terminal 105 turns on or begins to receive the service guide, it may access a Service Guide Announcement Channel (SG Announcement Channel) 300.

The SG Announcement Channel 300 may include at least one of SGDD 200 (e.g., SGDD #1, . . . , SGDD #2, SGDD #3), which may be formatted in any suitable format, such as that illustrated in Service Guide for Mobile Broadcast Services, Open Mobile Alliance, Version 1.0.1, Jan. 9, 2013 and/or Service Guide for Mobile Broadcast Services, open Mobile Alliance, Version 1.1, Oct. 29, 3013; both of which are incorporated by reference in their entirety. The descriptions of elements and attributes constituting the Service Guide Delivery Descriptor fragment 201 may be reflected in any suitable format, such as for example, a table format and/or in an eXtensible Markup Language (XML) schema.

The actual data is preferably provided in XML format according to the SGDD fragment 201. The information related to the service guide may be provided in various data formats, such as binary, where the elements and attributes are set to corresponding values, depending on the broadcast system.

The terminal 105 may acquire transport information about a Service Guide Delivery Unit (SGDU) 312 containing fragment information from a DescriptorEntry of the SGDD fragment received on the SG Announcement Channel 300.

The DescriptorEntry 302, which may provide the grouping information of a Service Guide includes the “GroupingCriteria”, “ServiceGuideDeliveryUnit”, “Transport”, and AlternativeAccessURI”. The transport-related channel information may be provided by the “Transport” or “AlternativeAccessURI”, and the actual value of the corresponding channel is provided by “ServiceGuideDeliveryUnit”. Also, upper layer group information about the SGDU 312, such as “Service” and “Genre”, may be provided by “GroupingCriteria”. The terminal 105 may receive and present all of the SGDUs 312 to the user according to the corresponding group information.

Once the transport information is acquired, the terminal 105 may access all of the Delivery Channels acquired from a DescriptorEntry 302 in an SGDD 301 on an SG Delivery Channel 310 to receive the actual SGDU 312. The SG Delivery Channels can be identified using the “GroupingCriteria”. In the case of time grouping, the SGDU can be transported with a time-based transport channel such as an Hourly SG Channel 311 and a Daily SG Channel. Accordingly, the terminal 105 can selectively access the channels and receive all the SGDUs existing on the corresponding channels. Once the entire SGDU is completely received on the SG Delivery Channels 310, the terminal 105 checks all the fragments contained in the SGDUs received on the SG Delivery Channels 310 and assembles the fragments to display an actual full service guide 320 on the screen which can be subdivided on an hourly basis 321.

In the conventional mobile broadcast system, the service guide is formatted and transmitted such that only configured terminals receive the broadcast signals of the corresponding broadcast system. For example, the service guide information transmitted by a DVB-H system can only be received by terminals configured to receive the DVB-H broadcast.

The service providers provide bundled and integrated services using various transmission systems as well as various broadcast systems in accordance with service convergence, which may be referred to as multiplay services. The broadcast service providers may also provide broadcast services on IP networks. Integrated service guide transmission/reception systems may be described using terms of entities defined in the 3GPP standards and OMA BCAST standards (e.g., a scheme). However, the service guide/reception systems may be used with any suitable communication and/or broadcast system.

Referring to FIG. 4, the scheme may include, for example, (1) Name; (2) Type; (3) Category; (4) Cardinality; (5) Description; and (6) Data type. The scheme may be arranged in any manner, such as a table format of an XML format.

The “name” column indicates the name of an element or an attribute. The “type” column indicates an index representing an element or an attribute. An element can be one of E1, E2, E3, E4, . . . , E[n]. E1 indicates an upper element of an entire message, E2 indicates an element below the E1, E3 indicates an element below E2, E4 indicates an element below the E3, and so forth. An attribute is indicated by A. For example, an “A” below E1 means an attribute of element E1. In some cases the notation may mean the following E=Element, A=Attribute, E1=sub-element, E2=sub-element's sub-element, E[n]=sub-element of element[n−1]. The “category” column is used to indicate whether the element or attribute is mandatory. If an element is mandatory, the category of the element is flagged with an “M”. If an element is optional, the category of the element is flagged with an “0”. If the element is optional for network to support it the element is flagged with a “NO”. If the element is mandatory for terminal to support it is flagged with a TM. If the element is mandatory for network to support it the element is flagged with “NM”. If the element is optional for terminal to support it the element is flagged with “TO”. If an element or attribute has cardinality greater than zero, it is classified as M or NM to maintain consistency. The “cardinality” column indicates a relationship between elements and is set to a value of 0, 0 . . . 1, 1, 0 . . . n, and 1 . . . n. 0 indicates an option, 1 indicates a necessary relationship, and n indicates multiple values. For example, 0 . . . n means that a corresponding element can have no or n values. The “description” column describes the meaning of the corresponding element or attribute, and the “data type” column indicates the data type of the corresponding element or attribute.

A service may represent a bundle of content items, which forms a logical group to the end-user. An example would be a TV channel, composed of several TV shows. A ‘Service’ fragment contains the metadata describing the Mobile Broadcast service. It is possible that the same metadata (i.e., attributes and elements) exist in the ‘Content’ fragment(s) associated with that ‘Service’ fragment. In that situation, for the following elements: ‘ParentalRating’, ‘TargetUserProfile’, ‘Genre’ and ‘BroadcastArea’, the values defined in ‘Content’ fragment take precedence over those in ‘Service’ fragment.

The program guide elements of this fragment may be grouped between the Start of program guide and end of program guide cells in a fragment. This localization of the elements of the program guide reduces the computational complexity of the receiving device in arranging a programming guide. The program guide elements are generally used for user interpretation. This enables the content creator to provide user readable information about the service. The terminal should use all declared program guide elements in this fragment for presentation to the end-user. The terminal may offer search, sort, etc. functionalities. The Program Guide may consist of the following service elements: (1) Name; (2) Description; (3) AudioLanguage; (4) TextLanguage; (5) ParentalRating; (6) TargetUserProfile; and (7) Genre.

The “Name” element may refer to Name of the Service, possibly in multiple languages. The language may be expressed using built-in XML attribute ‘xml:lang’.

The “Description” element may be in multiple languages and may be expressed using built-in XML attribute ‘xml:lang’.

The “AudioLanguage” element may declare for the end users that this service is available with an audio track corresponding to the language represented by the value of this element. The textual value of this element can be made available for the end users in different languages. In such a case the language used to represent the value of this element may be signaled using the built-in XML attribute ‘xml:lang’, and may include multi-language support. The AudioLanguage may contain an attribute languageSDPTag.

The “languageSDPTag” attribute is an identifier of the audio language described by the parent ‘AudioLanguage’ element as used in the media sections describing the audio track in a Session Description. Each ‘AudioLanguage’ element declaring the same audio stream may have the same value of the languageSDPTag′.

The “TextLanguage” element may declare for the end user that the textual components of this service are available in the language represented by the value of this element. The textual components can be, for instance, a caption or a sub-title track. The textual value of this element can be made available for the end users in different languages. In such a case the language used to represent the value of this element may be signaled using the built-in XML attribute ‘xml:lang’, and may include multi-language support. The same rules and constraints as specified for the element ‘AudioLanguage’ of assigning and interpreting the attributes ‘languageSDPTag’ and ‘xml:lang’ may be applied for this element.

The “languageSDPTag” attribute is an identifier of the text language described by the parent ‘TextLanguage’ element as used in the media sections describing the textual track in a Session Description.

The “ParentalRating” element may declare criteria parents and might be used to determine whether the associated item is suitable for access by children, defined according to the regulatory requirements of the service area. The terminal may support ‘ParentalRating’ being a free string, and the terminal may support the structured way to express the parental rating level by using the ‘ratingSystem’ and ‘ratingValueName’ attributes.

The “ratingSystem” attribute may specify the parental rating system in use, in which context the value of the ‘ParentalRating’ element is semantically defined. This allows terminals to identify the rating system in use in a non-ambiguous manner and act appropriately. This attribute may be instantiated when a rating system is used. Absence of this attribute means that no rating system is used (i.e. the value of the ‘ParentalRating’ element is to be interpreted as a free string).

The “ratingValueName” attribute may specify the human-readable name of the rating value given by this ParentalRating element.

The “TargetUserProfile” may specify elements of the users whom the service is targeting at. The detailed personal attribute names and the corresponding values are specified by attributes of ‘attributeName’ an ‘attributeValue’. Amongst the possible profile attribute names are age, gender, occupation, etc. (subject to national/local rules & regulations, if present and as applicable regarding use of personal profiling information and personal data privacy). The extensible list of ‘attributeName’ and ‘attributeValue’ pairs for a particular service enables end user profile filtering and end user preference filtering of broadcast services. The terminal may be able to support ‘TargetUserProfile’ element. The use of ‘TargetUserProfile’ element may be an “opt-in” capability for users. Terminal settings may allow users to configure whether to input their personal profile or preference and whether to allow broadcast service to be automatically filtered based on the users' personal attributes without users' request. This element may contain the following attributes: attributeName and attributeValue.

The “attributeName” attribute may be a profile attribute name.

The “attributeValue” attribute may be a profile attribute value.

The “Genre” element may specify classification of service associated with characteristic form (e.g. comedy, drama). The OMA BCAST Service Guide may allow describing the format of the Genre element in the Service Guide in two ways. The first way is to use a free string. The second way is to use the “href” attributes of the Genre element to convey the information in the form of a controlled vocabulary (classification scheme as defined in [TVA-Metadata] or classification list as defined in [MIGFG]). The built-in XML attribute xml:lang may be used with this element to express the language. The network may instantiate several different sets of ‘Genre’ element, using it as a free string or with a ‘href’ attribute. The network may ensure the different sets have equivalent and nonconflicting meaning, and the terminal may select one of the sets to interpret for the end-user. The ‘Genre’ element may contain the following attributes: type and href.

The “type” attribute may signal the level of the ‘Genre’ element, such as with the values of “main”, “second”, and “other”.

The “href” attribute may signal the controlled vocabulary used in the ‘Genre’ element.

After reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information defined within the programming guide to appropriately render the information in a manner suitable for the viewer. In particular, the traditional NTSC television stations typically have numbers such as, 2, 4, 6, 8, 12, and 49. For digital services, program and system information protocol includes a virtual channel table that, for terrestrial broadcasting defines each digital television service with a two-part number consisting of a major channel followed by a minor channel. The major channel number is usually the same as the NTSC channel for the station, and the minor channels have numbers depending on how many digital television services are present in the digital television multiples, typically starting at 1. For example, the analog television channel 9, WUSA-TV in Washington, D.C., may identify its two over-the-air digital services as follows: channel 9-1 WUSA-DT and channel 9-2 9-Radar. This notation for television channels is readily understandable by a viewer, and the programming guide elements may include this capability as an extension to the programming guide so that the information may be computationally efficiently processed by the receiving device and rendered to the viewer.

Referring to FIG. 5, to facilitate this flexibility an extension, such as ServiceMediaExtension, may be included with the programming guide elements which may specify further services. In particular, the ServiceMediaExtension may have a type element E1, a category NM/TM, with a cardinality of 1. The major channel may be referred to as MajorChannelNum, with a type element E2, a category NM/TM, a cardinality of 0 . . . 1, and a data type of string. By including the data type of string, rather than an unsignedByte, permits the support of other languages which may not necessarily be a number. The program guide information, including the ServiceMediaExtension may be included in any suitable broadcasting system, such as for example, ATSC.

After further reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information suitable to appropriately rendering the information in a manner suitable for the viewer. In many cases, the viewer associates a graphical icon with a particular program and/or channel and/or service. In this manner, the graphical icon should be selectable by the system, rather than being non-selectable.

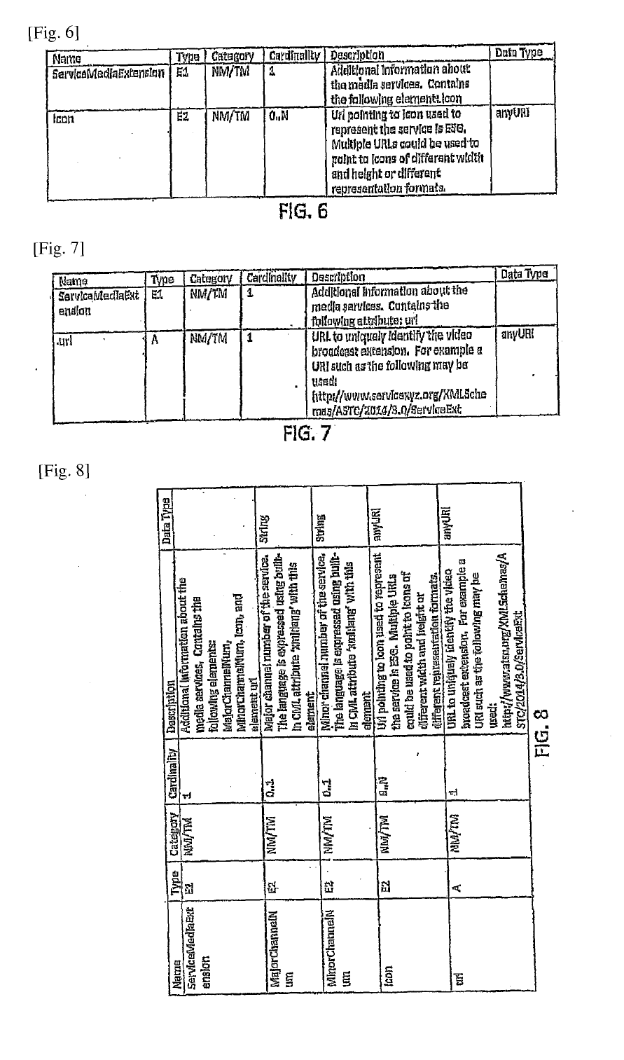

Referring to FIG. 6, to facilitate this flexibility an extension may be included with the programming guide elements which may specify an icon.

After yet further reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information suitable to appropriately rendering the information in a manner suitable for the viewer. In many cases, the viewer may seek to identify the particular extension being identified using the same extension elements. In this manner, a url may be used to specifically identify the particular description of the elements of the extension. In this manner, the elements of the extension may be modified in a suitable manner without having to expressly describe multiple different extensions.

Referring to FIG. 7, to facilitate this flexibility an extension may be included with the programming guide elements which may specify a url.

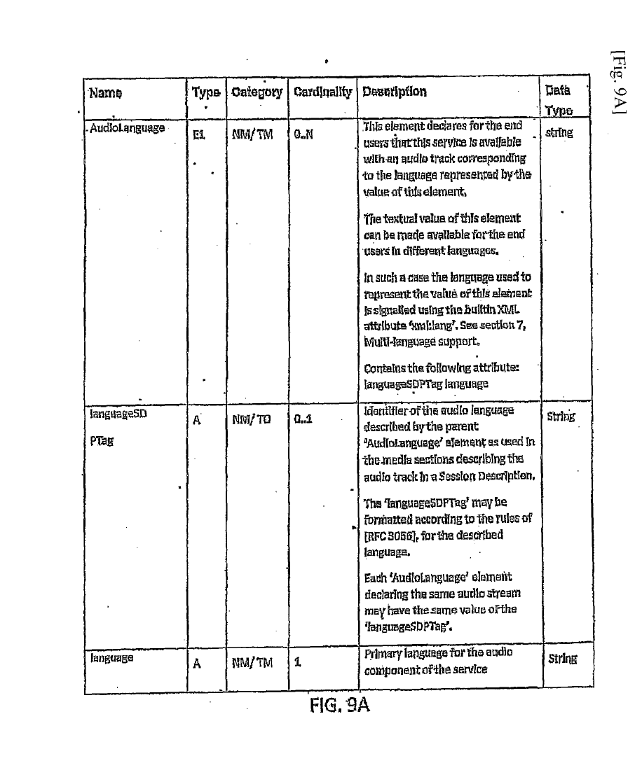

Referring to FIG. 8, to facilitate this overall extension flexibility an extension may be included with the programming guide elements which may specify an icon, major channel number, minor channel number, and/or url.

In other embodiments, instead of using Data Type “string” for MajorChannelNum and MinorChannelNum elements, other data types may be used. For example, the data type unsignedInt may be used. In another example, a string of limited length may be used, e.g. string of 10 digits. An exemplary XML schema syntax for the above extensions is illustrated below.

```
<xs:element name=“ServiceMediaExtension ” type=“SerExtensionType”
minOccurs=“0” maxOccurs=“unbounded”/>
<xs:complexType name=“SerExtensionType”>
      <xs:sequence>
<xs:element name=“Icon” type=“xs:anyURI” minOccurs=“0”
maxOccurs=“unbounded”/>
<xs:element name=“MajorChannelNum” type=“LanguageString”
minOccurs=“0” maxOccurs=“1”/>
<xs:element name=“MinorChannelNum” type=“LanguageString”
minOccurs=“0” maxOccurs=“1”/>
      </xs:sequence>
      <xs:attribute name=“url” type=“xs:anyURI” use=“required”/>
</xs:complexType>
```

In some embodiments the ServiceMediaExtension may be included inside a OMA “extension” element or may in general use OMA extension mechanism for defining the ServiceMediaExtension.

In some embodiments the MajorChannelNum and MinorChannelNum may be combined into one common channel number and represented. For example a ChannelNum string may be created by concatenating MajorChannelNum followed by a period (‘.’) followed by MinorChannelNum. Other such combinations are also possible with period replaced by other characters. Similar concept can be applied when using unsignedInt or other data types to represent channel numbers in terms of combining MajorChannelNum and MinorChannelNum into one number representation.

In yet another embodiment a MajorChannelNum.MinorChannelNum could be represented as “ServiceId” element (Service Id) for the service.

In another embodiment, the ServiceMediaExtension may only be used inside a PrivateExt element within a Service fragmentAn exemplary XML schema syntax for such an extension is illustrated below.

```
      <element name=“ ServiceMediaExtension ”
      type=“SerExtensionType ”>
            <annotation>
                  <documentation>
      This element is a wrapper for extensions to OMA BOAST SG
Service fragments. It may only be used inside a PrivateExt element within
a Service fragment.
            </documentation>
            </annotation>
</element>
<xs:complexType name=“SerExtensionType”>
      <xs:sequence>
<xs:element name=“Icon” type=“xs:anyURI” minOccurs=“0”
maxOccurs=“unbounded”/>
<xs:element name=“MajorChannelNum” type=“LanguageString”
minOccurs=“0” maxOccurs=“1”/>
<xs:element name=“MinorChannelNum” type=“LanguageString”
minOccurs=“0” maxOccurs=“1”/>
      </xs:sequence>
      <xs:attribute name=“url” type=“xs:anyURI” use=“required”/>
</xs:complexType>
```

In other embodiments some of the elements above may be changed from E2 to E1. In other embodiments the cardinality of some of the elements may be changed. In addition, if desired, the category may be omitted since it is generally duplicative of the information included with the cardinality.

It is desirable to map selected components of the ATSC service elements and attributes to the OMA service guide service fragment program guide. For example, the “Description” attribute of the OMA service guide fragment program guide may be mapped to “Description” of the ATSC service elements and attributes, such as for example ATSC-Mobile DTV Standard, Part 4-Announcement, other similar broadcast or mobile standards for similar elements and attributes. For example, the “Genre” attribute of the OMA service guide fragment program guide may be mapped to “Genre” of the ATSC service elements and attributes, such as for example ATSC-Mobile DTV Standard, Part 4-Announcement, other similar standards for similar elements and attributes. In one embodiment Genre scheme as defined in Section 6.10.2 of ATSC A153/Part 4 may be utilized For example, the “Name” attribute of the OMA service guide fragment program guide may be mapped to “Name” of the ATSC service elements and attributes, such as for example ATSC-Mobile DTV Standard, Part 4-Announcement, other similar standards for similar elements and attributes. Preferably, the cardinality of the name is selected to be 0 . . . N, which permits the omission of the name which reduces the overall bit rate of the system and increase flexibility. For example, the “ParentalRating” attribute of the OMA service guide fragment program guide may be mapped to a new “ContentAdvisory” of the ATSC service element and attributes, such as for example ATSC-Mobile DTV Standard, Part 4-Announcement, or similar standards for similar elements and attributes. For example, the “TargetUserProfile” attribute of the OMA service guide fragment program guide may be mapped to a new “Personalization” of the ATSC service element and attributes, such as for example ATSC-Mobile DTV Standard, Part 4-Announcement, or similar standards for similar elements and attributes.

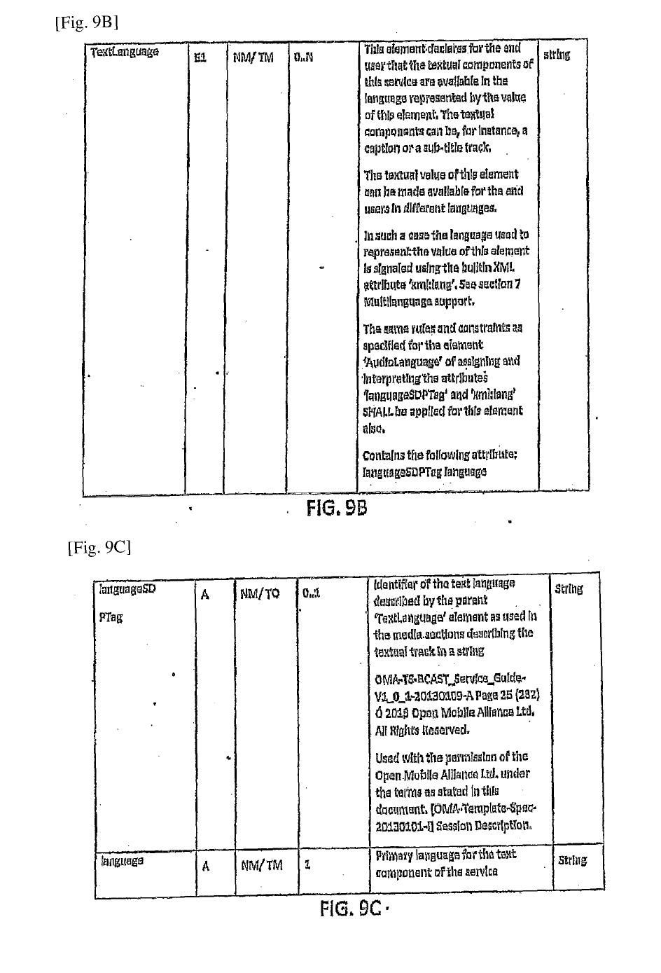

Referring to FIGS. 9A, 9B, 9C, the elements AudioLanguage (with attribute languageSDPTag) and TextLanguage (with attribute languageSDPTag) could be included if Session Description Fragment is included in the service announcement, such as for example ATSC-Mobile DTV Standard, Part 4-Announcement, or similar standards for similar elements and attributes. This is because the attribute languageSDPTag for the elements AudioLanguage and TextLanguage are preferably mandatory. This attribute provides identifier for audio/text language described by the parent element as used in the media sections describing audio/text track in a session description. In another embodiment the attribute languageSDPTag could be made optional and the elements AudioLanguage and TextLanguage could be included with an attribute “Langugage” with data type “string” which can provide language name.

An example XML schema syntax for this is shown below.

```
<xs:complexType name=“AudioOrTextLanguageType”>
      <xs:simpleContent>
            <xs:extension base=“LanguageString”>
                  <xs:attribute name=“languageSDPTag”
                  type=“xs:string” use=“optional”/>
      <xs:attribute name=“language” type=“xs:string” use=“required”/>
      </xs:extension>
      </xs:simpleContent>
</xs:complexType>
```

In another embodiment the attributes languageSDPTag for the elements AudioLanguage and TextLanguage could be removed. An example XML schema syntax for this is shown below.

```
<xs:complexType name=“AudioOrTextLanguageType”>
      <xs:simpleContent>
            <xs:extension base=“LanguageString”>
      <xs:attribute name=“language” type=“xs:string” use=“required”/>
      </xs:extension>
      </xs:simpleContent>
</xs:complexType>
```

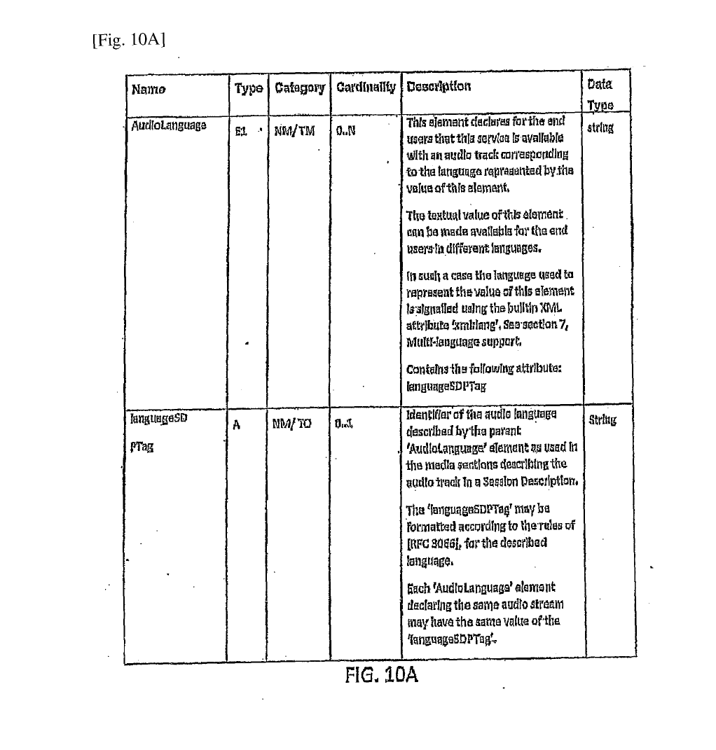

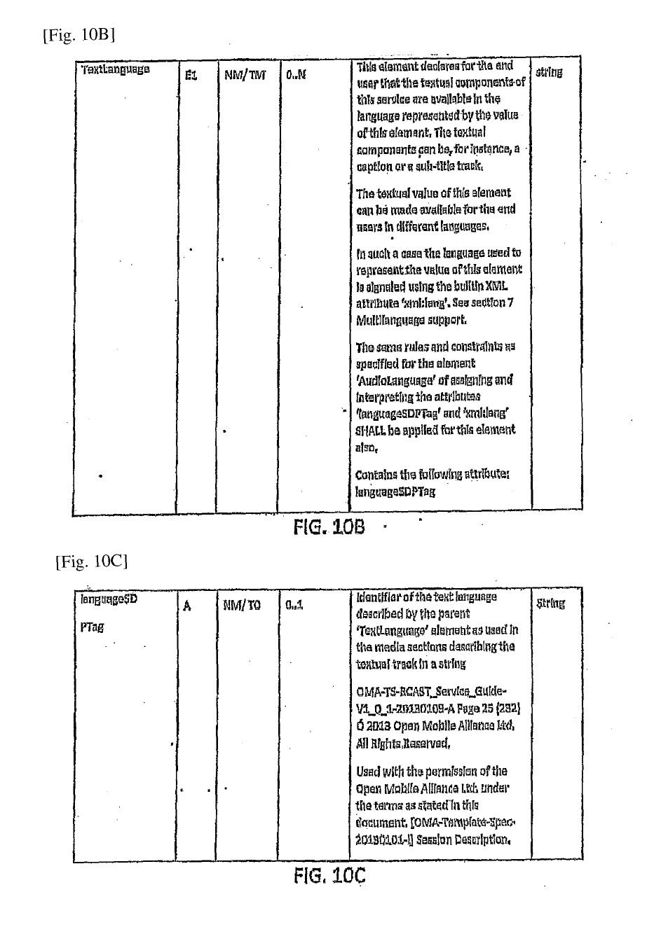

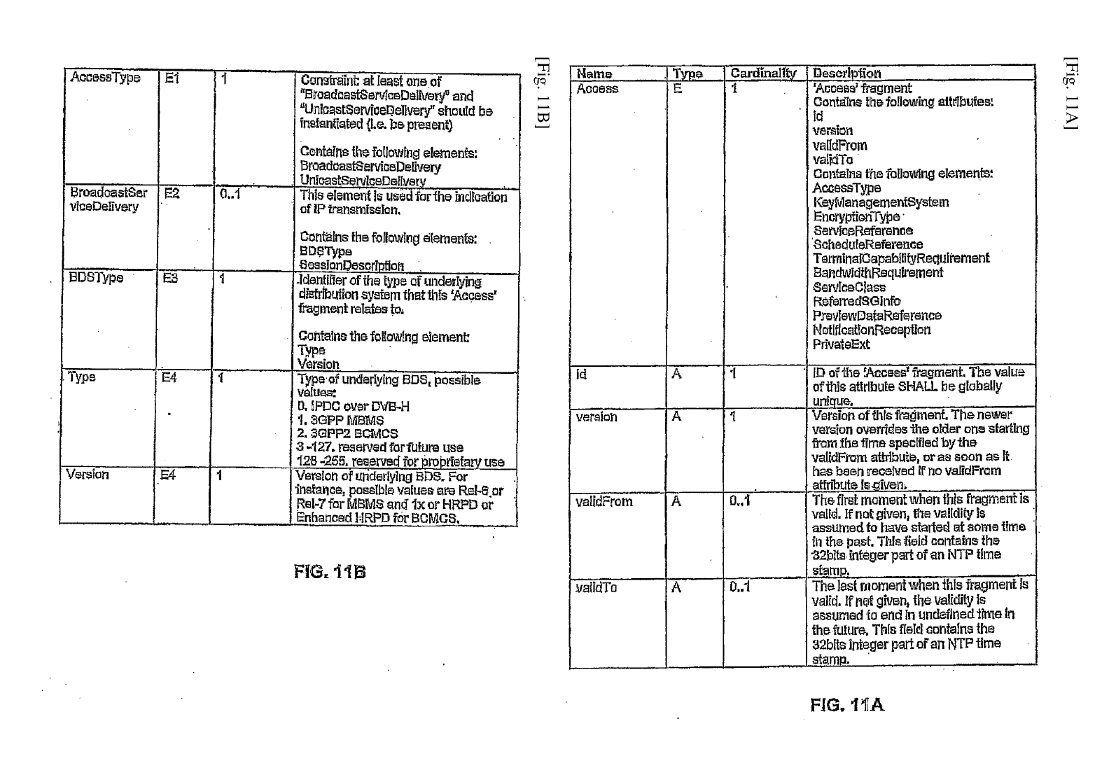

Referring to FIGS. 10A, 10B, 10C, the elements AudioLanguage (with attribute languageSDPTag) and TextLanguage (with attribute languageSDPTag) could be included if Session Description Fragment is included in the service announcement, such as for example ATSC-Mobile DTV Standard, Part 4-Announcement, or similar standards for similar elements and attributes. This is because the attribute languageSDPTag for the elements AudioLanguage and TextLanguage are preferably mandatory. This attribute provides identifier for audio/text language described by the parent element as used in the media sections describing audio/text track in a session description. In another embodiment the attribute languageSDPTag could be made optional.

An example XML schema syntax for this is shown below.

```
<xs:complexType name=“AudioOrTextLanguageType”>
      <xs:simpleContent>
            <xs:extension base=“LanguageString”>
                  <xs:attribute name=“languageSDPTag”
                  type=“xs:string” use=“optional”/>
      </xs:extension>
      </xs:simpleContent>
</xs:complexType>
```

In another embodiment the attributes languageSDPTag for the elements AudioLanguage and TextLanguage could be removed. An example XML schema syntax for this is shown below.

```
<xs:complexType name=“AudioOrTextLanguageType”>
      <xs:simpleContent>
            <xs:extension base=“LanguageString”>
      </xs:extension>
      </xs:simpleContent>
</xs:complexType>
```

In another embodiment the attribute “language” could be mapped to ATSC service “language” element and could refer to the primary language of the service.

In another embodiment the value of element “AudioLanguage” could be mapped to ATSC service “language” element and could refer to the primary language of the audio service in ATSC.

In another embodiment the value of element “TextLanguage” could be mapped to ATSC service “language” element and could refer to the primary language of the text service in ATSC. In some cases the text service may be a service such as closed caption service. In another embodiment the elements AudioLanguage and TextLanguage and their attributes could be removed.

In some embodiments, the service of the type Linear Service: On-Demand component may be forbidden. In that case, no ServiceType value may be assigned for that type of service.

As described, the ‘Access’ fragment describes how the service may be accessed during the lifespan of the service. This fragment may contain or reference Session Description information and indicates the delivery method. One or more ‘Access’ fragments may reference a ‘Service’ fragment, offering alternative ways for accessing or interacting with the associated service. For the Terminal/receiver, the ‘Access’ fragment provides information on what capabilities are required from the terminal to receive and render the service. The ‘Access’ fragment may provide Session Description parameters either in the form of inline text, or through a pointer in the form of a URI to a separate Session Description. Session Descriptioninformation may be delivered over either the broadcast channel or the interaction channel.

The Access fragment 231 may provide access-related information for allowing the user to view the service and delivery method, and session information associated with the corresponding access session. Preferably the access fragment includes attributes particularly suitable for the access fragment, while excluding other attributes not particularly suitable for the access fragment. The same content using different codecs can be consumed by the terminals with different audio-video codec capabilities using different channels. For example, the video streaming program may be in two different formats, such as MPEG-2 and ATSC, where MPEG-2 is a low quality video stream and ATSC is a high quality video stream. A service fragment may be provided for the video streaming program to indicate that it is encoded in two different formats, namely, MPEG-2 and ATSC. Two access fragments may be provided, associated with the service fragment, to respectively specify the two access channels for the two video stream formats. The user may select the preferred access channel based upon the terminal's decoding capabilities, such as that specified by a terminal capabilities requirement element.

Indicating capability required to access the service in the service guide can help the receiver provide a better user experience of the service. For example in one case the receiver may grey out content from the service for which the corresponding access fragment indicates a terminal/receiver requirement which the receiver does not support. For example if the access fragment indicates that the service is offered in codec of the format XYZ only and if the receiver does not support the codec of the format XYZ then receiver may grey out the service and/or content for that service when showing the service guide. Alternatively instead of greying out the content in this case the receiver may not display the particular content when showing the service guide. This can result in better user experience because user does not see a content in the service guide only to select it and learn that it can not access it because it does not have the required codec to access the service.

The service fragment and the access fragment may be used to support the selective viewing of different versions (for example, basic version only contains audio; normal version contains both audio and video; or the basic version contains the low bit rate stream of the live show, but the normal version contains the high bit rate stream of the same live show) of the same real-time program with different requirements. The selective viewing provides more flexibility to the terminal/receiver users and ensures the users can consume their interested program even as the terminal/receiver is under a bad reception condition, and consequently enhances the user experience. A service fragment may be provided for the streaming program. Two access fragments may be provided, associated with the service fragment, to respectively specify the two access channels, one access fragment only delivers the basic version which only contains the audio component or contains the low bit rate streams of the original audio and video streams, another access fragment delivers the normal version which contains the original high rate streams of the audio and video streams.

The service fragment and the access fragment may be used to similarly distinguish between two different programs, each of which has a different language.

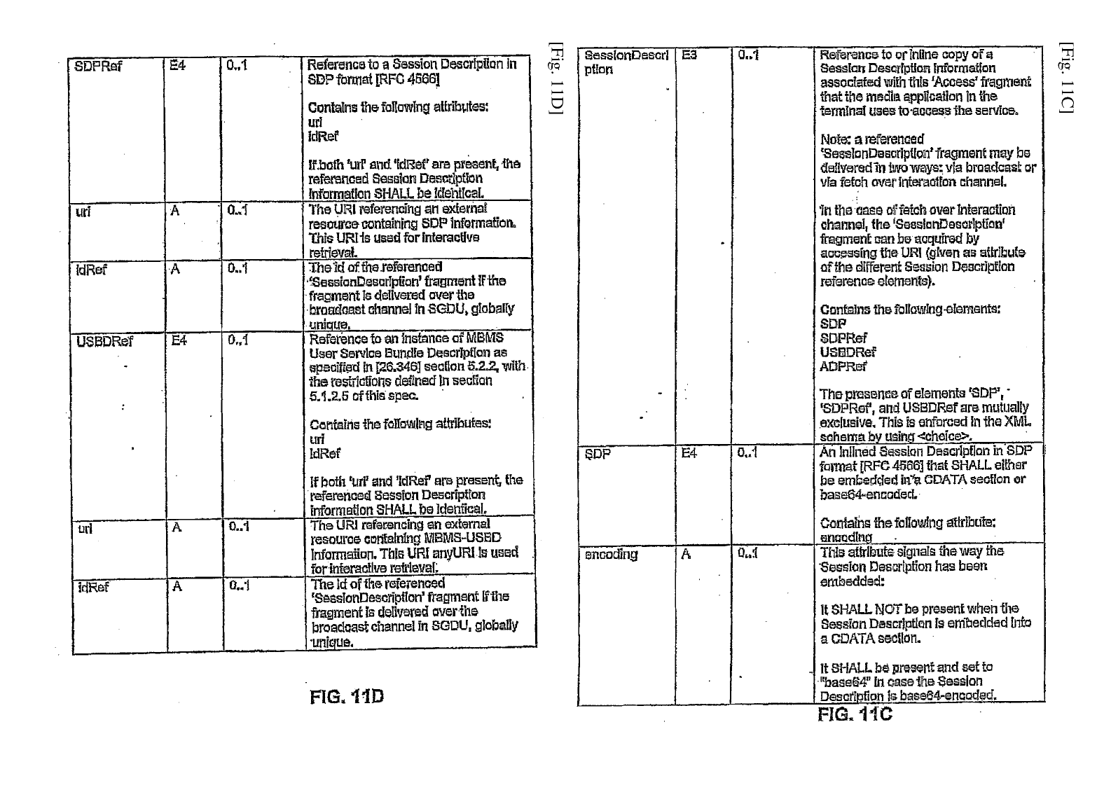

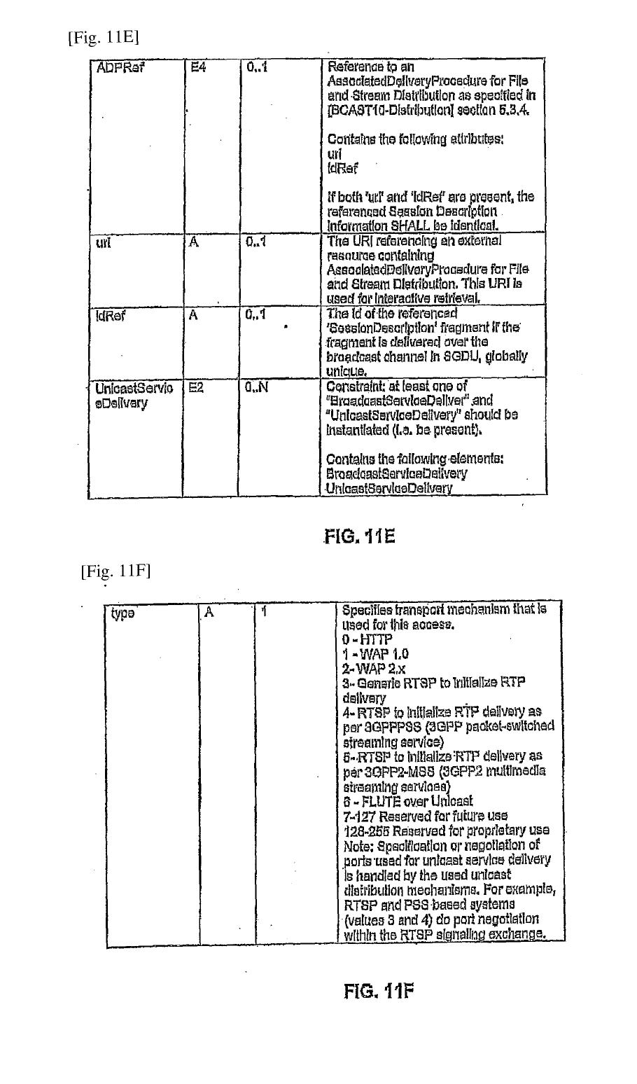

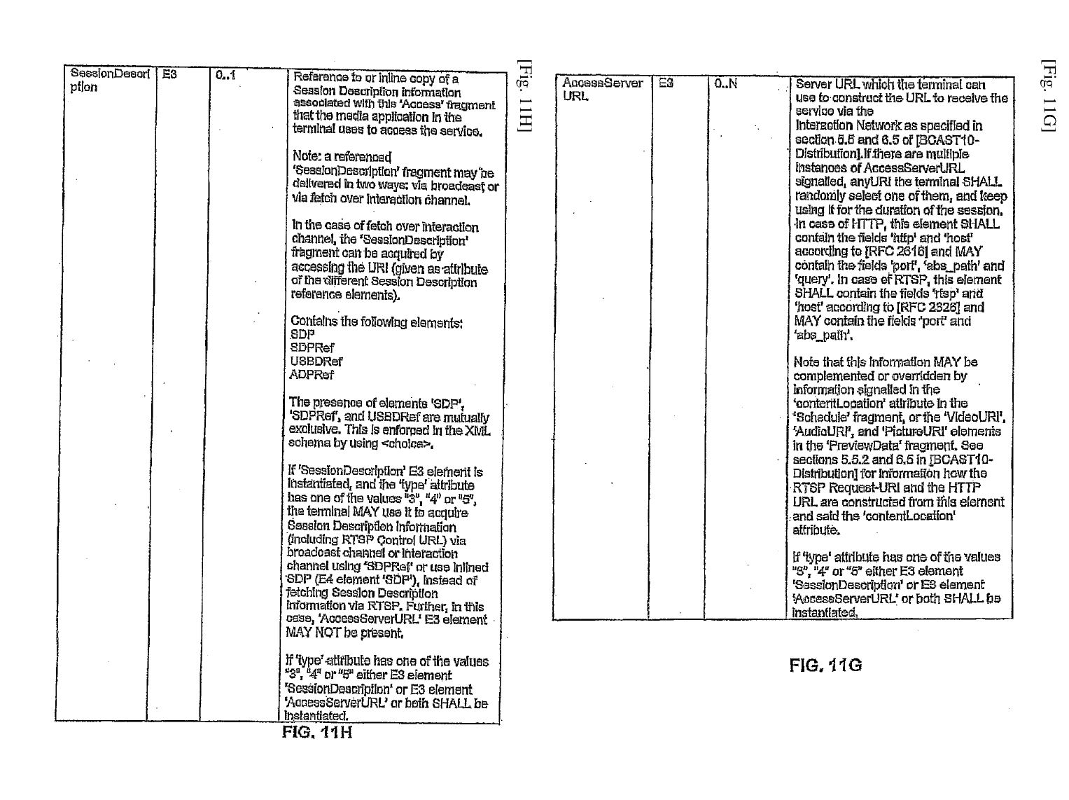

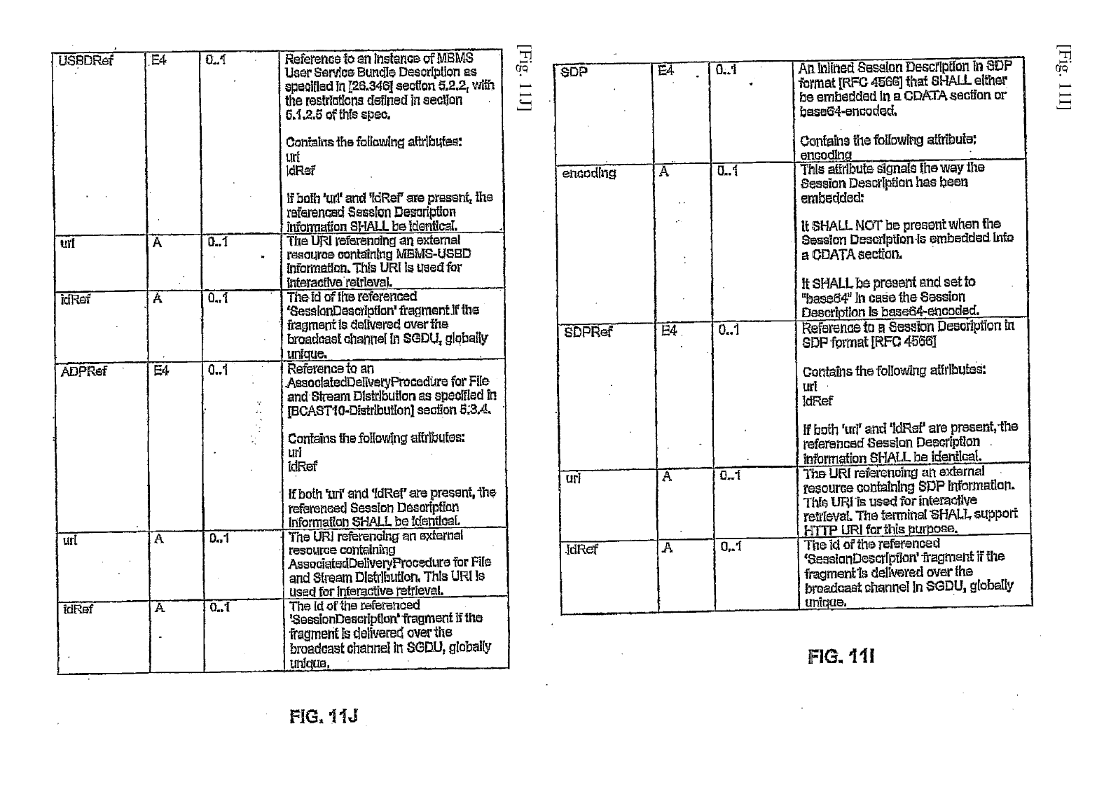

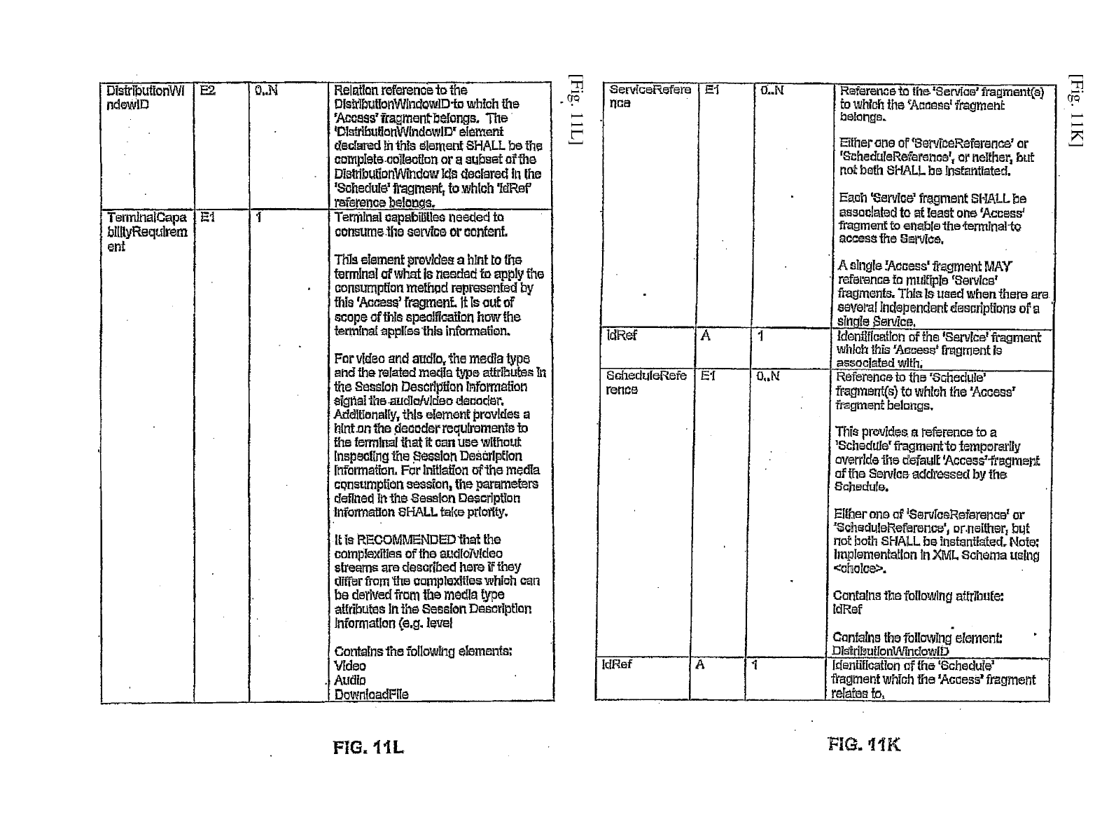

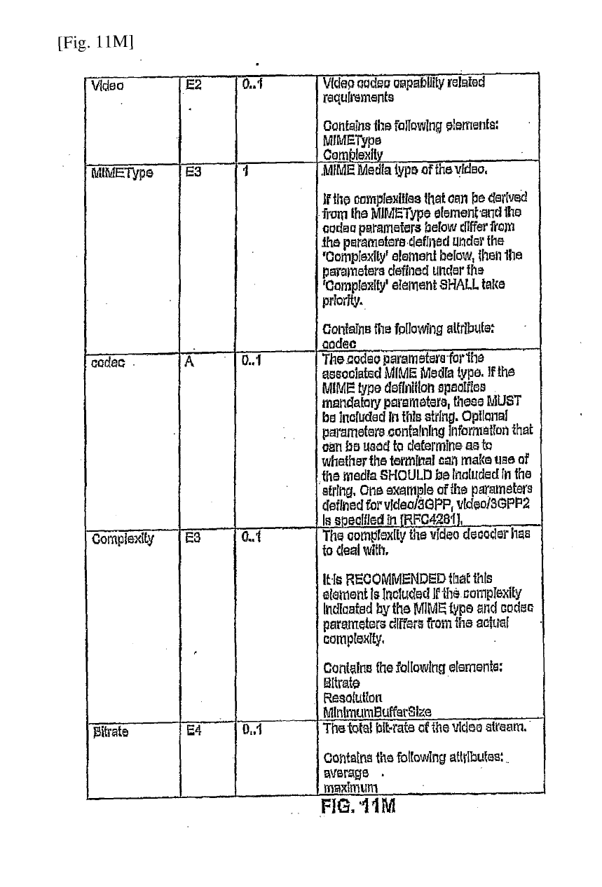

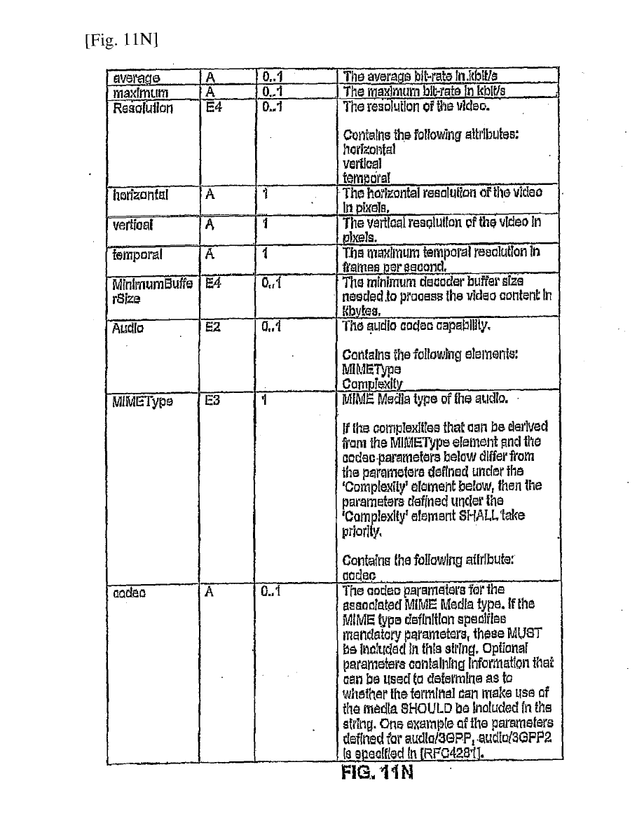

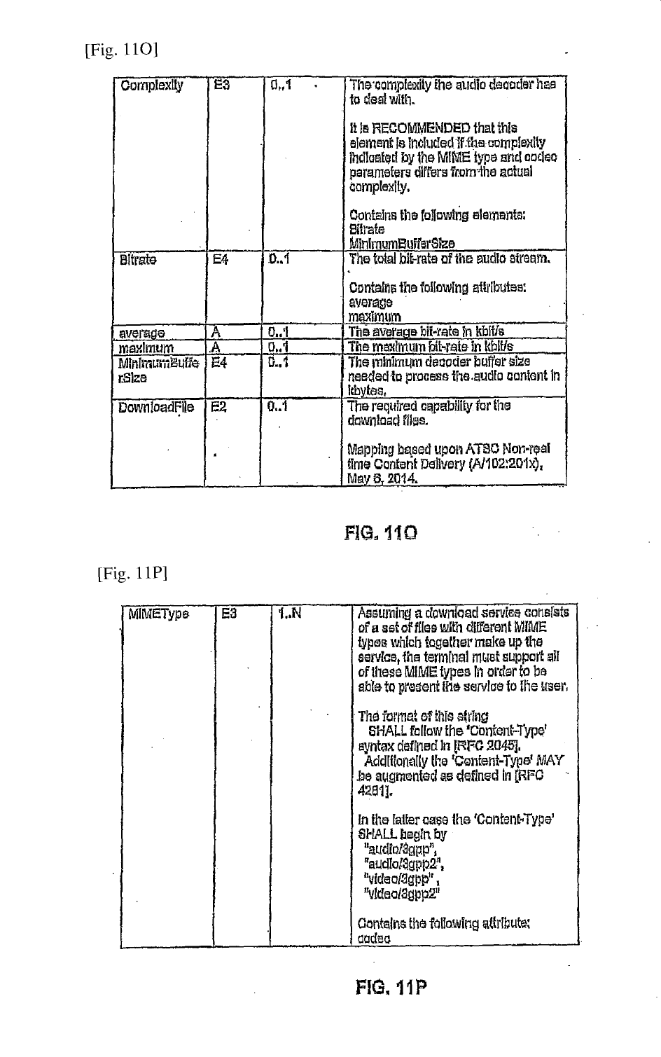

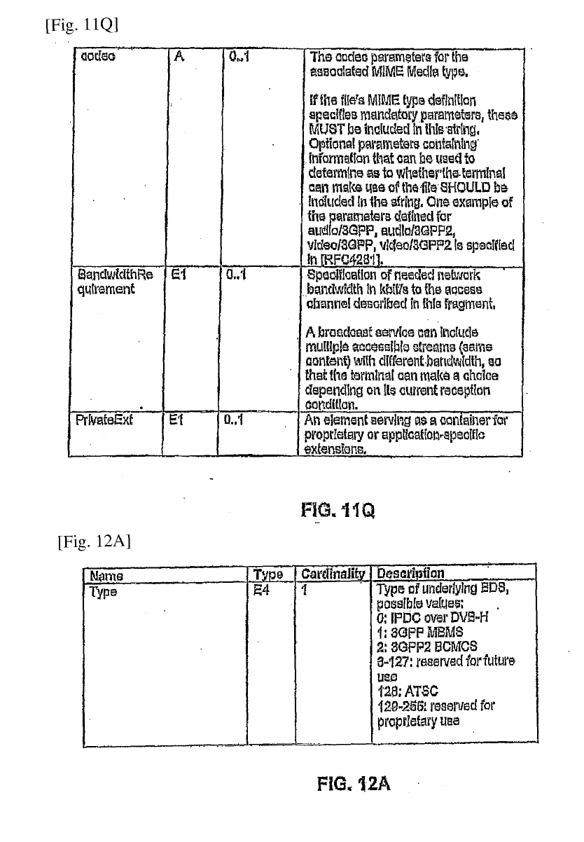

Referring to FIGS. 11A-11Q, an exemplary Access Fragment is illustrated, with particular modifications to Open Mobile Alliance, Service Guide for Mobile Broadcast Services, Version 1.0.1, Jan. 9, 2013, incorporated by refrerence herein it is entirety. The AccessType element may be modified to include a constraint of at least one of “BroadcastServiceDelivery” and “UnicastServiceDelivery” should be instantiated. Thus either or both of the elements “BroadcastServiceDelivery” and “UnicastServiceDelivery” is required to be present. In this manner, the AccessType element provides relevant information regarding the service delivery via BroadcastServiceDelivery and UnicastServiceDelivery elements, which facilitates a more flexible access fragment.

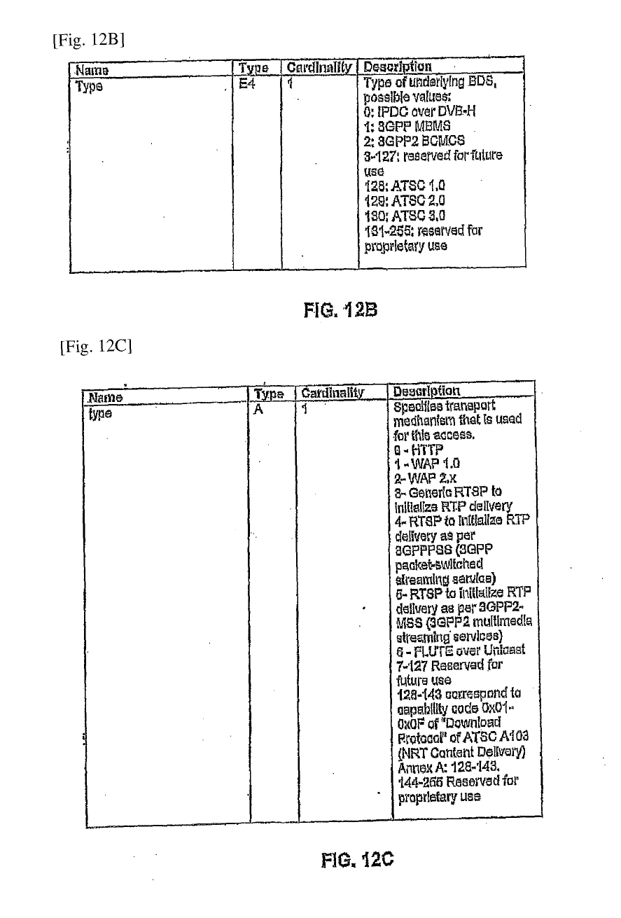

The BDSType element is an identifier of the underlying distribution system that the Access fragment relates to, such as a type of DVB-H or 3GPP MBMS, is preferably a required element (cardinality=1), rather than being an optional element (cardinality=0 . . . 1). The Type sub-element of the BDSType element is preferably a required element (cardinality=1), rather than being an optional element (cardinality=0 . . . 1). Additional information regarding Type sub-element is provided below in relation with FIG. 12A and FIG. 12B. The Version sub-element of the BDSType element is preferably a required element (cardinality=1), rather than being an optional element (cardinality=0 . . . 1).

The SessionDescription element is a reference to or inline copy of a Session Description information associated with this Access fragment that the media application in the terminal uses to access the service. The Version sub-element of the BDSType element is preferably an optional element (cardinality=0 . . . 1), rather than being a required element (cardinality=1). Alternatively the SessionDescription element should be omitted.

The UnicastServiceDelivery element may be modified to include a constraint of at least one of “BroadcastServiceDelivery” and “UnicastServiceDelivery” should be instantiated. In this manner, the UnicastServiceDelivery element may include both BroadcastServiceDelivery and UnicastServiceDelivery, which facilitates a more flexible access fragment.

The TerminalCapabilityRequirement describes the capability of the receiver or terminal needed to consume the service or content. The TerminalCapabilityRequirement element is preferably a required element (cardinality=1), rather than being an optional element (cardinality=0 . . . 1).

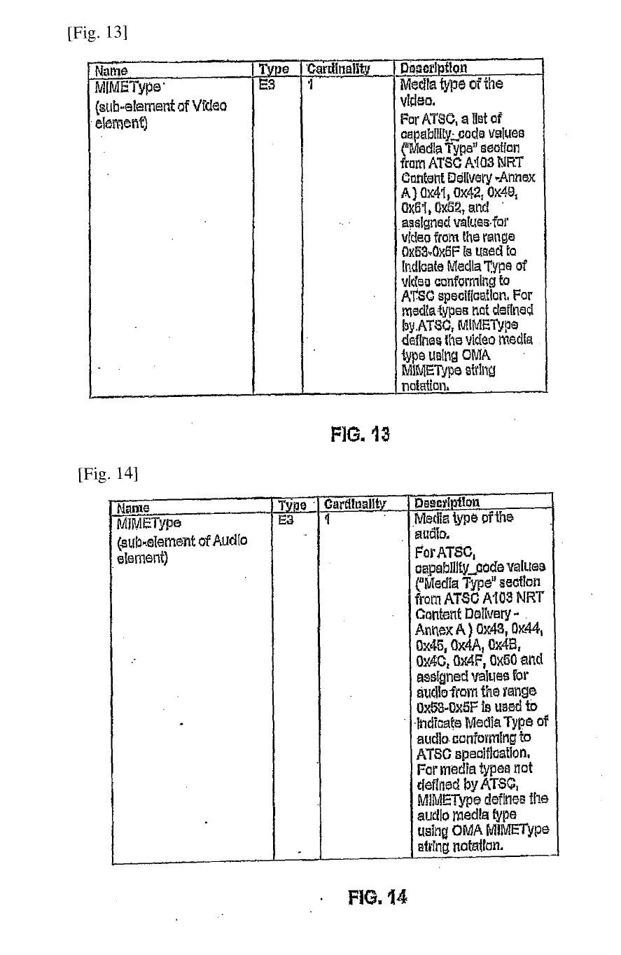

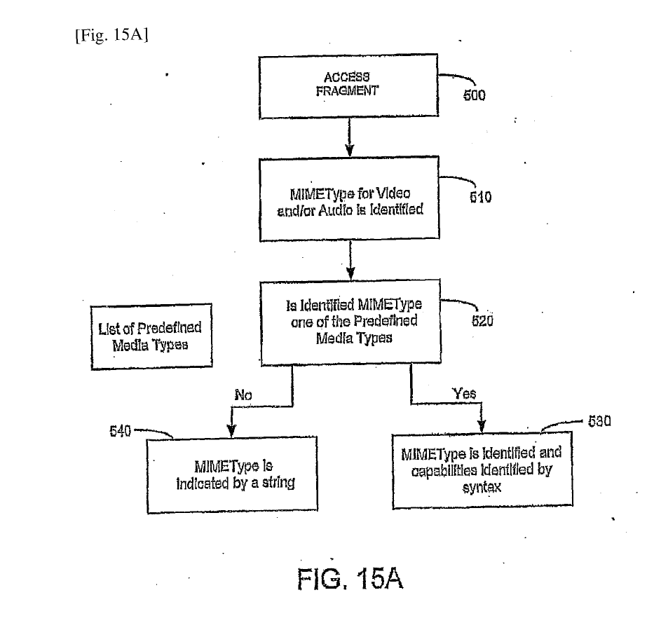

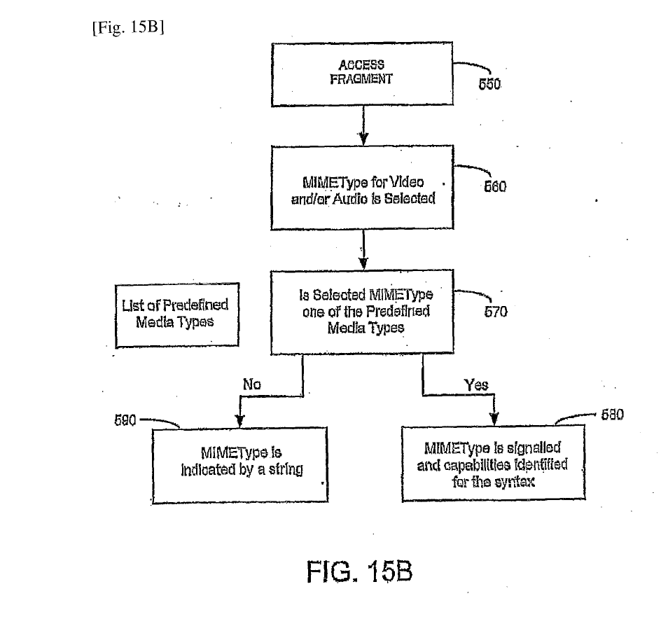

The MIMEType describes the Media type of the video. The MIMEType element is preferably a required element (cardinality=1), rather than being an optional element (cardinality=0 . . . 1). Additional information regarding MIMEType sub-element is provided below in relation with FIG. 13, FIG. 14, FIG. 15.

Some elements and attributes of the Access Fragment should be omitted, including FileDescription elements and attributes related to the FLUTE protocol and the RFC 3926. Other elements and attributes of the Access Fragment should be omitted, including KeyManagementSystem elements related to security elements and attributes. Yet other elements and attributes of the Access Fragment should be omitted, including ServiceClass, ReferredSGInfo, BSMSelector, idRef, Service, PreviewDataReference, idRef, usage, NotificationReception, IPBroadcastDelivery, port, address, PollURL, and PollPeriod.

Referring to FIG. 12A, the Type sub-element of the BroadcastServiceDelivery element may be modified to include a new type value of 128: ATSC in the range reserved for proprietary use. In this case the sub-element Version of the element BDSType in FIG. 11B can be used to signal the Version of ATSC used. As an example the Version could be “1.0” or “2.0” or “3.0” indicating together with Type sub-element (with value of 128 for ATSC) indicating ATSC 1.0, ATSC 2.0 and ATSC 3.0 respectively. Alternatively referring to FIG. 12B, the Type sub-element of the BroadcastServiceDelivery element may be modified to include new type values of 128: ATSC 1.0; 129: ATSC 2.0; 130: ATSC 3.0, in the range reserved for proprietary use.

Referring to FIG. 12C, the type attribute of the UnicastServiceDelivery may be modified to add a new type value from capability_code “Download Protocol” section from ATSC A103 (NRT Content Delivery) Annex A: 128-143: corresponding to ca-pability_code 0x01-0x0F. Alternatively other capability code's defined by ATSC could be mapped to the values for the type attribute in the range reserved for proprietary use. For example values 128 to 159 for type attribute could be mapped to ca-pability_code values 0x81-0x9F.

In ATSC A103-NRT Content Delivery, capability signaling is done using capability codes. The capabilities descriptor provides a list of “capabilities” (download protocols, FEC algorithms, wrapper/archive formats, compression algorithms, and media types) used for an NRT service or content item (depending on the level at which the descriptor appears), together with an indicator of which ones are deemed essential for meaningful presentation of the NRT service or NRT content item. These are signaled via capabilities_descriptor( ) or optionally via Service and Content fragments.

It is proposed to indicate the required device capabilities by using and extending the TerminalCapabilityRequirement element in Access fragment of OMA BCAST Service guide. TerminalCapabilityRequirement provides ability to indicate terminal capabilities needed to consume the service or content. These are extended with inclusion of capability_code values as defined by ATSC. Following discussion points describe reasoning and asserted benefits of this proposed design choice for capability indication:

Regarding signaling capabilities using TerminalCapabilityRequirement element in Access fragment:
In ATSC A103 the capability code signaling is done in Service and Content fragment by defining several elements and sub-elements. For making sure that a certain content is able to be consumed by the receiver capability code related elements in both service fragment and content fragment need to be parsed and examined since it is allowed that a capability is listed as non-essential for the service but essential for the content.

Since Access fragment's TerminalCapabilityRequirement already supports signaling information about media types, codecs it is proposed to use this for ATSC3 service announcement. Also TerminalCapabilityRequirement element in Access fragment provides ability to signal more precise information regarding video and audio codec, and “complexity” (including required average and maximum bitrate, horizontal, vertical and temporal resolution and minimum buffer size). This information is useful to determine the receiver's ability to consume the service.

It is asserted that the proposed use and extension of TerminalCapabilityRequirement avoids replication of similar functionality in other fragments.

Regarding essential and non-essential capabilities signaling:

It is also asserted that for the service announcement purpose signaling required capabilities via access fragment does not require further distinction between essential and non-essential capabilities as the purpose of this signaling is only to indicate to the user if receiver is capable of consuming a service. This purpose is satisfied as long as the receiver has resource support for indicated required capability for any one of the access fragment of the service.

Additionally since in A103 a capability listed as non-essential at the service level could in fact be essential for content further illustrates that the essential versus non-essential capabilities distinction is not beneficial and unnecessarily increases the complexity of service announcement.

Regarding inclusion of capability_codes in TerminalCapabilityRequirement:

A benefit of capability_code Media Types defined by ATSC is that they can provide more constrained description regarding AV media types compared to IANA defined MIME Media Types. As a result the MIMEType sub-element of Video and Audio element in Access Fragment's TerminalCapabilityRequirement element are extended to signal ATSC A103 defined capability_code if the media conforms to ATSC specification. If not then the MIMEType sub-element is used to signal IANA or un-registered MIME Media Type.

Similarly “type” attribute of Access fragment which provides information about the transport mechanism used for access is extended to indicate capability_code values from “Download Protocol” section of ATSC A103.

Referring to FIG. 13 and FIG. 14, the TerminalCapabilityRequirement of the Access Fragment relates to the capabilities needed to consume the service or content. Having this information in the Access Fragment, such as in the MIMEType, reduces the complexity of the decoder. For the MIMEType sub-element of the video sub-element of the TerminalCapabilityRequirement and the MIMEType sub-element of the audio sub-element of the TerminalCapabilityRequirement, it is desirable that the cardinality indicate that each of the elements (MIMEType sub-element of Video and MIMEType sub-element of Audio) are required (cardinality=1). It is further desirable to include Terminal Capability element and to signal capability_code Media Types in MIMEType sub-elements for Video and Audio sub-elements for particular media types, such as those defined by ATSC. By using these particular video and audio sub-elements being signaled in MIMEType, sufficiently well defined information may be provided for the terminal capability requirements to render the media without ambiguity. For media types not defined for the particular media types, such as those defined by ATSC, MIMEType defines the media type using a string notation.

A list of capability_code values (“Media Type” section from ATSC A103 NRT

Content Delivery-Annex A) may be included to indicate the Media Type of video conforming to the ATSC specification. Media Type 0x41 AVC standard definition video (Section A.2.8), Media Type 0x42 AVC high definition video (Section A.2.9), Media Type 0x49 AVC mobile video (Section A.2.15), Media Type 0x51 Frame-compatable 3D video (Side-by-Side) (Section A.2.23), and Media Type 0x52 Frame-compatable 3D video (Top-and-Bottom) (Section A.2.24), and Media Type with assigned values by ATSC for the video from the range 0x53-0x5F to indicate its conformance to the ATSC specification.

For media types not defined by ATSC, MIMEType defines the video media type using OMA MIMEType string notation. For example if the terminal capability require video codec of type MEDX-ES, then since this is not one of the codec in the list of pre-defined capability_codes, the MIMEType will indicate string “video/MEDX-ES”.

In one embodiment following new capability_codes are defined:

```
      0x53- HEVC legacy “profile” video
      0x54 - HEVC progressive “profile” video
      where HEVC related to High efficiency video coding standard
coded video, such as for example ISO/IEC 23008-2: 2013, International
Organization for Standardization, incorporated by reference herein
in its entirety.
```

In another embodiment following new capability_codes are defined:

0x55- ATSC HEVC mobile “profile” video
0x56 - ATSC HEVC fixed “profile” video

Alternatively, a new capability_code is defined to signal media types that are not in the list of defined capability_code Media Types.

For example:
0x57—HEVC legacy “profile” video

In one embodiment following new capability_codes are defined:

```
      0x53- SHVC legacy “profile” video
      0x54 - SHVC progressive “profile” video
      where SHVC related to scalable extension of High efficiency
video coding standard coded video, such as for example, J. Chen,
J. Boyce, Y. Ye, M. Hannuksela, “SHVC Draft 4”, JCTVC-O1008,
Geneva, November 2013 incorporated by reference herein in its entirety;
the scalable specification may include, J. Chen, J. Boyce, Y. Ye,
M. Hannuksela, Y. K. Wang, “High Efficiency Video Coding (HEVC)
Scalable Extension Draft 5, JCTVC-P1008, San Jose, January 2014,
incorporated by reference herein in its entirety. The scalable specification
may include “High efficiency video coding (HEVC) scalable extension
Draft 6” Valencia, March 2014, incorporated by reference herein
in its entirety.
```

In another embodiment following new capability_codes are defined:

0x55 - ATSC SHVC mobile “profile” video
0x56 - ATSC SHVC fixed “profile” video

Alternatively, a new capability_code is defined to signal media types that are not in the list of defined capability_code Media Types.

For example:
0x57-SHVC legacy “profile” video

The values used above are examples and other values may be used for signaling the capability_codes. For example values 0x58 and 0x59 could be used in place of values 0x53 and 0x54.

Example constraints which are related to defining a new capability_code for HEVC video as specified by ATSC are shown below:

By way of example, the capability_code value 0x54 may represent the receiver ability to support HEVC video encoded in conformance with the ATSC video specification. The capability_code value 0x54 may not appear along with capability_code values 0x42, 0x43, 0x22, 0x23, or 0x24, since each of these code values implies support for AVC with certain specified constraints.

Example constraints defined for HEVC video include following constraints, for example as defined in, B. Bros, W-J. Han, J-R Ohm, G. J. Sullivan, and T. Wiegand, “High efficiency video coding (HEVC) text specification draft 10”, JCTVC-L1003, Geneva, January 2013, incorporated by reference herein in its entirety.

general_progressive_source_flag in profile_tier_level syntax structure in Sequence Parameter Set (SPS) and Video Parameter Set (VPS) is required to be set equal to 1.

general_interlaced_source_flag flag in profile_tier_level syntax structure in Sequence Parameter Set (SPS) and Video Parameter Set (VPS) is required to be set equal to 0.

general_frame_only_constraint_flag in profile_tier_level syntax structure in Sequence Parameter Set (SPS) and Video Parameter Set (VPS) is required to be set equal to 1.

In one variant: If vui_parameters_present_flag in SPS is equal to 1 then it is required that field_seq_flag is set equal to 0 and frame_field_info_present_flag is set equal to 0.

In another variant: vui_parameters_present_flag in SPS is required to be set to 1 and it is required that field_seq_flag is set equal to 0 and frame_field_info_present_flag is set equal to 0.

vui_parameters_present_flag in SPS is required to be set to equal to 1, vui_timing_info_present_flag in SPS is required to be set equal to 1, vui_hrd_parameters_present_flag in SPS is required to be set equal to 1, and:

in one variant: fixed_pic_rate_general_flag[i] is required to be set equal to 1 or fixed_pic_rate_within_cvs_flag [i] is required to be set equal to 1 for all value of i in the range 0 to maxNumSubLayersMinus1, inclusive.

in another variant: fixed_pic_rate_general_flag[i] is required to be set equal to 1 or fixed_pic_rate_within_cvs_flag [i] is required to be set equal to 1 for i equal to maxNumSubLayersMinus1.

Similar other constraints may be defined for other HEVC and/or SHVC profiles defined by ATSC.

A list of capability_code values (“Media Type” section from ATSC A103 NRT Content Delivery-Annex A) may be included to indicate the Media Type of audio conforming to the ATSC specification. Media Type 0x43 AC-3 audio (Section A.2.10), Media Type 0x44 E-AC-3 audio (Section A.2.11), Media Type 0x45 MP3 audio (Section A.2.12), Media Type 0x4A HE AAC v2 mobile audio (Section A.2.16), Media Type 0x4B HE AAC v2 level 4 audio (Section A.2.17), Media Type 0x4C DTS-HD audio (Section A.2.21), Media Type 0x4F HE AAC v2 with MPEG Surround (Section A.2.21), Media Type 0x50 HE AAC v2 Level 6 audio (Section A.2.22), and Media Type with the assigned values for the audio from the range 0x53-0x5F to indicate its conformance to the ATSC specification.

For media types not defined by ATSC, MIMEType defines the audio media type using OMA MIMEType string notation. For example if the terminal capability require audio codec of type AUDX-ES, then since this is not one of the codec in the list of pre-defined capability_codes, the MIMEType will indicate string “audio/AUDX-ES” In one embodiment following new capability_codes are defined for ATSC selected audio coding standard with additional constraints as defined by ATSC:

0x57—ATSC 3 Audio 1
0x58—ATSC 3 Audio 2
Referring to FIG. 15A, an exemplary flow is illustrated for the signaling of the predefined media types, including audio and video. The access fragment is received 500 by the terminal device. For the received access fragment, the MIMEType for video and/or audio is identified 510. Next, the terminal device determines if the MIMEType is one of the predefined media types 520. If the MIMEType is one of the predefined media types 520, then the MIMEType is identified and the capabilities required to render the content are likewise identified by the syntax 530. One example of predefined media types are the capability_codes of ATSC for video and audio as described above. If the MIMEType is not one of the predefined media types 520, then the MIMEType is indicated by a string value, indicating a media type not further defined by the syntax, and the capabilities required to render the content are not further defined by the syntax 540.

Referring to FIG. 15B, another exemplary flow is illustrated for the signaling of the predefined media types, including audio and video. The access fragment is constructed 550 by the encoding device/broadcast or broadband server side. For the constructed access fragment, the MIMEType for video and/or audio is selected 560. For example the selection is based on the codec used and other media type related parameters used for the media (audio, video, etc.) encoding. Next, the encoder determines if the MIMEType is one of the predefined media types 570. In some cases these may be predefined media types with per defined constraints as defined above. If the MIMEType is one of the predefined media types 570, then the MIMEType is signalled and the capabilities required to render the content are likewise signalled for the syntax 580. One example of predefined media types are the capability_codes of ATSC for video and audio as described above. If the MIMEType is not one of the predefined media types 570, then the MIMEType is signalled by a string value, indicating a media type not further defined by the syntax, and the capabilities required to render the content are not further defined by the syntax 590.

In some embodiments, it is desirable to include additional syntax elements and/or attributes for the service guide element. For example, the new elements and/or attributes may include:

VideoRole
AudioMode
CC
Presentable
url

These new elements can be addressed by a syntax element that the system may enable announcement using the receiver's on-screen program guide of Components within a given Service that would be helpful to a viewer (e.g., multi-view service information, alternative audio tracks, alternative subtitles, etc.).

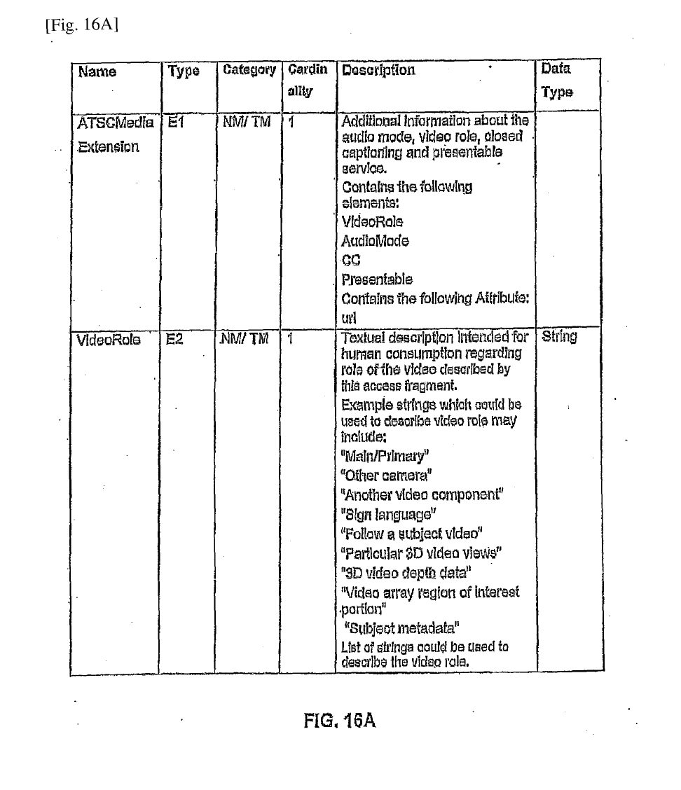

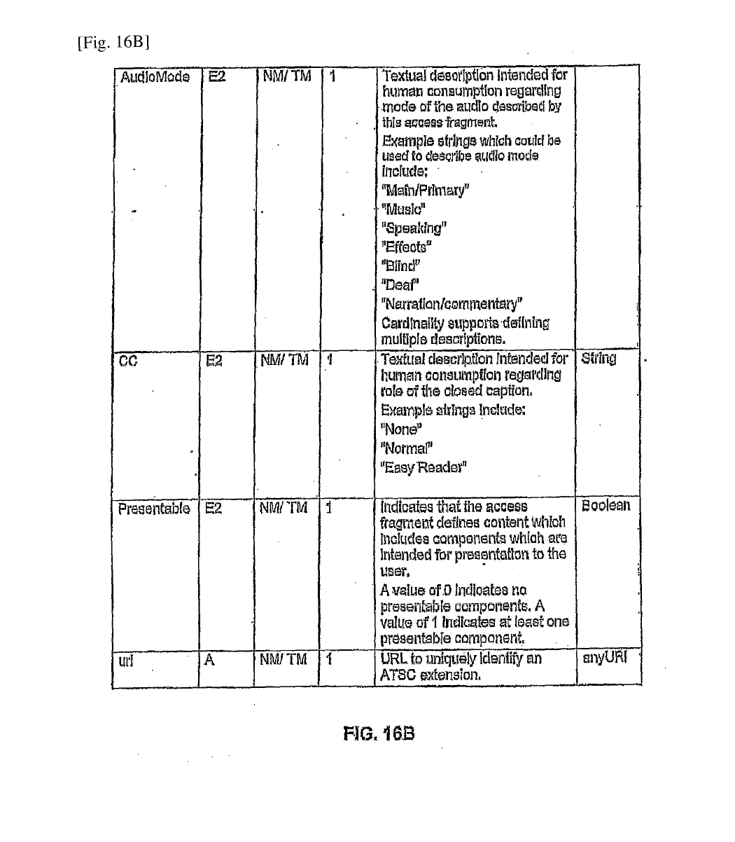

Referring to FIGS. 16A-16B, these are preferably added to the access fragment, but may also or alternatively be added to the Content fragment or alternatively be added to the Service fragment. For example, these may be included within a PrivateExt element in Access fragment and/or Content fragment and/or Service fragment. The cardinality is preferably selected to be 1 . . . N (for VideoRole and AudioMode elements) because more than one may be selected in some cases, such as, the VideoRole being the “Primary (default) video” and simultaneously a “3D video right/left view”.

In an alternative embodiment, instead of using Data Type “string” for the VideoRole, AudioMode, CC, Presentable elements other data types may be used. For example the Data Type unsignedInt may be used. In another example a string of limited length may be used, e.g. string of 5 digits.

In another embodiment a list of enumerated values may be defined for VideoRole, Audio Mode and CC and then represented as values for those elements.

For example, for VideoRole the following values may be pre-defined and then used to signal the value.
0 Main/Primary video
1 Other Camera view
2 Another video component
3 Sign language
4 Follow a subject video
5 Particular 3D video views
6 3D video depth data
7 Video array region of interest portion
8 Subject metadata
9 Undefined
10 Reserved

For example, for AudioMode the following values may be pre-defined and then used to signal the value
0 Main/Primary
1 Music
2 Speaking
3 Effects
4 Blind
5 Deaf
6 Narration/commentary
7 Undefined
8 Reserved

For example, for CC the following values may be pre-defined and then used to signal the value
0=None
1=Normal
2=Easy Reader
   An example XML schema syntax for the above additions is shown below.

```
<xs:element name=“ATSC3MediaExtension”
type=“ATSC3MediaExtensionType” minOccurs=“0”
maxOccurs=“unbounded”/>
<xs:complexType name=“ATSC3MediaExtensionType”>
      <xs:sequence>
      <xs:element name=“VideoRole” type=“LanguageString”
      minOccurs=“1” maxOccurs=“1”/>
      <xs:element name=“AudioMode” type=“LanguageString”
      minOccurs=“1” maxOccurs=“1”/>
      <xs:element name=“CC” type=“LanguageString”
      minOccurs=“1” maxOccurs=“1”/>
      <xs:element name=“Presentable” type=“boolean”
      minOccurs=“1” maxOccurs=“1”/>
      </xs:sequence>
      <xs:attribute name=“url” type=“xs:anyURI” use=“required”/>
</xs:complexType>
```

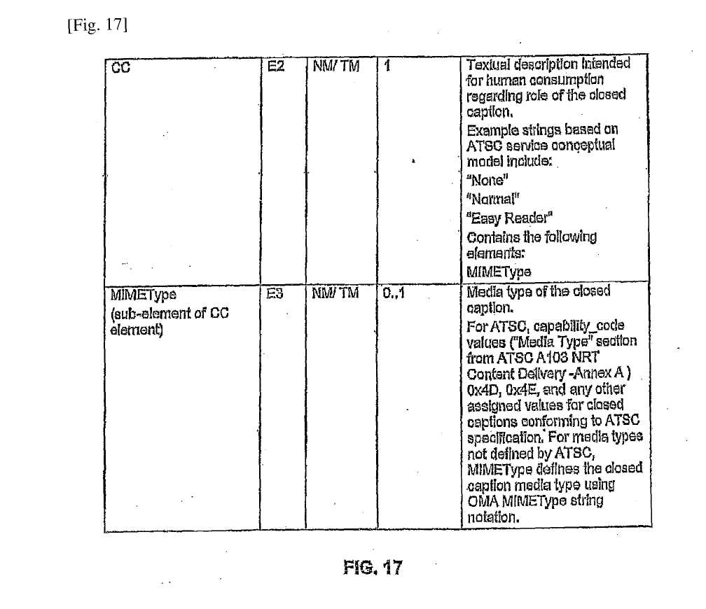

Referring to FIG. 17, another exemplary embodiment of the CC is illustrated. A list of capability_code values (“Media Type” section from ATSC A103 NRT Content Delivery-Annex A) may be included to indicate the Media Type of closed captioning conforming to the ATSC specification. Media Type 0x4D CFF-TT (Section A.2.19), Media Type 0x4E CEA-708 captions (Section A.2.20), may be used to define the ATSC closed captioning.

An example XML schema syntax for the above modification is shown below.

```
<xs:element name=“ATSCMediaExtension”
type=“ATSCMediaExtensionType” minOccurs=“0”
maxOccurs=“unbounded”/>
<xs:complexType name=“ATSCMediaExtensionType”>
      <xs:sequence>
      <xs:element name=“VideoRole” type=“LanguageString”
      minOccurs=“1” maxOccurs=“1”/>
      <xs:element name=“AudioMode” type=“LanguageString”
      minOccurs=“1” maxOccurs=“1”/>
      <xs: complexType name=“CC” type=“LanguageString”
      minOccurs=“1” maxOccurs=“1”/>
      <xs:sequence>
      <xs:element name=“MIMEType” type=“ “xs:string””
      minOccurs=“0” maxOccurs=“1”/>
      </xs:sequence>
      </xs:complexType>
      <xs:element name=“Presentable” type=“boolean”
      minOccurs=“1” maxOccurs=“1”/>
      </xs:sequence>
      <xs:attribute name=“url” type=“xs:anyURI” use=“required”/>
</xs:complexType>
```

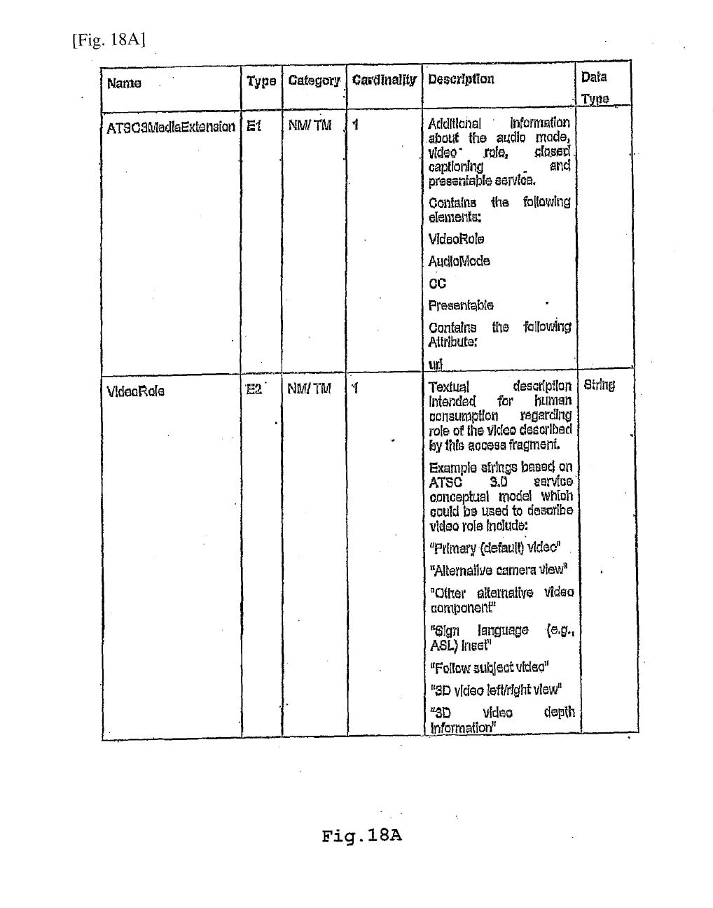

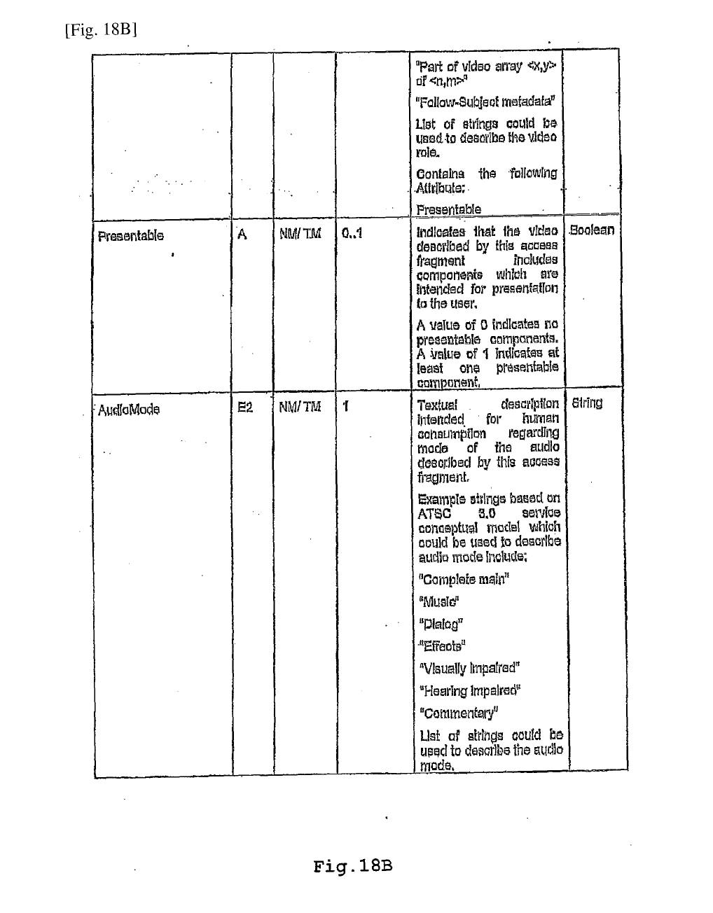

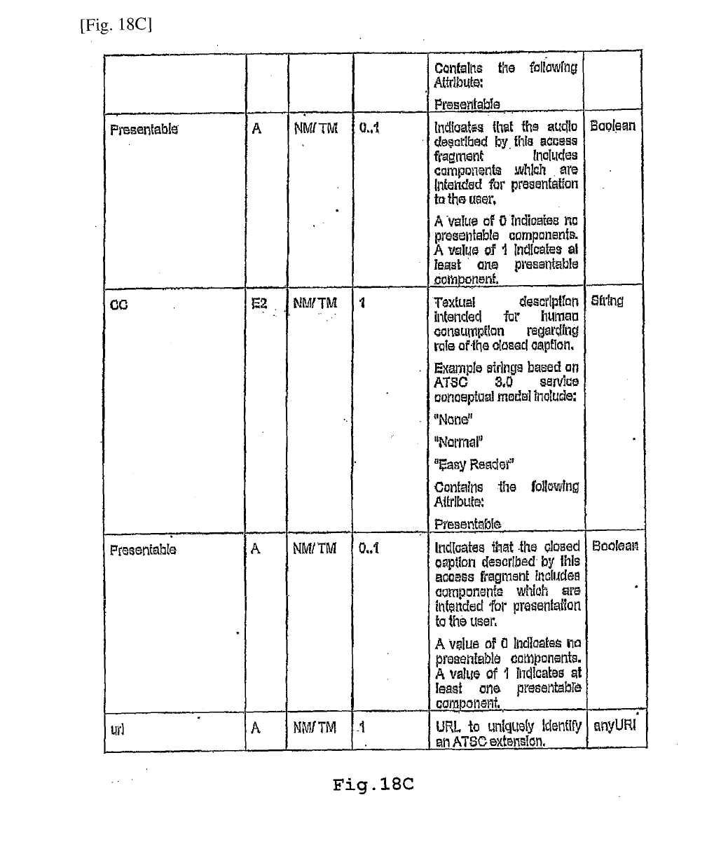

Referring to FIG. 18A, FIG. 18B, and FIG. 18C another exemplary embodiment of the Presentable is illustrated. The Presentable element may instead be signalled as attribute for each of the VideoRole, AudioMode, CC elements as shown in FIG. 18A, FIG. 18B, and FIG. 18C.

An example XML schema syntax for the above modification is shown below.

An example XML schema syntax for the above additions is shown below.
<xs:element name=“ATSC3MediaExtension”
type=“ATSC3MediaExtensionType” minOccurs=“0”
maxOccurs=“unbounded”/>
<xs:complexType name=“ATSC3MediaExtensionType”>
<xs:sequence>
<xs:element name=“VideoRole” type=“LanguageString” minOccurs=“1”
maxOccurs=“1”>
<xs:complexType>
<xs:attribute name=“Presentable” type=“boolean” minOccurs=“0”
maxOccurs=“1”/>
</xs:complexType>
</xs:element>
<xs:element name=“AudioMode” type=“LanguageString” minOccurs=“1”
maxOccurs=“1”>
<xs:complexType>
<xs:attribute name=“Presentable” type=“boolean” minOccurs=“0”
maxOccurs=“1”/>
</xs:complexType>
</xs:element>
<xs:element name=“CC” type=“LanguageString” minOccurs=“1”
maxOccurs=“1”>
<xs:complexType>
<xs:attribute name=“Presentable” type=“boolean” minOccurs=“0”
maxOccurs=“1”/>
</xs:complexType>
</xs:element>
</xs:sequence>
<xs:attribute name=“url” type=“xs:anyURI” use=“required”/>
</xs:complexType>

Additionally regarding signaling capabilities using new elements and attributes defined below:
In ATSC A103 a string representation of a capability may only be used for capabilities that do not have a capability_code listed in Table A1. However certain ca-pability_codes in Table A-1 require additional capability information to make them complete and thus in those cases instead a capability string should be supported to be used.

As an example the capability_code value 0x51 represents the receiver ability to support display of 3D video in either 720p or 1080i side-by-side format as specified in Section 5.3 of A/104 Part 3. However since the capability_code value 0x51 does not indicate any codec information, it may be accompanied by codec information. In this case the codec information may be a capability_code value (e.g. 0x42) or it may be capability string (e.g. if a codec different than capability codes is used) to provide the receivers with the complete information.

Separate indication of group of Capability codes and/or strings (CapabilityOrGroup and its sub-element) that are combined by OR logic to represent a single capability is supported in addition to CapabilityCodes and CapabilityString elements.

CapabilityString cardinality is indicated as 1 . . . N where as it should be 0 . . . N as CapabilityCodes may be sufficient thus not needing CapabilityString in typical cases.

In ATSC A103 the capability code signaling is done by capabilities_descriptor( ) or optionally in Service and Content fragments by defining several elements and sub-elements. For making sure that a certain content is able to be consumed by the receiver capability code related elements in both service fragment and content fragment need to be parsed and examined since additional essential capabilities could be defined at the content level and also since it is allowed that a capability is listed as non-essential for the service but essential for the content.

This two level indication is complicated as it is always needed to parse the capabilities required for a content.

The service announcement purpose signaling required capabilities does not need further distinction between essential and non-essential capabilities as the purpose of this signaling is only to indicate to the user if receiver is capable of consuming a service. This purpose is satisfied as long as the receiver has resource support for indicated required capability.

Additionally since in A103 a capability listed as non-essential at the service level could in fact be essential for content further illustrates that the essential versus non-essential capabilities distinction is not beneficial and unnecessarily increases the complexity of service announcement.

Thus a method for indicating the required device capability for consumption of a service and/or content is described. The indication is intended for machine consumption. Such that when a receiver receives this indication information it is able to determine if it can decode and present the service and/or content to user. The indication is intended to be signaled in service announcement/service guide.

These new elements could be signaled in OMA BCAST Service guide Content fragment

In other embodiments they may be instead or in addition be signaled in OMA BCAST service guide Service fragment and/or OMA BCAST service guide Access fragment or some other fragment.

In one embodiment these are added inside PrivateExt element in Content fragment.

Content Fragment elements:

| | | | Cardi- | | |
|---|---|---|---|---|---|
| Name | Type | Category | nality | Description | Data Type |
| Required | E2 | NO/TO | 0 . . . 1 | Required Capabilities for | |
| Capabilities | | | | decoding and presenting | |
| | | | | content. | |
| | | | | Contains the following | |
| | | | | elements: | |
| | | | | CapabilityCodesList | |
| | | | | CapabilityString | |
| | | | | In some embodiments the | |
| | | | | Required Capabilities will be | |
| | | | | additional capabilities that are | |
| | | | | required in addition to those | |
| | | | | signaled at the service level. | |
| CapabilityCodesList | E3 | NO/TO | 0 . . . N | A space separated list of | list of |
| | | | | required capability codes. | unsignedInt |
| | | | | Each capability code in the list | |
| | | | | is code point from Table A.1. | |
| | | | | The list of code points in one | |
| | | | | CapabilityCodesList | |
| | | | | represents the required | |
| | | | | capabilities that are combined | |
| | | | | by logical “AND” operation to | |
| | | | | represent total required | |
| | | | | capabilities that are sufficient | |
| | | | | to decode and present the | |
| | | | | content The list may not | |
| | | | | include a code point belonging | |
| | | | | to the capability category | |
| | | | | string code point code points | |
| | | | | (i.e. 0x0000001F, 0x0000002F, | |
| | | | | 0x0000003F, . . . , 0x000000FF). | |
| | | | | Multiple occurrences of | |
| | | | | CapabilityCodesList represent | |
| | | | | alternative sets of required | |
| | | | | capabilities any one of which | |
| | | | | is sufficient to decode and | |
| | | | | present the content. Thus | |
| | | | | either one of the | |
| | | | | CapabilityCodesList or set of | |
| | | | | CapabilityString elements is | |
| | | | | sufficient to provide required | |
| | | | | capabilities for decoding and | |
| | | | | presenting the content. | |
| CapabilityString | E3 | NO/TO | 0 . . . N | A string containing the | string |
| | | | | representation of a capability | |
| | | | | as per Table A.1 and the text | |
| | | | | following it. | |
| | | | | Contains the following | |
| | | | | attribute: | |
| | | | | categorycode | |
| | | | | All the CapabilityString | |
| | | | | element values together | |
| | | | | indicate a complete capability | |
| | | | | set sufficient to provide | |
| | | | | required capabilities for | |
| | | | | decoding and presenting the | |
| | | | | content as an additional | |
| | | | | alternative to the required | |
| | | | | capabilities as signaled by | |
| | | | | CapabilityCodesList | |
| | | | | alternatives. The string could | |
| | | | | be empty (e.g. Null string or | |
| | | | | “ ”) when the category attribute | |
| | | | | has a value equal to a | |
| | | | | capability_code value other | |
| | | | | than the capability category | |
| | | | | string code point code point | |
| | | | | values (i.e. value other than | |
| | | | | 0x0000001F, 0x0000002F, | |
| | | | | 0x0000003F, . . . , 0x000000FF) | |
| | | | | as per Table A1. | |
| categorycode | A | NO/TO | 1 | Gives the capability category | unsignedInt |
| | | | | of the capability represented | |
| | | | | by this CapabilityString | |
| | | | | element. | |
| | | | | If the categoryCode is one of | |
| | | | | capability category string code | |
| | | | | point code point values (i.e. | |
| | | | | 0x0000001F, 0x0000002F, | |
| | | | | 0x0000003F, . . . , 0x000000FF) | |
| | | | | then the CapabilityString must | |
| | | | | not be empty. | |

A103 The following is proposed for Table 1.1 in A103:
The capability_code is assigned 4 bytes instead of 1 byte. One byte is asserted to be too restrictive and not sufficiently extensible in future as it only supports a maximum of 256 capability code points. The legacy code point values from A103 are maintained for backward compatibility by converted from unsigned byte to unsigned Int.

In an alternative embodiment 2 bytes may be assigned for capability_code. In this case for example the elements may be use data type of unsigned Short instead of unsigned Int.

Ability to represent alternative sets of required capabilities any one of which is sufficient to decode and present the content is provide by simple extension.

The table A.1 (capability codes with capability_code field) and Table 8.8 (capability categories with capability_category_code field) is handled in a unified manner by assigning capability_codes in each capability categories for indicating capabilities via capability string.

The new video and audio capability_codes may defined for ATSC constrained video and audio. Example of a code_point for HEVC constrained video is described.

CapabilityString cardinality is indicated as 1 . . . N where as it should be 0 . . . N as CapabilityCodes may be sufficient thus not needing CapabilityString in typical cases.

TABLE A.1
Required Capability Codes

| capability_code | Meaning | Reference |
|---|---|---|
| 0x00000000 | Forbidden | |

Download Protocols

| | | |
|---|---|---|
| 0x00000001 | FLUTE protocol, as specified in | Section A.2.1 |
| | this Standard. | |
| 0x00000002-0x0000000E | Reserved for future ATSC use. | |
| 0x0000000F | Capability category string code | Section CapabilityString |
| | point for Download Protocols | semantics |

FEC Algorithms

| | | |
|---|---|---|
| 0x00000010 | Compact No-Code FEC scheme. | Section A.2.2 |
| 0x00000011 | Raptor algorithm, as specified in | Section A.2.3 |
| | this Standard. | |
| 0x00000012-0x0000001E | Reserved for future ATSC use. | |
| 0x0000001F | Capability category string code | Section CapabilityString |
| | point for FEC Algorithms | semantics |

Wrapper/Archive Formats

| | | |
|---|---|---|
| 0x00000020 | DECE CFF container general | Section A.2.4.1 |
| 0x00000021 | format ZIP format, as specified | Section A.2.29 |
| | in this Standard. | |
| 0x00000022 | DECE CFF container format, | Section A.2.4.2 |
| | Profile PD. | |
| 0x00000023 | DECE CFF container format, | Section A.2.4.3 |
| | Profile SD. | |
| 0x00000024 | DECE CFF container format, | Section A.2.4.4 |
| | Profile HD. | |
| 0x00000025 | ISO Base Media File Format for | Section A.2.5 |
| | MC audio | |
| 0x00000026 | ATSC compliant MPEG-2 transport | Section A.2.6 |
| | stream | |
| 0x00000027 | MP4 constrained container format, | Section A.2.7 |
| | Profile PD2. | |
| 0x00000028 | W3C Web Apps Package | Section A.2.30 |
| 0x00000029-0x0000002E | Reserved for future ATSC use. | |
| 0x0000002F | Capability category string code | Section CapabilityString |
| | point for Wrapper/Archive Formats | semantics |

Compression Algorithms

| | | |
|---|---|---|
| 0x00000030 | DEFLATE algorithm, as specified | Section A.2.31 |
| | in this Standard. | |
| 0x00000031-0x0000003E | Reserved for future ATSC use. | |
| 0x0000003F | Capability category string code | Section CapabilityString |
| | point for Compression Algorithms | semantics |

Media Types

| | | |
|---|---|---|
| 0x00000041 | AVC standard definition video | Section A.2.8 |
| 0x00000042 | AVC high definition video | Section A.2.9 |
| 0x00000043 | AC-3 audio | Section A.2.10 |
| 0x00000044 | E-AC-3 audio | Section A.2.11 |
| 0x00000045 | MP3 audio | Section A.2.12 |
| 0x00000046 | Browser Profile A | Section A.2.13 |
| 0x00000047 | Reserved | |
| 0x00000048 | Atom per RFC 4287 | Section A.2.14 |
| 0x00000049 | AVC mobile video | Section A.2.15 |
| 0x0000004A | HE MC v2 mobile audio | Section A.2.16 |
| 0x0000004B | HE AAC v2 level 4 audio | Section A.2.17 |
| 0x0000004C | DTS-HD audio | Section A.2.18 |
| 0x0000004D | CFF-TT | Section A.2.19 |
| 0x0000004E | CEA-708 captions | Section A.2.20 |
| 0x0000004F | HE AAC v2 with MPEG Surround | Section A.2.21 |
| 0x00000050 | HE AAC v2 Level 6 audio | Section A.2.22 |
| 0x00000051 | Frame-compatible 3D video | Section A.2.23 |
| | (Side-by-Side) | |
| 0x00000052 | Frame-compatible 3D video | Section A.2.24 |
| | (lop-and-Bottom) | |
| 0x00000053 | ATSC 3.0 HEVC Video 1 | Section A.2.v1 |
| 0x00000054 | ATSC 3.0 HEVC Video 2 | Section A.2.v2 |
| 0x00000055 | ATSC 3.0 SHVC Video 1 | Section A.2.v3 |
| 0x00000056 | ATSC 3.0 SHVC Video 2 | Section A.2.v4 |
| 0x00000053 | ATSC 3.0 Coded Audio 1 | Section A.2.a1 |
| 0x00000054 | ATSC 3.0 Coded Audio 2 | Section A.2.a2 |
| 0x00000053-0x0000005E | Reserved for future ATSC use. | |
| 0x0000005F | Capability category string code | Section CapabilityString |
| | point for Media Types | semantics |

Internet Link

| | | |
|---|---|---|
| 0x00000060 | Internet link, downward rate | Section A.2.25 |
| | 56,000 bps or better | |
| 0x00000061 | Internet link, downward rate | Section A.2.26 |
| | 512,000 bps or better | |
| 0x00000062 | Internet link, downward rate | Section A.2.27 |
| | 2,000,000 bps or better | |
| 0x00000063 | Internet link, downward rate | Section A.2.28 |
| | 10,000,000 bps or better | |
| 0x00000064-0x0000006E, | Reserved for future ATSC use. | |
| 0x00000080-0xFFFF000000 | | |
| 0x0000006F | Capability category string code | Section CapabilityString |
| | point for Internet Link | semantics |
| 0x0000007F, 0x0000008F, | Reserved capability category string | Section CapabilityString |
| 0x0000009F, . . . , 0x000000FF | code points | semantics |
| 0x00000070-0x0000007F, | Available for private use. | |
| 0xFFFF0001-0xFFFFFFFFFF | | |

Example of new capability_code for video and audio for ATSC 3.0:

### Section

A.2.v1 Capability Code 0x00000054: ATSC 3.0 HEVC Video 1
The capability_code value 0x00000054 may represent the receiver ability to support HEVC video encoded in conformance with the ATSC specification. The ca-pability_code value 0x00000054 may not appear along with capability_code values 0x00000042, 0x00000043, 0x00000022, 0x00000023, or 0x00000024, since each of these code values implies support for AVC with certain specified constraints.

A.2.a1 Capability Code 0x00000056: ATSC 3.0 Coded Audio 1

The capability_code value 0x00000056 may represent the receiver ability to support ATSC coded audio encoded in conformance with the ATSC specification.

Although certain capability_code values are used above, some other values could be used instead. For example instead of Capability Code 0x00000054 for ATSC 3.0 HEVC video 1 a Capability Code 0x00398 may be used.

In this variant multiple CapabilityString set each representing alternative complete required capabilities that are sufficient to decode and present the content may be supported as follows:

Content Fragment elements:

| | | | Cardi- | | |
|---|---|---|---|---|---|
| Name | Type | Category | nality | Description | Data Type |
| Required | E2 | NO/TO | 0 . . . 1 | Required Capabilities for | |
| Capabilities | | | | decoding and presenting | |
| | | | | content. | |
| | | | | Contains the following | |
| | | | | elements: | |
| | | | | CapabilityCodesList | |
| | | | | CapabilityStringSets | |
| | | | | In some embodiments the | |
| | | | | RequiredCapabilities will be | |
| | | | | additional capabilities that are | |
| | | | | required in addition to those | |
| | | | | signaled at the service level. | |
| CapabilityCodesList | E3 | NO/TO | 0 . . . N | A space separated list of | list of |
| | | | | required capability codes. | unsignedInt |
| | | | | Each capability code in the list | |
| | | | | is code point from Table A1. | |
| | | | | The list of code points in one | |
| | | | | CapabilityCodesList | |
| | | | | represents the required | |
| | | | | capabilities that are combined | |
| | | | | by logical “AND” operation to | |
| | | | | represent total required | |
| | | | | capabilities that are sufficient | |
| | | | | to decode and present the | |
| | | | | content. The list may not | |
| | | | | include a code point belonging | |
| | | | | to the capability category | |
| | | | | string code point (i.e. | |
| | | | | 0x0000001F, 0x0000002F, | |
| | | | | 0x0000003F, . . . , 0x000000FF). | |
| | | | | Multiple occurrences of | |
| | | | | CapabilityCodesList represent | |
| | | | | alternative sets of required | |
| | | | | capabilities any one of which | |
| | | | | is sufficient to decode and | |
| | | | | present the content. Thus | |
| | | | | either one of the | |
| | | | | CapabilityCodesList or set of | |
| | | | | CapabilityString elements is | |
| | | | | sufficient to provide required | |
| | | | | capabilities for decoding and | |
| | | | | presenting the content. | |
| CapabilityStringSets | E3 | NO/TO | 0 . . . N | Multiple CapabilityString sets | |
| | | | | each representing alternative | |
| | | | | complete required capabilities | |
| | | | | that are sufficient to decode | |
| | | | | and present the content. | |
| | | | | Contains the following | |
| | | | | elements: | |
| | | | | CapabilityString | |
| CapabilityString | E4 | NO/TO | 1 . . . N | A string containing the | string |
| | | | | representation of a capability | |
| | | | | as per Table A.1 and the text | |
| | | | | following it. | |
| | | | | Contains the following | |
| | | | | attribute: | |
| | | | | categorycode | |
| | | | | All the CapabilityString | |
| | | | | element values together | |
| | | | | indicate a complete capability | |
| | | | | set sufficient to provide | |
| | | | | required capabilities for | |
| | | | | decoding and presenting the | |
| | | | | content as an additional | |
| | | | | alternative to the required | |
| | | | | capabilities as signaled by | |
| | | | | CapabilityCodesList | |
| | | | | alternatives. | |
| | | | | The string could be empty | |
| | | | | (e.g. Null string or “ ”) when | |
| | | | | the category attribute has a | |
| | | | | value equal to a | |
| | | | | capability_code value other | |
| | | | | than the capability category | |
| | | | | string code point values (i.e. | |
| | | | | value other than 0x0000001F, | |
| | | | | 0x0000002F, 0x0000003F, . . . , | |
| | | | | 0x000000FF) as per Table A1. | |
| categorycode | A | NO/TO | 1 | Gives the capability category | unsignedInt |
| | | | | of the capability represented | |
| | | | | by this CapabilityString | |
| | | | | element. | |
| | | | | If the categoryCode is one of | |
| | | | | capability category string code | |
| | | | | point values (i.e. 0x0000001F, | |
| | | | | 0x0000002F, 0x0000003F, . . . , | |
| | | | | 0x000000FF) then the | |
| | | | | CapabilityString must | |
| | | | | not be empty. | |

In another variant an attribute additionalcapabilities is signaled for element CapabilityCodesList.

If additionalcapabilities is “true” then the required capabilities listed in CapabilityCodesList element will be additional capabilities that are required in addition to the capabilities signaled at the service level for decoding and presenting the content.

If additionalcapabilities is “false” then the required capabilities listed in CapabilityCodesList element is complete list of capabilities that are required for decoding and presenting the content.

In this variant an attribute additionalcap is signaled for element CapabilityString.

If additionalcap is “true” then the required capabilities listed in CapabilityString element will be additional capability that is required in addition to the capabilities signaled at the service level for decoding and presenting the content.

If additionalcap is “false” then the required capabilities listed in CapabilityString element may overlap with list of capabilities that are capabilities signaled at the service level and that are required for decoding and presenting the content.

In case the required capabilities are included in both the service signaling and service announcement (i.e. service guide, e.g. such as described) then for the purpose of the service/content consumption, the parameters defined in the service signaling information MAY take priority. Thus in some embodiments the required capability information in service announcement (i.e. service guide, e.g. such as described) is provided for the purpose that the receiver can check it against its capabilities to decide if it is able to decode and present the service and/or the content but for the actual service/content consumption the information from the service signaling MAY be used.

Content Fragment elements:

| | | | Cardi- | | |
|---|---|---|---|---|---|
| Name | Type | Category | nality | Description | Data Type |
| Required | E2 | NO/TO | 0 . . . 1 | Required Capabilities for | |
| Capabilities | | | | decoding and presenting | |
| | | | | content. | |
| | | | | Contains the following | |
| | | | | elements: | |
| | | | | CapabilityCodesList | |
| | | | | CapabilityStringSets | |
| | | | | In some embodiments the | |
| | | | | RequiredCapabilities will be | |
| | | | | additional capabilities that are | |
| | | | | required in addition to those | |
| | | | | signaled at the service level. | |
| CapabilityCodesList | E3 | NO/TO | 0 . . . N | A space separated list of | list of |
| | | | | required capability codes. | unsignedInt |
| | | | | Each capability code in the list | |
| | | | | is code point from Table A.1. | |
| | | | | The list of code points in one | |
| | | | | CapabilityCodesList | |
| | | | | represents the required | |
| | | | | capabilities that are combined | |
| | | | | by logical “AND” operation to | |
| | | | | represent total required | |
| | | | | capabilities that are sufficient | |
| | | | | to decode and present the | |
| | | | | content. The list may not | |
| | | | | include a code point belonging | |
| | | | | to the capability category | |
| | | | | string code point (i.e. | |
| | | | | 0x0000001F, 0x0000002F, | |
| | | | | 0x0000003F, . . . , 0x000000FF). | |
| | | | | Multiple occurrences of | |
| | | | | CapabilityCodesList represent | |
| | | | | alternative sets of required | |
| | | | | capabilities any one of which | |
| | | | | is sufficient to decode and | |
| | | | | present the content. Thus | |
| | | | | either one of the | |
| | | | | CapabilityCodesList or set of | |
| | | | | CapabilityString elements is | |
| | | | | sufficient to provide required | |
| | | | | capabilities for decoding and | |
| | | | | presenting the content. | |
| | | | | Contains the following | |
| | | | | attribute: | |
| | | | | additionalcapabilities | |
| additionalcapabilities | A | NM/TM | 1 | true: | boolean |
| | | | | the required capabilities listed | |
| | | | | in CapabilityCodesList | |
| | | | | element will be additional | |
| | | | | capabilities that are required in | |
| | | | | addition to the capabilities | |
| | | | | signaled at the service level | |
| | | | | for decoding and presenting | |
| | | | | the content. | |
| | | | | false: | |
| | | | | the required capabilities listed | |
| | | | | in CapabilityCodesList | |
| | | | | element is complete list of | |
| | | | | capabilities that are required | |
| | | | | for decoding and presenting | |
| | | | | the content. | |
| CapabilityStringSets | E3 | NO/TO | 0 . . . N | Multiple-CapabilityString sets | |
| | | | | each representing alternative | |
| | | | | complete required capabilities | |
| | | | | that are sufficient to decode | |
| | | | | and present the content. | |
| | | | | Contains the following | |
| | | | | elements: | |
| | | | | CapabilityString | |
| CapabilityString | E4 | NO/TO | 1 . . . N | A string containing the | string |
| | | | | representation of a capability | |
| | | | | as per Table A.1 and the text | |
| | | | | following it. | |
| | | | | Contains the following | |
| | | | | attribute: | |
| | | | | Categorycode | |
| | | | | additionalcap | |
| | | | | All the CapabilityString | |
| | | | | element values together | |
| | | | | indicates complete capability | |
| | | | | set sufficient to provide | |
| | | | | required capabilities for | |
| | | | | decoding and presenting the | |
| | | | | content as an additional | |
| | | | | altemative to the required | |
| | | | | capabilities as signaled by | |
| | | | | CapabilityCodesList | |
| | | | | alternatives. | |
| | | | | The string could be empty | |
| | | | | (e.g. Null string or “ ”) when | |
| | | | | the category attribute has a | |
| | | | | value equal to a | |
| | | | | capability_code value other | |
| | | | | than the capability category | |
| | | | | string code point values (i.e. | |
| | | | | value other than 0x0000001F, | |
| | | | | 0x0000002F, 0x0000003F, . . . , | |
| | | | | 0x000000FF) as per Table A1. | |
| categorycode | A | NO/TO | 1 | Gives the capability category | unsignedInt |
| | | | | of the capability represented | |
| | | | | by this CapabilityString | |
| | | | | element. | |
| | | | | If the categoryCode is one of | |
| | | | | capability category string code | |
| | | | | point values (i.e. 0x0000001F, | |
| | | | | 0x0000002F, 0x0000003F, . . . , | |
| | | | | 0x000000FF) then the | |
| | | | | CapabilityString must | |
| | | | | not be empty. | |
| additionalcap | A | NM/TM | 1 | true: | boolean |
| | | | | the required capabilities listed | |
| | | | | in CapabilityString element will | |
| | | | | be additional capability that is | |
| | | | | required in addition to the | |
| | | | | capabilities signaled at the | |
| | | | | service level for decoding and | |
| | | | | presenting the content. | |
| | | | | false: | |
| | | | | the required capabilities listed | |
| | | | | in CapabilityString element | |
| | | | | may overlap with list of | |
| | | | | capabilities that are | |
| | | | | capabilities signaled at the | |
| | | | | service level and that are | |
| | | | | required for decoding and | |
| | | | | presenting the content. | |

In another variant the elements are described in the table with rules on using them described in separate section as follows:

| | | | Cardi- | | |
|---|---|---|---|---|---|
| Name | Type | Category | nality | Description | Data Type |
| Required | E2 | NO/TO | 0 . . . 1 | Required Capabilities for | |
| Capabilities | | | | decoding and presenting | |
| | | | | content. | |
| | | | | Contains the following | |
| | | | | elements: | |
| | | | | CapabilityCodesList | |
| | | | | CapabilityStringSets | |
| CapabilityCodesList | E3 | NO/TO | 0 . . . N | A space separated list of | list of |
| | | | | required capability codes. | unsignedInt |
| | | | | Each capability code in the | |
| | | | | list is | |
| | | | | code point from Table A.2. | |
| CapabilityStringSets | E3 | NO/TO | 0 . . . N | Multiple CapabilityString | |
| | | | | sets each representing | |
| | | | | alternative complete | |
| | | | | required capabilities that | |
| | | | | are sufficient to decode and | |
| | | | | present the content. | |
| | | | | Contains the following | |
| | | | | elements: | |
| | | | | CapabilityString | |
| CapabilityString | E4 | NO/TO | 1 . . . N | A string containing the | string |
| | | | | representation of a | |
| | | | | capability as per Table A.2 | |
| | | | | and the text following it. | |
| | | | | Contains the following | |
| | | | | attribute: | |
| | | | | categorycode | |
| categorycode | A | NO/TO | 1 | Gives the capability | unsignedInt |
| | | | | category of the capability | |
| | | | | represented by this | |
| | | | | CapabilityString element. | |

The list of code points in one CapabilityCodesList represents the required capabilities that are combined by logical “AND” operation to represent total required capabilities that are sufficient to decode and present the content. The list may not include a code point belonging to the capability category string code point (i.e. 0x0000001F, 0x0000002F, 0x0000003F, . . . , 0x000000FF). Multiple occurrences of CapabilityCodesList represent alternative sets of required capabilities any one of which is sufficient to decode and present the content. Thus either one of the CapabilityCodesList or set of CapabilityString elements is sufficient to provide required capabilities for decoding and presenting the content.

In some embodiments the RequiredCapabilities will be additional capabilities that are required in addition to those signaled at the service level. In this case the description may be as follows:

The list of code points in one CapabilityCodesList represents the required capabilities that are combined by logical “AND” operation together with the required capabilities signaled at the service level to represent total required capabilities that are sufficient to decode and present the content. The list may not include a code point belonging to the capability category string code point values (i.e. 0x0000001F, 0x0000002F, 0x0000003F, . . . , 0x000000FF). Multiple occurrences of CapabilityCodesList represent alternative sets of required capabilities any one of which together with the required capabilities signaled at the service level is sufficient to decode and present the content. Thus either one of the CapabilityCodesList or set of CapabilityString elements together with the required capabilities signaled at the service level is sufficient to provide required capabilities for decoding and presenting the content.

In another embodiment the service level required capabilities may be signaled in via low level signaling at the baseband level.

In another embodiment the service level required capabilities may be signaled in Service fragment.

All the CapabilityString element values together indicate a complete capability set sufficient to provide required capabilities for decoding and presenting the content as an additional alternative to the required capabilities as signaled by CapabilityCodesList alternatives. The string could be empty (e.g. Null string or “ ”) when the category attribute has a value equal to a capability_code value other than the capability category string code point values (i.e. value other than 0x0000001F, 0x0000002F, 0x0000003F, . . . , 0x000000FF) as per Table A.2.

If the categoryCode is one of capability category string code point values (i.e. 0x0000001F, 0x0000002F, 0x0000003F, . . . , 0x000000FF) then the CapabilityString must not be empty.

In addition the table A.1 may be further augmented by additional capability code categories (“App”) defined as shown below.

TABLE A.2
Required Capability Codes

| capability_code | Meaning | Reference |
|---|---|---|
| 0x00000000 | Forbidden | |

Download Protocols

| | | |
|---|---|---|
| 0x00000001 | FLUTE protocol, as specified in | Section A.2.1 |
| | this Standard. | |
| 0x00000002-0x0000000E | Reserved for future ATSC use. | |
| 0x0000000F | Capability category string code | Section CapabilityString |
| | point for Download Protocols | semantics |

FEC Algorithms

| | | |
|---|---|---|
| 0x00000010 | Compact No-Code FEC scheme. | Section A.2.2 |
| 0x00000011 | Raptor algorithm, as specified in | Section A.2.3 |
| | this Standard. | |
| 0x00000012-0x0000001E | Reserved for future ATSC use. | |
| 0x0000001F | Capability category string code | Section CapabilityString |
| | point for FEC Algorithms | semantics |

Wrapper/Archive Formats

| | | |
|---|---|---|
| 0x00000020 | DECE CFF container general | Section A.2.4.1 |
| 0x00000021 | format ZIP format, as specified | Section A.2.29 |
| | in this Standard. | |
| 0x00000022 | DECE CFF container format, | Section A.2.4.2 |
| | Profile PD. | |
| 0x00000023 | DECE CFF container format, | Section A.2.4.3 |
| | Profile SD. | |
| 0x00000024 | DECE CFF container format, | Section A.2.4.4 |
| | Profile HD. | |
| 0x00000025 | ISO Base Media File Format for | Section A.2.5 |
| | PAC audio | |
| 0x00000026 | ATSC compliant MPEG-2 transport | Section A.2.6 |
| | stream | |
| 0x00000027 | MP4 constrained container format, | Section A.2.7 |
| | Profile PD2. | |
| 0x00000028 | W3C Web Apps Package | Section A.2.30 |
| 0x00000029-0x0000002E | Reserved for future ATSC use. | |
| 0x0000002F | Capability category string code | Section CapabilityString |
| | point for Wrapper/Archive Formats | semantics |

Compression Algorithms

| | | |
|---|---|---|
| 0x00000030 | DEFLATE algorithm, as specified | Section A.2.31 |
| | in this Standard. | |
| 0x00000031-0x0000003E | Reserved for future ATSC use. | |
| 0x0000003F | Capability category string code | Section CapabilityString |
| | point for Compression Algorithms | semantics |

Media Types

| | | |
|---|---|---|
| 0x00000041 | AVC standard definition video | Section A.2.8 |
| 0x00000042 | AVC high definition video | Section A.2.9 |
| 0x00000043 | AC-3 audio | Section A.2.10 |
| 0x00000044 | E-AC-3 audio | Section A.2.11 |
| 0x00000045 | MP3 audio | Section A.2.12 |
| 0x00000046 | Browser Profile A | Section A.2.13 |
| 0x00000047 | Reserved | |
| 0x00000048 | Atom per RFC 4287 | Section A.2.14 |
| 0x00000049 | AVC mobile video | Section A.2.15 |
| 0x0000004A | HE AAC v2 mobile audio | Section A.2.16 |
| 0x0000004B | HE AAC v2 level 4 audio | Section A.2.17 |
| 0x0000004C | DTS-HD audio | Section A.2.18 |
| 0x0000004D | CFF-TT | Section A.2.19 |
| 0x0000004E | CEA-708 captions | Section A.2.20 |
| 0x0000004F | HE AAC v2 with MPEG Surround | Section A.2.21 |
| 0x00000050 | HE AAC v2 Level 6 audio | Section A2.22 |
| 0x00000051 | Frame-compatible 3D video | Section A2.23 |
| | (Side-by-Side) | |
| 0x00000052 | Frame-compatible 3D video | Section A2.24 |
| | (Top-and-Bottom) | |
| 0x00000053 | ATSC 3.0 HEVC Video 1 | Section A.2.v1 |
| 0x00000054 | ATSC 3.0 HEVC Video 2 | Section A.2.v2 |
| 0x00000055 | ATSC 3.0 SHVC Video 1 | Section A.2.v3 . |
| 0x00000056 | ATSC 3.0 SHVC Video 2 | Section A.2.v4 |
| 0x00000053 | ATSC 3.0 Coded Audio 1 | Section A.2.a1 |
| 0x00000054 | ATSC 3.0 Coded Audio 2 | Section A.2.a2 |
| 0x00000053-0x0000005E | Reserved for future ATSC use. | |
| 0x0000005F | Capability category string code | Section CapabilityString |
| | point for Media Types | semantics |

Internet Link

| | | |
|---|---|---|
| 0x00000060 | Internet link, downward rate | Section A.2.25 |
| | 56,000 bps or better | |
| 0x00000061 | Internet link, downward rate | Section A.2.26 |
| | 512,000 bps or better | |
| 0x00000062 | Internet link, downward rate | |
| | 2,000,000 bps or better | Section A.2.27 |
| 0x00000063 | Internet link, downward rate | Section A.2.28 |
| | 10,000,000 bps or better | |
| 0x00000064-0x0000006E, 0x00000064- | Reserved for future ATSC use. | |
| 0x0000006E, 0x00000080-0xFFFF000000 | | |
| 0x0000006F | Capability category string code | Section CapabilityString |
| | point for Internet Link | semantics |

App

| | | |
|---|---|---|
| 0x00000080 | App of type 1 | Section A.2.x1 |
| 0x00000081 | App of type 2 | Section A.2.x2 |
| 0x82-0x8E | Reserved for future ATSC use. | |
| 0x8F | Capability category string code | |
| | point for App | |
| 0x0000009F, 0x000000AF, | Reserved capability category string | Section CapabilityString |
| 0x000000BF,, . . . , 0x000000FF | code points | semantics |
| 0x00000070-0x0000007F, 0xFFFF0001- | Available for private use. | |
| 0xFFFFFFFFFF | | |

A.2.v1 Capability Code 0x00000054: ATSC 3.0 HEVC Video 1
The capability_code value 0x00000054 may represent the receiver ability to support HEVC video encoded in conformance with the ATSC specification defined. The ca-pability_code value 0x00000054 may not appear along with capability code values 0x00000042, 0x00000043, 0x00000022, 0x00000023, or 0x00000024, since each of these code values implies support for AVC with certain specified constraints.

A.2.a1 Capability Code 0x00000056: ATSC 3.0 Coded Audio 1

The capability_code value 0x00000056 may represent the receiver ability to support ATSC coded audio encoded in conformance with the ATSC specification defined.

A.2.x1 Capability Code 0x00000070: App of Type 1

The capability_code value 0x00000070 may represent the receiver ability to support all normative requirements of the App of type 1 specified in an apps specification for apps of type 1.

In one example embodiment the App of type 1 may be a Digital Video Recorder (DVR) app.

In this variant the elements are described in the table with rules on using them described in separate section as follows:

| | | | Cardi- | | |
|---|---|---|---|---|---|
| Name | Type | Category | nality | Description | Data Type |
| Content | E | | | ‘Content’ fragment | |
| | | | | . . . | |
| . . . | | | | | |
| . . . | | | | | |
| . . . | | | | | |
| PrivateExt | E1 | NO/TO | 0 . . . 1 | An element serving as a | |
| | | | | container for proprietary or | |
| | | | | application-specific | |
| | | | | extensions. | |
| ProprietaryElements | E2 | NO/TO | 0 . . . N | Proprietary or application- | |
| | | | | specific elements that are | |
| | | | | not defined in this | |
| | | | | specification. These | |
| | | | | elements may further | |
| | | | | contain sub-elements or | |
| | | | | attributes. | |
| Required | E2 | NO/TO | 0 . . . 1 | Required Capabilities for | |
| Capabilities | | | | decoding and presenting | |
| | | | | content. | |
| | | | | Contains the following | |
| | | | | elements: | |
| | | | | CapabilityCodesList | |
| | | | | CapabilityStringSets | |
| CapabilityCodesList | E3 | NO/TO | 0 . . . N | A space separated list of | list of |
| | | | | required capability codes. | unsignedInt |
| | | | | Each capability code in the | |
| | | | | list is | |
| | | | | code point from Table A.3. | |
| | | | | Contains the following | |
| | | | | attribute: | |
| | | | | additionalcapabilities | |
| additionalcapabilities | A | NM/TM | 1 | true: | boolean |
| | | | | the required capabilities | |
| | | | | listed in | |
| | | | | CapabilityCodesList | |
| | | | | element will be additional | |
| | | | | capabilities that are | |
| | | | | required in addition to the | |
| | | | | capabilities signaled at the | |
| | | | | service level for decoding | |
| | | | | and presenting the content. | |
| | | | | false: | |
| | | | | the required capabilities | |
| | | | | listed in | |
| | | | | CapabilityCodesList | |
| | | | | element is complete list of | |
| | | | | capabilities that are | |
| | | | | required for decoding and | |
| | | | | presenting the content. | |
| CapabilityStringSets | E3 | NO/TO | 0 . . . N | Multiple CapabilityString | |
| | | | | sets each representing | |
| | | | | alternative complete | |
| | | | | required capabilities that | |
| | | | | are sufficient to decode | |
| | | | | and present the content. | |
| | | | | Contains the following | |
| | | | | elements: | |
| | | | | CapabilityString | |
| CapabilityString | E4 | NO/TO | 1 . . . N | A string containing the | string |
| | | | | representation of a | |
| | | | | capability as per Table A.3 | |
| | | | | and the text following it. | |
| | | | | Contains the following | |
| | | | | attribute: | |
| | | | | Categorycode | |
| | | | | additionalcap | |
| categorycode | A | NO/TO | 1 | Gives the capability | unsignedInt |
| | | | | category of the capability | |
| | | | | represented by this | |
| | | | | CapabilityString element. | |
| additionalcap | A | NM/TM | 1 | true: | boolean |
| | | | | the required capabilities | |
| | | | | listed in CapabilityString | |
| | | | | element will be additional | |
| | | | | capability that is required in | |
| | | | | addition to the capabilities | |
| | | | | signaled at the service | |
| | | | | level for decoding and | |
| | | | | presenting the content. | |
| | | | | false: | |
| | | | | the required capabilities | |
| | | | | listed in CapabilityString | |
| | | | | element may overlap with | |
| | | | | list of capabilities that are | |
| | | | | capabilities signaled at the | |
| | | | | service level and that are | |
| | | | | required for decoding and | |
| | | | | presenting the content. | |

The list of code points in one CapabilityCodesList represents the required capabilities that are combined by logical “AND” operation to represent total required capabilities that are sufficient to decode and present the content. The list may not include a code point belonging to the capability category string code point (i.e. 0x0000001F, 0x0000002F, 0x0000003F, . . . , 0x000000FF). Multiple occurrences of CapabilityCodesList represent alternative sets of required capabilities any one of which is sufficient to decode and present the content. Thus either one of the CapabilityCodesList or set of CapabilityString elements is sufficient to provide required capabilities for decoding and presenting the content.

In some embodiments the RequiredCapabilities will be additional capabilities that are required in addition to those signaled at the service level. In this case the description may be as follows:

The list of code points in one CapabilityCodesList represents the required capabilities that are combined by logical “AND” operation together with the required capabilities signaled at the service level to represent total required capabilities that are sufficient to decode and present the content. The list may not include a code point belonging to the capability category string code point values (i.e. 0x0000001F, 0x0000002F, 0x0000003F, . . . , 0x000000FF). Multiple occurrences of CapabilityCodesList represent alternative sets of required capabilities any one of which together with the required capabilities signaled at the service level is sufficient to decode and present the content. Thus either one of the CapabilityCodesList or set of CapabilityString elements together with the required capabilities signaled at the service level is sufficient to provide required capabilities for decoding and presenting the content.

In another embodiment the service level required capabilities may be signaled in via low level signaling at the baseband level.

In another embodiment the service level required capabilities may be signaled in Service fragment.

All the CapabilityString element values together indicate a complete capability set sufficient to provide required capabilities for decoding and presenting the content as an additional alternative to the required capabilities as signaled by CapabilityCodesList alternatives. The string could be empty (e.g. Null string or “ ”) when the category attribute has a value equal to a capability_code value other than the capability category string code point values (i.e. value other than 0x0000001F, 0x0000002F, 0x0000003F, . . . , 0x000000FF) as per Table A.3.

If the categoryCode is one of capability category string code point values (i.e. 0x0000001F, 0x0000002F, 0x0000003F, . . . , 0x000000FF) then the CapabilityString must not be empty.

Where Content, PrivateExt, ProprietaryElements elements are described in OMA BCAST service guide (e.g. OMA Service Guide for Mobile Broadcast Services 1.0.1) and are incorporated here by reference. They may be similarly applied to all other embodiments and variants described in this document.

In addition the table A.3 may be further augmented by additional capability code categories (“App”) defined as shown below.

TABLE A.3
Required Capability Codes

| | | |
|---|---|---|
| capability_code | Meaning | Reference |

| | |
|---|---|
| 0x00000000 | Forbidden |

Download Protocols

| | | |
|---|---|---|
| 0x00000001 | FLUTE protocol, as specified in this | Section A.2.1 |
| | Standard. | |
| 0x00000002-0x0000000E | Reserved for future ATSC use. | |
| 0x0000000F | Capability category string code point | Section CapabilityString |
| | for Download Protocols | semantics |

FEC Algorithms

| | | |
|---|---|---|
| 0x00000010 | Compact No-Code FEC scheme. | Section A.2.2 |
| 0x00000011 | Raptor algorithm, as specified in this | Section A.2.3 |
| | Standard. | |
| 0x00000012-0x0000001E | Reserved for future ATSC use. | |
| 0x0000001F | Capability category string code point | Section CapabilityString |
| | for FEC Algorithms | semantics |

Wrapper/Archive Formats

| | | |
|---|---|---|
| 0x00000020 | DECE CFF container general format | Section A.2.4.1 |
| 0x00000021 | ZIP format, as specified in this | Section A.2.29 |
| | Standard. | |
| 0x00000022 | DECE CFF container format, Profile | Section A.2.4.2 |
| | PD. | |
| 0x00000023 | DECE CFF container format, Profile | Section A.2.4.3 |
| | SD. | |
| 0x00000024 | DECE CFF container format, Profile | Section A.2.4.4 |
| | HD. | |
| 0x00000025 | ISO Base Media File Format for | Section A.2.5 |
| | AAC audio | |
| 0x00000026 | ATSC compliant MPEG-2 transport | Section A.2.6 |
| | stream | |
| 0x00000027 | MP4 constrained container format, | Section A.2.7 |
| | Profile PD2. | |
| 0x00000028 | W3C Web Apps Package | Section A.2.30 |
| 0x00000029-0x0000002E | Reserved for future ATSC use. | |
| 0x0000002F | Capability category string code point | Section CapabilityString |
| | for Wrapper/Archive Formats | semantics |

Compression Algorithms

| | | |
|---|---|---|
| 0x00000030 | DEFLATE algorithm, as specified in | Section A.2.31 |
| | this Standard. | |
| 0x00000031-0x0000003E | Reserved for future ATSC use. | |
| 0x0000003F | Capability category string code point | Section CapabilityString |
| | for Compression Algorithms | semantics |

Media Types

| | | |
|---|---|---|
| 0x00000041 | AVC standard definition video | Section A.2.8 |
| 0x00000042 | AVC high definition video | Section A.2.9 |
| 0x00000043 | AC-3 audio | Section A.2.10 |
| 0x00000044 | E-AC-3 audio | Section A.2.11 |
| 0x00000045 | MP3 audio | Section A.2.12 |
| 0x00000046 | Browser Profile A | Section A.2.13 |
| 0x00000047 | Reserved | |
| 0x00000048 | Atom per RFC 4287 | Section A.2.14 |
| 0x00000049 | AVC mobile video | Section A.2.15 |
| 0x0000004A | HE AAC v2 mobile audio | Section A.2.16 |
| 0x0000004B | HE AAC v2 level 4 audio | Section A.2.17 |
| 0x0000004C | DTS-HD audio | Section A.2.18 |
| 0x0000004D | CFF-TT | Section A.2.19 |
| 0x0000004E | CEA-708 captions | Section A.2.20 |
| 0x0000004F | HE AAC v2 with MPEG Surround | Section A.2.21 |
| 0x00000050 | HE AAC v2 Level 6 audio | Section A.2.22 |
| 0x00000051 | Frame-compatible 3D video (Side- | Section A.2.23 |
| | by-Side) | |
| 0x00000052 | Frame-compatible 3D video (Top- | Section A.2.24 |
| | and-Bottom) | |
| 0x00000053 | ATSC 3.0 HEVC Video 1 | Section A.2.v1 |
| 0x00000054 | ATSC 3.0 HEVC Video 2 | Section A.2.v2 |
| 0x00000055 | ATSC 3.0 SHVC Video 1 | Section A.2.v3 |
| 0x00000056 | ATSC 3.0 SHVC Video 2 | Section A.2.v4 |
| 0x00000053 | ATSC 3.0 Coded Audio 1 | Section A.2.a1 |
| 0x00000054 | ATSC 3.0 Coded Audio 2 | Section A.2.a2 |
| 0x00000053-0x0000005E | Reserved for future ATSC use, | |
| 0x0000005F | Capability category string code point | Section CapabilityString |
| | for Media Types | semantics |

Internet Link

| | | |
|---|---|---|
| 0x00000060 | Internet link, downward rate 56,000 | Section A.2.25 |
| | bps or better | |
| 0x00000061 | Internet link, downward rate 512,000 | Section A.2.26 |
| | bps or better | |
| 0x00000062 | Internet link, downward rate | Section A.2.27 |
| | 2,000,000 bps or better | |
| 0x00000063 | Internet link, downward rate | Section A.2.28 |
| | 10,000,000 bps or better | |
| 0x00000064-0x0000006E, 0x00000064-0x0000006E, | Reserved for future ATSC use. | |
| 0x00000080-0xFFFF000000 | | |
| 0x0000006F | Capability category string code point | Section CapabilityString |
| | for Internet Link | semantics |

App

| | | |
|---|---|---|
| 0x00000080 | App of type 1 | Section A.2.x1 |
| 0x00000081 | App of type 2 | Section A.2.x2 |
| 0x82-0x8E | Reserved for future ATSC use. | |
| 0x8F | Capability category string code point | |
| | for App | |
| 0x0000009F, 0x000000AF, 0x000000BF,, . . . , | Reserved capability category string | Section CapabilityString |
| 0x000000FF | code points | semantics |
| 0x00000070-0x0000007F, 0xFFFF0001-0xFFFFFFFFFF | Available for private use. | |

A.2.v1 Capability Code 0x00000054: ATSC 3.0 HEVC Video 1
The capability_code value 0x00000054 may represent the receiver ability to support HEVC video encoded in conformance with the ATSC specification defined. The ca-pability_code value 0x00000054 may not appear along with capability_code values 0x00000042, 0x00000043, 0x00000022, 0x00000023, or 0x00000024, since each of these code values implies support for AVC with certain specified constraints.

A.2.a1 Capability Code 0x00000056: ATSC 3.0 Coded Audio 1

The capability_code value 0x00000056 may represent the receiver ability to support ATSC coded audio encoded in conformance with the ATSC specification.

A.2.x1 Capability Code 0x00000070: App of Type 1

The capability_code value 0x00000070 may represent the receiver ability to support all normative requirements of the App of type 1 specified in an apps specification for apps of type 1.

In one example embodiment the App of type 1 may be a Digital Video Recorder (DVR) app.

In a variant embodiment elements and attributes to indicate required capabilities are signaled in a content fragment and service fragment with the following differences:

In the service fragment an additional element RequiredCapabilitiesContentUpdate is supported.

Description of elements in service level and content level is different.

Service Fragment Elements:

| Name | Type | Category | Cardinality | Description | Data Type |
|---|---|---|---|---|---|
| Required | E2 | NO/TO | 0 . . . 1 | Required Capabilities for | |
| Capabilities | | | | decoding and presenting | |
| | | | | the service. | |
| | | | | Contains the following | |
| | | | | elements: | |
| | | | | CapabilityCodesList | |
| | | | | CapabilityString | |
| | | | | Contains the following | |
| | | | | attributes | |
| | | | | RequiredCapabilities | |
| | | | | ContentUpdate | |
| RequiredCapabilities | A | NM/TM | 1 | Signals whether required | boolean |
| ContentUpdate | | | | capabilities indicated for | |
| | | | | this service at the | |
| | | | | service level could be | |
| | | | | further modified by | |
| | | | | addition of different | |
| | | | | additional required | |
| | | | | capabilities for a content | |
| | | | | in the service at the | |
| | | | | content level. | |
| | | | | true: | |
| | | | | Individual content | |
| | | | | associated with the | |
| | | | | service may include | |
| | | | | additional | |
| | | | | RequiredCapabilities | |
| | | | | beyond those indicated | |
| | | | | at the service level . . . | |
| | | | | false: | |
| | | | | Individual content | |
| | | | | associated with the | |
| | | | | service does not include | |
| | | | | additional | |
| | | | | RequiredCapabilities | |
| | | | | beyond those indicated | |
| | | | | at the service level. Thus | |
| | | | | required capabilities | |
| | | | | indicated at the service | |
| | | | | level are sufficient for | |
| | | | | decoding and presenting | |
| | | | | all the content in the | |
| | | | | service | |
| CapabilityCodesList | E3 | NO/TO | 0 . . . 1 | A comma separated list | String |
| | | | | of capability code sets. | (Comma |
| | | | | The capability code sets | Separated |
| | | | | are | lists of |
| | | | | a list of code points from | unsignedByte) |
| | | | | Table A.4 in numeric | |
| | | | | form. | |
| | | | | The list of code points in | |
| | | | | one capability code set | |
| | | | | represents the required | |
| | | | | capabilities that are | |
| | | | | combined by logical | |
| | | | | “AND” operation to | |
| | | | | represent total required | |
| | | | | capability. The comma | |
| | | | | separated list of | |
| | | | | capability code sets are | |
| | | | | interpreted by a logical | |
| | | | | “OR”. Thus either one of | |
| | | | | the capability code set | |
| | | | | together with | |
| | | | | CapabilityString values | |
| | | | | is sufficient to provide | |
| | | | | Required Capabilities for | |
| | | | | decoding and presenting | |
| | | | | the service/content. | |
| | | | | See capability_code | |
| | | | | (Section 8.3). | |
| CapabilityString | E3 | NO/TO | 04 . . . N | A string containing the | string |
| | | | | representation of a | |
| | | | | capability per modified | |
| | | | | Table 8.8 of A103 and | |
| | | | | the text following it. | |
| | | | | See capability_string | |
| | | | | (Section 8.3). | |
| | | | | Contains the following | |
| | | | | attribute: | |
| | | | | Category | |
| | | | | The string could be | |
| | | | | capability_code as per | |
| | | | | Table A.4 when category | |
| | | | | attribute has the value of | |
| | | | | 0x06. | |
| | | | | The CapabilityString | |
| | | | | values together indicate | |
| | | | | a capability code set of | |
| | | | | required capabilities that | |
| | | | | is needed for decoding | |
| | | | | and presenting the | |
| | | | | service/content as an | |
| | | | | additional alternative to | |
| | | | | the capabilities required | |
| | | | | as signaled by | |
| | | | | CapabilityCodesList | |
| | | | | (comma separated list of | |
| | | | | capability code sets). | |
| category | A | NO/TO | 1 | Gives the capability | unsignedByte |
| | | | | category of the capability | |
| | | | | represented by this | |
| | | | | CapabilityString | |
| | | | | element. | |

Content Fragment elements:

| Name | Type | Category | Cardinality | Description | Data Type |
|---|---|---|---|---|---|
| Required | E2 | NO/TO | 0 . . . 1 | Required Capabilities for decoding | |
| Capabilities | | | | and presenting content. | |
| | | | | Contains the following elements: | |
| | | | | CapabilityCodesList | |
| | | | | CapabilityString | |
| | | | | When | |
| | | | | RequiredCapabilitiesContentUpdate | |
| | | | | attribute of the service associated | |
| | | | | with this content is equal to ‘false’ | |
| | | | | the RequiredCapabilities element | |
| | | | | can not exists at the content | |
| | | | | level. Thus in this case it is required | |
| | | | | to have a cardinality of 1. | |
| CapabilityCodesList | E3 | NO/TO | 0 . . . 1 | A comma separated list of | String |
| | | | | capability code sets. The capability | (Comma |
| | | | | code sets are | Separated |
| | | | | a list of code points from Table A.4 | lists of |
| | | | | in numeric form. | unsignedByte) |
| | | | | The list of code points in one | |
| | | | | capability code set represents the | |
| | | | | required capabilities that are | |
| | | | | combined by logical “AND” | |
| | | | | operation to represent total required | |
| | | | | capability. The comma separated | |
| | | | | list of capability code sets are | |
| | | | | interpreted by a logical “OR”. Thus | |
| | | | | either one of the capability code set | |
| | | | | together with CapabilityString | |
| | | | | values is sufficient to provide | |
| | | | | Required Capabilities for decoding | |
| | | | | and presenting the service/content. | |
| | | | | See capability_code (Section 8.3). | |
| CapabilityString | E3 | NO/TO | 0 . . . N | A string containing the | string |
| | | | | representation of a capability per | |
| | | | | modified Table 8.8 of A103 and the | |
| | | | | text following it. | |
| | | | | See capability_string (Section 8.3). | |
| | | | | Contains the following attribute: | |
| | | | | Category | |
| | | | | The string could be capability_code | |
| | | | | as per Table A.4 when category | |
| | | | | attribute has the value of 0x06. | |
| | | | | The CapabilityString values | |
| | | | | together indicate a capability code | |
| | | | | set of required capabilities that is | |
| | | | | needed for decoding and | |
| | | | | presenting the service/content as | |
| | | | | an additional alternative to the | |
| | | | | capabilities required as signaled by | |
| | | | | CapabilityCodesList (comma | |
| | | | | separated list of capability code | |
| | | | | sets). | |
| category | A | NO/TO | 1 | Gives the capability category of the | unsignedByte |
| | | | | capability represented by this | |
| | | | | CapabilityString element. | |

TABLE 8.8
Table 8.8 Capability Categories and Registries

| | Capability | |
|---|---|---|
| capability_category_code | Category | Registry |
| 0x00 | reserved | |
| 0x01 | Download | No registry - use widely used industry name |
| | Protocol | |
| 0x02 | FEC Algorithm | IANA registry of FEC encoding IDs and instance IDs as per |
| | | http://www.iana.org/assignments/rmt-fec-parameters. |
| 0x03 | Wrapper/Archive | IANA registry of media types and subtypes as |
| | Format | per, http://www.iana.org/assignments/media-types |
| 0x04 | Compression | IANA registry of HTTP Content-Coding values |
| | Algorithm | |
| 0x05 | Media Type | IANA registry of media types and subtypes |
| | | http://www.iana.org/assignments/media-types |
| 0x06 | capability_code | capability_code as per Table A.4 |
| 0x067-0x7F | reserved | |

TABLE A.4
Capability Codes

| | | |
|---|---|---|
| capability_code | Meaning | Reference |

| | |
|---|---|
| 0x00 | Forbidden |

Download Protocols

| | | |
|---|---|---|
| 0x01 | FLUTE protocol, as specified in this Standard. | Section A.2.1 |
| 0x02-0x0F | Reserved for future ATSC use. | |

FEC Algorithms

| | | |
|---|---|---|
| 0x10 | Compact No-Code FEC scheme. | Section A.2.2 |
| 0x11 | Raptor algorithm, as specified in this Standard. | Section A.2.3 |
| 0x12-0x1F | Reserved for future ATSC use. | |

Wrapper/Archive Formats

| | | |
|---|---|---|
| 0x20 | DECE CFF container general format | Section A.2.4.1 |
| 0x21 | ZIP format, as specified in this Standard. | Section A.2.29 |
| 0x22 | DECE CFF container format, Profile PD. | Section A.2.4.2 |
| 0x23 | DECE CFF container format, Profile SD. | Section A.2.4.3 |
| 0x24 | DECE CFF container format, Profile HD. | Section A.2.4.4 |
| 0x25 | ISO Base Media File Format for AAC audio | Section A.2.5 |
| 0x26 | ATSC compliant MPEG-2 transport stream | Section A.2.6 |
| 0x27 | MP4 constrained container format, Profile PD2. | Section A.2.7 |
| 0x28 | W3C Web Apps Package | Section A.2.30 |
| 0x29-0x2F | Reserved for future ATSC use. | |

Compression Algorithms

| | | |
|---|---|---|
| 0x30 | DEFLATE algorithm, as specified in this Standard. | Section A.2.31 |
| 0x31-0x3F | Reserved for future ATSC use. | |

Media Types

| | | |
|---|---|---|
| 0x41 | AVC standard definition video | Section A.2.8 |
| 0x42 | AVC high definition video | Section A.2.9 |
| 0x43 | AC-3 audio | Section A.2.10 |
| 0x44 | E-AC-3 audio | Section A.2.11 |
| 0x45 | MP3 audio | Section A.2.12 |
| 0x46 | Browser Profile A | Section A.2.13 |
| 0x47 | Reserved | |
| 0x48 | Atom per RFC 4287 | Section A.2.14 |
| 0x49 | AVC mobile video | Section A.2.15 |
| 0x4A | HE AAC v2 mobile audio | Section A.2.16 |
| 0x4B | HE AAC v2 level 4 audio | Section A.2.17 |
| 0x4C | DTS-HD audio | Section A.2.18 |
| 0x4D | CFF-TT | Section A.2.19 |
| 0x4E | CEA-708 captions | Section A.2.20 |
| 0x4F | HE AAC v2 with MPEG Surround | Section A.2.21 |
| 0x50 | HE AAC v2 Level 6 audio | Section A.2.22 |
| 0x51 | Frame-compatible 3D video (Side-by-Side) | Section A.2.23 |
| 0x52 | Frame-compatible 3D video (Top-and-Bottom) | Section A.2.24 |
| 0x53 | ATSC 3.0 HEVC Video 1 | Section A.2.v1 |
| 0x54 | ATSC 3.0 HEVC Video 2 | Section A.2.v2 |
| 0x55 | ATSC 3.0 SHVC Video 1 | Section A.2.v3 |
| 0x56 | ATSC 3.0 SHVC Video 2 | Section A.2.v4 |
| 0x53 | ATSC 3.0 Coded Audio 1 | Section A.2.a1 |
| 0x54 | ATSC 3.0 Coded Audio 2 | Section A.2.a2 |
| 0x53-0x5F | Reserved for future ATSC use. | |

Internet Link

| | | |
|---|---|---|
| 0x60 | Internet link, downward rate 56,000 bps or better | Section A.2.25 |
| 0x61 | Internet link, downward rate 512,000 bps or better | Section A.2.26 |
| 0x62 | Internet link, downward rate 2,000,000 bps or better | Section A.2.27 |
| 0x63 | Internet link, downward rate 10,000,000 bps or better | Section A.2.28 |
| 0x64-0x6F | Reserved for future ATSC use. | |
| 0x70-0x7F | Available for private use. | |

Example of new capability_code for video and audio for ATSC 3.0:

### A.2.v1 Capability Code 0x54: ATSC 3.0 HEVC Video 1

The capability_code value 0x54 may represent the receiver ability to support HEVC video encoded in conformance with the ATSC specification. The capability_code value 0x54 may not appear along with capability_code values 0x42, 0x43, 0x22, 0x23, or 0x24, since each of these code values implies support for AVC with certain specified constraints.

A.2.a1 Capability Code 0x56: ATSC 3.0 Coded Audio 1

The capability_code value 0x56 may represent the receiver ability to support ATSC coded audio encoded in conformance with the ATSC specification.

In another embodiment the following elements, the attributes may be defined for indicating required capabilities for content consumption. Additionally constraints may be defined on CapabilityCodes and CapabilityString elements and categoryCode attributes.

| Name | Type | Category | Cardinality | Description | Data Type |
|---|---|---|---|---|---|
| Content | E | | | ‘Content’ fragment | |
| | | | | . . . | |
| . . . | | | | | |
| PrivateExt | E1 | NO/ | 0 . . . 1 | An element | |
| | | TO | | serving as a | |
| | | | | container for | |
| | | | | proprietary or | |
| | | | | application- | |
| | | | | specific | |
| | | | | extensions. | |
| atsc3:RequiredCapabilities | E2 | NO/TM | 0 . . . N | Required | |
| | | | | Capabilities for | |
| | | | | decoding and | |
| | | | | presenting the | |
| | | | | content. | |
| | | | | Contains the | |
| | | | | following | |
| | | | | elements: | |
| | | | | CapabilityCodes | |
| | | | | CapabilityString | |
| atsc3:CapabilityCodes | E3 | NO/TM | 0 . . . 1 | A white space | list of |
| | | | | separated list of | unsignedShort |
| | | | | required capability | |
| | | | | codes. Each | |
| | | | | capability code in | |
| | | | | the list is code | |
| | | | | point from Table | |
| | | | | A.1. | |
| atsc3:CapabilityString | E3 | NO/TM | 0 . . . N | A string containing | string |
| | | | | the representation | |
| | | | | of a capability | |
| atsc3:categoryCode | A | NO/TM | 1 | Gives the | unsignedShort |
| | | | | capability category | |
| | | | | of the capability | |
| | | | | represented by | |
| | | | | this | |
| | | | | CapabilityString | |
| | | | | element. | |

The list of code points in one CapabilityCodes element, combined with the set of CapabilityString elements (if present), specify the required capabilities that are combined by logical “AND” operation to represent the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a RequiredCapabilities element, each listed CapabilityString element indicates a capability required in addition to those listed in the CapabilitieCodes element. Each CapabilityString element may include a categoryCode attribute associating the string with a category and registration authority per Table 2 below.

The required capability code list in atsc3:CapabilityCodes sub-element may contain at most one capability code of each capability category unless a particular capability code requires C1 requires multiple capability codes to be present for the capability category as described in its Reference section A.2.xx.

When the list of required capability codes in atsc3:CapabilityCodes sub-element in an atsc3:RequiredCapabilities element contains a capability code C1 such that V1 is equal to (C1 & 0x0F00) and V1 is in the range of 0x01 to 0x05, inclusive, any atsc3:CapabilityString sub-element in the same atsc3:RequiredCapabilities element may not have atsc3:categoryCode value equal to V1 unless the associated capability code C1 requires multiple capability codes to be present for the capability category as described in its Reference section A.2.xx.

Where & is bitwise AND operation.

TABLE 1
Capability Codes

| | | |
|---|---|---|
| capability_code | Meaning | Reference (see A/103) |

| | |
|---|---|
| 0x0000 | Forbidden |

Capability Category: Download Protocols

| | | |
|---|---|---|
| 0x0101 | FLUTE protocol, as specified in A/103 | Section A.2.1 |
| 0x0102 | HTTP 1.1 | |
| 0x0103-0x01FF | Reserved for future ATSC use. | |

Capability Category: FEC Algorithms

| | | |
|---|---|---|
| 0x0200 | Compact No-Code FEC scheme. | Section A.2.2 |
| 0x0201 | Raptor algorithm, as specified in this | Section A.2.3 |
| | Standard. | |
| 0x0202-0x02FF | Reserved for future ATSC use. | |

Capability Category: Wrapper/Archive Formats

| | | |
|---|---|---|
| 0x0300 | DECE CFF container general format | Section A.2.4.1 |
| 0x0301 | ZIP format, as specified in this Standard. | Section A.2.29 |
| 0x0302 | DECE CFF container format, Profile PD. | Section A.2.4.2 |
| 0x0303 | DECE CFF container format, Profile SD. | Section A.2.4.3 |
| 0x0304 | DECE CFF container format, Profile HD. | Section A.2.4.4 |
| 0x0305 | ISO Base Media File Format for AAC audio | Section A.2.5 |
| 0x0306 | ATSC compliant MPEG-2 transport stream | Section A.2.6 |
| 0x0307 | MP4 constrained container format, Profile | Section A.2.7 |
| | PD2. | |
| 0x0308 | W3C Web Apps Package | Section A.2.30 |
| 0x0309-0x03FF | Reserved for future ATSC use. | |

Capability Category: Compression Algorithms

| | | |
|---|---|---|
| 0x0400 | DEFLATE algorithm, as specified in this | Section A.2.31 |
| | Standard. | |
| 0x0401-0x04FF | Reserved for future ATSC use. | |

Capability Category: Media Types

| | | |
|---|---|---|
| 0x0501 | AVC standard definition video | Section A.2.8 |
| 0x0502 | AVC high definition video | Section A.2.9 |
| 0x0503 | AC-3 audio | Section A.2.10 |
| 0x0504 | E-AC-3 audio | Section A.2.11 |
| 0x0505 | MP3 audio | Section A.2.12 |
| 0x0506 | Browser Profile A (A/105) | Section A.2.13 |
| 0x0507 | Reserved | |
| 0x0508 | Atom per RFC 4287 | Section A.2.14 |
| 0x0509 | AVC mobile video | Section A.2.15 |
| 0x050A | HE AAC v2 mobile audio | Section A.2.16 |
| 0x050B | HE AAC v2 level 4 audio | Section A.2.17 |
| 0x050C | DTS-HD audio | Section A.2.18 |
| 0x050D | CFF-TT | Section A.2.19 |
| 0x050E | CEA-708 captions | Section A.2.20 |
| 0x050F | HE AAC v2 with MPEG Surround | Section A.2.21 |
| 0x0510 | HE AAC v2 Level 6 audio | Section A.2.22 |
| 0x0511 | Frame-compatible 3D video (Side-by-Side) | Section A.2.23 |
| 0x0512 | Frame-compatible 3D video (Top-and- | Section A.2.24 |
| | Bottom) | |
| 0x0513 | ATSC 3.0 HEVC Video 1 (e.g. HD video) | Section A.2.v1 |
| 0x0514 | ATSC 3.0 HEVC Video 2 (e.g. UHD video) | Section A.2.v2 |
| 0x0515 | ATSC 3.0 SHVC Video 1 | Section A.2.v3 |
| 0x0516 | ATSC 3.0 HDR Video 1 | Section A.2.v4 |
| 0x0517 | ATSC 3.0 Wide Color Gamut Video 1 | Section A.2.v5 |
| 0x0518 | ATSC 3.0 Coded Audio 1 (e.g. 5.1. channel | Section A.2.a1 |
| | surround audio) | |
| 0x0519 | ATSC 3.0 Coded Audio 2 (e.g. Immersive/ | Section A.2.a2 |
| | 3D Audio) | |
| 0x051A | Dialog level adjustment | Section A.2.a3 |
| 0x051B-0x05FF | Reserved for future ATSC use. | |

Capability Category: Internet Link

| | | |
|---|---|---|
| 0x0600 | Internet link, downward rate 56,000 bps or | Section A.2.25 |
| | better | |
| 0x0601 | Internet link, downward rate 512,000 bps or | Section A.2.26 |
| | better | |
| 0x0602 | Internet link, downward rate 2,000,000 bps | Section A.2.27 |
| | or better | |
| 0x0603 | Internet link, downward rate 10,000,000 bps | Section A.2.28 |
| | or better | |
| 0x0604-0x06FF | Reserved for future ATSC use. | |

ATSC Reserved

| | |
|---|---|
| 0x0001-0x00FF, | Reserved for future ATSC use. |
| 0x0700-0xBFFF | |

Reserved Private

| | |
|---|---|
| 0xC000-0xFFFF | Reserved for private use. |

TABLE 2
Capability Categories and Registries in A/103 (Included for reference)

| | Capability | |
|---|---|---|
| capability_category_code | Category | Registry |
| 0x00 | reserved | |
| 0x01 | Download | No registry - use widely |
| | Protocol | used industry name |
| 0x02 | FEC Algorithm | IANA registry of FEC |
| | | encoding IDs and |
| | | instance IDs |
| 0x03 | Wrapper/Archive | IANA registry of |
| | Format | media types and |
| | | subtypes |
| 0x04 | Compression | IANA registry of HTTP |
| | Algorithm | Content-Coding values |
| 0x05 | Media Type | IANA registry of |
| | | media types and subtypes |
| 0x06-0x7F | reserved | |

By way of example, the following code points may be defined for the video system.

A.2.v1 Capability Code 0x0413: ATSC 3.0 HEVC Video 1. The capability_code value 0x0413 may represent the receiver ability to support HEVC video encoded in conformance with the ATSC specification.

A.2.a1 Capability Code 0x0418: ATSC 3.0 Coded Audio 1. The capability_code value 0x0418 may represent the receiver ability to support ATSC coded audio encoded in conformance with the ATSC specification.

A XML Schema may be used for various elements and attributes which indicate required device capabilities. In one embodiment XML schema syntax is as shown below.

```
<xs:element name=“RequiredCapabilities”
type=“RequiredCapabilitiesType” minOccurs=“0”
maxOccurs=“unbounded”>
        <annotation>
              <documentation>
          This element is a wrapper for indicating required
capabilities for ATSC content consumption. It may only
be used inside a PrivateExt element within an Content fragment.
      </documentation>
      </annotation>
              </xs:element>
<xs:complexType name=“RequiredCapabilitiesType”>
<xs:sequence>
<xs:element name=“CapabilityCodes” type=“CCListType”
minOccurs=“0” maxOccurs=“1”/>
<xs:element name=“CapabilityString” type=“CCStringType”
minOccurs=“0” maxOccurs=“unbounded”/>
</xs:complexType>
<xs:simpleType name=“CCListType”>
      <xs:list itemType=“xs:unsignedShort”/>
</xs:simpleType>
<xs:complexType name=“CCStringType”>
      <xs:simpleContent>
              <xs:extension base=“xs:string”>
                    <xs:attribute name=“categorycode”
                    type=“xs:unsignedShort” use=“required”/>
              </xs:extension>
      </xs:simpleContent>
</xs:complexType>
```

In an alternative embodiment the XML schema may be as follows:

```
<xs:element name=“RequiredCapabilities”
type=“RequiredCapabilitiesType” minOccurs=“0”
maxOccurs=“unbounded”>
      <annotation>
            <documentation>
        This element is a wrapper for indicating required
capabilities for ATSC content consumption. It may only
be used inside a PrivateExt element within a Content fragment.
    </documentation>
    </annotation>
            </xs:element>
<xs:complexType name=“RequiredCapabilitiesType”>
<xs:sequence>
<xs:element name=“CapabilityCodes” type=“CCListType”
minOccurs=“0” maxOccurs=“1”/>
<xs:element name=“CapabilityString” type=“xs:string”
minOccurs=“0” maxOccurs=“unbounded”>
  <xs:sequence>
<xs:attribute name=“categorycode” type=“xs:unsignedShort”
minOccurs=“0” maxOccurs=“1”/>
  </xs:sequence>
</xs:element>
</xs:complexType>
<xs:simpleType name=“CCListType”>
      <xs:list itemType=“xs:unsignedShort”/>
</xs:simpleType>
```

In an alternative embodiment the data type unsigned Int may be used instead of unsigned short for elements in the list of capability codes (i.e. in CapabilityCodes element) and/or for the attribute of category code (i.e. categorycode) for the capability string (e.g. CapabilityString).

In alternative embodiment additional namespace qualifier may be added for an xml element/attributes/type. For example <xs:complexType name=“CCStringType”> may instead be called xs:complexType name=“atsc3:CCStringType”> or xs:complexType name=“atsc:CCStringType”> where atsc3 and atsc respectively indicate namespace.

Similarly for example <xs:element name=“CapabilityCodes” may instead be called <xs:element name=“atsc3:CapabilityCodes” or <xs:element name=“atsc:CapabilityCodes” where atsc3 and atsc respectively indicate namespace.

In some embodiments “category” may be changed from NO/TO to NO/TM.

In some embodiments “category” may be changed from NM/TM to NO/TM.

In other embodiments some of the elements above may be changed from E2 to E1 or in general from any EN to E(N−i) or from any EM to E(M+j) for any i and j.

In other embodiment some of the elements or sub-elements may instead be signalled as attributes.

In other embodiment some of the attributes may instead be signalled as elements or sub-elements.

In other embodiments the cardinality of some of the elements may be changed. For example cardinality may be changed from “1” to “0 . . . 1” or cardinality may be changed from “1” to “1 . . . N” or cardinality may be changed from “1” to “0 . . . N”.

Several different variants for XML representation of device capabilities are shown below.

Variant A1: A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and capability strings, each with a capability category code.

Variant A2: A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and a list of capability strings with capability category codes embedded in the string.

Variant A3: A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and a list of capability strings with an attribute which is a list of capability category codes.

Variant A4: A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability strings which can represent capability codes and/or capability strings, each with a capability category code.

Variant A5: A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and/or list of capability string elements together as a single element.

Variant B: A capabilities set element which can include capability codes and capability strings which could be grouped using Boolean AND/OR operations and a second level capability Boolean operation element which can flexibly represent further Boolean operations on initial AND/OR sets are defined.

For each variant:

A syntax structure table with elements and sub-elements is shown.

A XML schema is shown.

Validated examples of XML data are also described for each variant.

Additionally Table 1, 1A, 1B, 1C shown below represent capability codes and Table 2 shown below represents capability categories.

TABLE 1
Capability Codes

| | | |
|---|---|---|
| capability_code | Meaning | Reference (see A/103) |

| | |
|---|---|
| 0x0000 | Forbidden |

Capability Category: Download Protocols

| | | |
|---|---|---|
| 0x0101 | FLUTE protocol, as specified in A/103 | Section A.2.1 |
| 0x0102 | HTTP | |
| 0x0103 | HTTPS | |
| 0x0104-0x01FF | Reserved for future ATSC use. | |

Capability Category: FEC Algorithms

| | | |
|---|---|---|
| 0x0200 | Compact No-Code FEC scheme. | Section A.2.2 |
| 0x0201 | Raptor algorithm, as specified in this | Section A.2.3 |
| | Standard. | |
| 0x0202-0x02FF | Reserved for future ATSC use. | |

Capability Category: Wrapper/Archive Formats

| | | |
|---|---|---|
| 0x0300 | DECE CFF container general format | Section A.2.4.1 |
| 0x0301 | ZIP format, as specified in this Standard. | Section A.2.29 |
| 0x0302 | DECE CFF container format, Profile PD. | Section A.2.4.2 |
| 0x0303 | DECE CFF container format, Profile SD. | Section A.2.4.3 |
| 0x0304 | DECE CFF container format, Profile HD. | Section A.2.4.4 |
| 0x0305 | ISO Base Media File Format for AAC audio | Section A.2.5 |
| 0x0306 | ATSC compliant MPEG-2 transport stream | Section A.2.6 |
| 0x0307 | MP4 constrained container format, Profile | Section A.2.7 |
| | PD2. | |
| 0x0308 | W3C Web Apps Package | Section A.2.30 |
| 0x0309-0x03FF | Reserved for future ATSC use. | |

Capability Category: Compression Algorithms

| | | |
|---|---|---|
| 0x0400 | DEFLATE algorithm, as specified in this | Section A.2.31 |
| | Standard. | |
| 0x0401-0x04FF | Reserved for future ATSC use. | |

Capability Category: Media Types

| | | |
|---|---|---|
| 0x0501 | AVC standard definition video | Section A.2.8 |
| 0x0502 | AVC high definition video | Section A.2.9 |
| 0x0503 | AC-3 audio | Section A.2.10 |
| 0x0504 | E-AC-3 audio | Section A.2.11 |
| 0x0505 | MP3 audio | Section A.2.12 |
| 0x0506 | Browser Profile A (A/105) | Section A.2.13 |
| 0x0507 | Reserved | |
| 0x0508 | Atom per RFC 4287 | Section A.2.14 |
| 0x0509 | AVC mobile video | Section A.2.15 |
| 0x050A | HE AAC v2 mobile audio | Section A.2.16 |
| 0x050B | HE AAC v2 level 4 audio | Section A.2.17 |
| 0x050C | DTS-HD audio | Section A.2.18 |
| 0x050D | CFF-TT | Section A.2.19 |
| 0x050E | CEA-708 captions | Section A.2.20 |
| 0x050F | HE AAC v2 with MPEG Surround | Section A.2.21 |
| 0x0510 | HE AAC v2 Level 6 audio | Section A.2.22 |
| 0x0511 | Frame-compatible 3D video (Side-by-Side) | Section A.2.23 |
| 0x0512 | Frame-compatible 3D video (Top-and-Bottom) | Section A.2.24 |
| 0x0513 | ATSC 3.0 HEVC Video 1 (e.g. HD video) | Section A.2.v1 |
| 0x0514 | ATSC 3.0 HEVC Video 2 (e.g. UHD video) | Section TBD |
| 0x0515 | ATSC 3.0 SHVC Video 1 | Section TBD |
| 0x0516 | ATSC 3.0 HDR Video 1 | Section TBD |
| 0x0517 | ATSC 3.0 Wide Color Gamut Video 1 | Section TBD |
| 0x0518 | ATSC 3.0 Coded Audio 1 (e.g. 5.1. channel | Section A.2.a1 |
| | surround audio) | |
| 0x0519 | ATSC 3.0 Coded Audio 2 (e.g. Immersive/3D | Section TBD |
| | Audio) | |
| 0x051A | Dialog level adjustment | Section TBD |
| 0x051B-0x05FF | Reserved for future ATSC use. | |

Capability Category: Internet Link

| | | |
|---|---|---|
| 0x0600 | Internet link, downward rate 56,000 bps or | Section A.2.25 |
| | better | |
| 0x0601 | Internet link, downward rate 512,000 bps or | Section A.2.26 |
| | better | |
| 0x0602 | Internet link, downward rate 2,000,000 bps or | Section A.2.27 |
| | better | |
| 0x0603 | Internet link, downward rate 10,000,000 bps or | Section A.2.28 |
| | better | |
| 0x0604-0x06FF | Reserved for future ATSC use. | |

ATSC Reserved

| | |
|---|---|
| 0x001-0x00FF, | Reserved for future ATSC use. |
| 0x0700-0xBFFF | |

Reserved Private

| | |
|---|---|
| 0xC000-0xFFFF | Reserved for private use. |

TABLE 2
Capability Category codes

| | Capability | |
|---|---|---|
| capability_category_code | Category | Registry |
| 0x00 | reserved | |
| 0x01 | Download | No registry - use widely |
| | Protocol | used industry name |
| 0x02 | FEC Algorithm | IANA registry of FEC |
| | | encoding IDs and |
| | | instance IDs |
| 0x03 | Wrapper/Archive | IANA registry of |
| | Format | media types and |
| | | subtypes |
| 0x04 | Compression | IANA registry of HTTP |
| | Algorithm | Content-Coding values |
| 0x05 | Media Type | IANA registry of |
| | | media types and subtypes |
| 0x06-0xFF | reserved | |

TABLE 1A
Capability Codes

| | | |
|---|---|---|
| capability_code string | Meaning | Reference (see A/103) |

| | |
|---|---|
| “0x0000” | Forbidden |

Capability Category: Download Protocols

| | | |
|---|---|---|
| “0x0101” | FLUTE protocol, as specified in A/103 | Section A.2.1 |
| “0x0102” | HTTP | |
| “0x0103” | HTTPS | |
| “0x0104”-“0x01FF” | Reserved for future ATSC use. | |

Capability Category: FEC Algorithms

| | | |
|---|---|---|
| “0x0200” | Compact No-Code FEC scheme. | Section A.2.2 |
| “0x0201” | Raptor algorithm, as specified in this | Section A.2.3 |
| | Standard. | |
| “0x0202”-“0x02FF” | Reserved for future ATSC use. | |

Capability Category: Wrapper/Archive Formats

| | | |
|---|---|---|
| “0x0300” | DECE CFF container general format | Section A.2.4.1 |
| “0x0301” | ZIP format, as specified in this Standard. | Section A.2.29 |
| “0x0302” | DECE CFF container format, Profile PD. | Section A.2.4.2 |
| “0x0303” | DECE CFF container format, Profile SD. | Section A.2.4.3 |
| “0x0304” | DECE CFF container format, Profile HD. | Section A.2.4.4 |
| “0x0305” | ISO Base Media File Format for AAC audio | Section A.2.5 |
| “0x0306” | ATSC compliant MPEG-2 transport stream | Section A.2.6 |
| “0x0307” | MP4 constrained container format, Profile | Section A.2.7 |
| | PD2. | |
| “0x0308” | W3C Web Apps Package | Section A.2.30 |
| “0x0309”-“0x03FF” | Reserved for future ATSC use. | |

Capability Category: Compression Algorithms

| | | |
|---|---|---|
| “0x0400” | DEFLATE algorithm, as specified in this | Section A.2.31 |
| | Standard. | |
| “0x0401”-“0x04FF” | Reserved for future ATSC use. | |

Capability Category: Media Types

| | | |
|---|---|---|
| “0x0501” | AVC standard definition video | Section A.2.8 |
| “0x0502” | AVC high definition video | Section A.2.9 |
| “0x0503” | AC-3 audio | Section A.2.10 |
| “0x0504” | E-AC-3 audio | Section A.2.11 |
| “0x0505” | MP3 audio | Section A.2.12 |
| “0x0506” | Browser Profile A (A/105) | Section A.2.13 |
| “0x0507” | Reserved | |
| “0x0508” | Atom per RFC 4287 | Section A.2.14 |
| “0x0509” | AVC mobile video | Section A.2.15 |
| “0x050A” | HE AAC v2 mobile audio | Section A.2.16 |
| “0x050B” | HE AAC v2 level 4 audio | Section A.2.17 |
| “0x050C” | DTS-HD audio | Section A.2.18 |
| “0x050D” | CFF-TT | Section A.2.19 |
| “0x050E” | CEA-708 captions | Section A.2.20 |
| “0x050F” | HE AAC v2 with MPEG Surround | Section A.2.21 |
| “0x0510” | HE AAC v2 Level 6 audio | Section A.2.22 |
| “0x0511” | Frame-compatible 3D video (Side-by-Side) | Section A.2.23 |
| “0x0512” | Frame-compatible 3D video (Top-and-Bottom) | Section A.2.24 |
| “0x0513” | ATSC 3.0 HEVC Video 1 (e.g. HD video) | Section A.2.v1 |
| “0x0514” | ATSC 3.0 HEVC Video 2 (e.g. UHD video) | Section TBD |
| “0x0515” | ATSC 3.0 SHVC Video 1 | Section TBD |
| “0x0516” | ATSC 3.0 HDR Video 1 | Section TBD |
| “0x0517” | ATSC 3.0 Wide Color Gamut Video 1 | Section TBD |
| “0x0518” | ATSC 3.0 Coded Audio 1 (e.g. 5.1. channel | Section A.2.a1 |
| | surround audio) | |
| “0x0519” | ATSC 3.0 Coded Audio 2 (e.g. Immersive/3D | Section TBD |
| | Audio) | |
| “0x051A” | Dialog level adjustment | Section TBD |
| “0x051B”-“0x05FF” | Reserved for future ATSC use. | |

Capability Category: Internet Link

| | | |
|---|---|---|
| “0x0600” | Internet link, downward rate 56,000 bps or | Section A.2.25 |
| | better | |
| “0x0601” | Internet link, downward rate 512,000 bps or | Section A.2.26 |
| | better | |
| “0x0602” | Internet link, downward rate 2,000,000 bps or | Section A.2.27 |
| | better | |
| “0x0603” | Internet link, downward rate 10,000,000 bps or | Section A.2.28 |
| | better | |
| “0x0604”-“0x06FF” | Reserved for future ATSC use. | |

ATSC Reserved

| | |
|---|---|
| “0x001”-“0x00FF”, | Reserved for future ATSC use. |
| “0x0700”-“0xBFFF” | |

Reserved Private

| | |
|---|---|
| “0xC000”-“0xFFFF” | Reserved for private use. |

TABLE 1B
Capability Codes

| | | |
|---|---|---|
| capability_code string | Meaning | Reference (see A/103) |

| | |
|---|---|
| 0x00 | Forbidden |

Capability Category: Download Protocols

| | | |
|---|---|---|
| 0x01 | FLUTE protocol, as specified in A/103 | Section A.2.1 |
| 0x02 | HTTP | |
| 0x03 | HTTPS | |
| 0x04-0xFF | Reserved for future ATSC use. | |

Capability Category: FEC Algorithms

| | | |
|---|---|---|
| 0x00 | Compact No-Code FEC scheme. | Section A.2.2 |
| 0x01 | Raptor algorithm, as specified in this | Section A.2.3 |
| | Standard. | |
| 0x02-0xFF | Reserved for future ATSC use. | |

Capability Category: Wrapper/Archive Formats

| | | |
|---|---|---|
| 0x00 | DECE CFF container general format | Section A.2.4.1 |
| 0x01 | ZIP format, as specified in this Standard. | Section A.2.29 |
| 0x02 | DECE CFF container format, Profile PD. | Section A.2.4.2 |
| 0x03 | DECE CFF container format, Profile SD. | Section A.2.4.3 |
| 0x04 | DECE CFF container format, Profile HD. | Section A.2.4.4 |
| 0x05 | ISO Base Media File Format for AAC audio | Section A.2.5 |
| 0x06 | ATSC compliant MPEG-2 transport stream | Section A.2.6 |
| 0x07 | MP4 constrained container format, Profile | Section A.2.7 |
| | PD2. | |
| 0x08 | W3C Web Apps Package | Section A.2.30 |
| 0x09-0xFF | Reserved for future ATSC use. | |

Capability Category: Compression Algorithms

| | | |
|---|---|---|
| 0x00 | DEFLATE algorithm, as specified in this | Section A.2.31 |
| | Standard. | |
| 0x01-0xFF | Reserved for future ATSC use. | |

Capability Category: Media Types

| | | |
|---|---|---|
| 0x01 | AVC standard definition video | Section A.2.8 |
| 0x02 | AVC high definition video | Section A.2.9 |
| 0x03 | AC-3 audio | Section A.2.10 |
| 0x04 | E-AC-3 audio | Section A.2.11 |
| 0x05 | MP3 audio | Section A.2.12 |
| 0x06 | Browser Profile A (A/105) | Section A.2.13 |
| 0x07 | Reserved | |
| 0x08 | Atom per RFC 4287 | Section A.2.14 |
| 0x09 | AVC mobile video | Section A.2.15 |
| 0x0A | HE AAC v2 mobile audio | Section A.2.16 |
| 0x0B | HE AAC v2 level 4 audio | Section A.2.17 |
| 0x0C | DTS-HD audio | Section A.2.18 |
| 0x0D | CFF-TT | Section A.2.19 |
| 0x0E | CEA-708 captions | Section A.2.20 |
| 0x0F | HE AAC v2 with MPEG Surround | Section A.2.21 |
| 0x10 | HE AAC v2 Level 6 audio | Section A.2.22 |
| 0x11 | Frame-compatible 3D video (Side-by-Side) | Section A.2.23 |
| 0x12 | Frame-compatible 3D video (Top-and-Bottom) | Section A.2.24 |
| 0x13 | ATSC 3.0 HEVC Video 1 (e.g. HD video) | Section A.2.v1 |
| 0x14 | ATSC 3.0 HEVC Video 2 (e.g. UHD video) | Section TBD |
| 0x15 | ATSC 3.0 SHVC Video 1 | Section TBD |
| 0x16 | ATSC 3.0 HDR Video 1 | Section TBD |
| 0x17 | ATSC 3.0 Wide Color Gamut Video 1 | Section TBD |
| 0x18 | ATSC 3.0 Coded Audio 1 (e.g. 5.1. channel | Section A.2.a1 |
| | surround audio) | |
| 0x19 | ATSC 3.0 Coded Audio 2 (e.g. Immersive/3D | Section TBD |
| | Audio) | |
| 0x1A | Dialog level adjustment | Section TBD |
| 0x1B-0xFF | Reserved for future ATSC use. | |

Capability Category: Internet Link

| | | |
|---|---|---|
| 0x00 | Internet link, downward rate 56,000 bps or | Section A.2.25 |
| | better | |
| 0x01 | Internet link, downward rate 512,000 bps or | Section A.2.26 |
| | better | |
| 0x02 | Internet link, downward rate 2,000,000 bps or | Section A.2.27 |
| | better | |
| 0x03 | Internet link, downward rate 10,000,000 bps or | Section A.2.28 |
| | better | |
| 0x04-0xFF | Reserved for future ATSC use. | |

TABLE 1C
Capability Codes

| | | |
|---|---|---|
| capability_code string | Meaning | Reference (see A/103) |

| | |
|---|---|
| “0x00” | Forbidden |

Capability Category: Download Protocols

| | | |
|---|---|---|
| “0x01” | FLUTE protocol, as specified in A/103 | Section A.2.1 |
| “0x02” | HTTP | |
| “0x03” | HTTPS | |
| “0x04”-“0xFF” | Reserved for future ATSC use. | |

Capability Category: FEC Algorithms

| | | |
|---|---|---|
| “0x00” | Compact No-Code FEC scheme. | Section A.2.2 |
| “0x01” | Raptor algorithm, as specified in this | Section A.2.3 |
| | Standard. | |
| “0x02”-“0xFF” | Reserved for future ATSC use. | |

Capability Category: Wrapper/Archive Formats

| | | |
|---|---|---|
| “0x00” | DECE CFF container general format | Section A.2.4.1 |
| “0x01” | ZIP format, as specified in this Standard. | Section A.2.29 |
| “0x02” | DECE CFF container format, Profile PD. | Section A.2.4.2 |
| “0x03” | DECE CFF container format, Profile SD. | Section A.2.4.3 |
| “0x04” | DECE CFF container format, Profile HD. | Section A.2.4.4 |
| “0x05” | ISO Base Media File Format for AAC audio | Section A.2.5 |
| “0x06” | ATSC compliant MPEG-2 transport stream | Section A.2.6 |
| “0x07” | MP4 constrained container format, Profile | Section A.2.7 |
| | PD2. | |
| “0x08” | W3C Web Apps Package | Section A.2.30 |
| “0x09”-“0xFF” | Reserved for future ATSC use. | |

Capability Category: Compression Algorithms

| | | |
|---|---|---|
| “0x00” | DEFLATE algorithm, as specified in this | Section A.2.31 |
| | Standard. | |
| “0x01”-“0xFF” | Reserved for future ATSC use. | |

Capability Category: Media Types

| | | |
|---|---|---|
| “0x01” | AVC standard definition video | Section A.2.8 |
| “0x02” | AVC high definition video | Section A.2.9 |
| “0x03” | AC-3 audio | Section A.2.10 |
| “0x04” | E-AC-3 audio | Section A.2.11 |
| “0x05” | MP3 audio | Section A.2.12 |
| “0x06” | Browser Profile A (A/105) | Section A.2.13 |
| “0x07” | Reserved | |
| “0x08” | Atom per RFC 4287 | Section A.2.14 |
| “0x09” | AVC mobile video | Section A.2.15 |
| “0x0A” | HE AAC v2 mobile audio | Section A.2.16 |
| “0x0B” | HE AAC v2 level 4 audio | Section A.2.17 |
| “0x0C” | DTS-HD audio | Section A.2.18 |
| “0x0D” | CFF-TT | Section A.2.19 |
| “0x0E” | CEA-708 captions | Section A.2.20 |
| “0x0F” | HE AAC v2 with MPEG Surround | Section A.2.21 |
| “0x10” | HE AAC v2 Level 6 audio | Section A.2.22 |
| “0x11” | Frame-compatible 3D video (Side-by-Side) | Section A.2.23 |
| “0x12” | Frame-compatible 3D video (Top-and-Bottom) | Section A.2.24 |
| “0x13” | ATSC 3.0 HEVC Video 1 (e.g. HD video) | Section A.2.v1 |
| “0x14” | ATSC 3.0 HEVC Video 2 (e.g. UHD video) | Section TBD |
| “0x15” | ATSC 3.0 SHVC Video 1 | Section TBD |
| “0x16” | ATSC 3.0 HDR Video 1 | Section TBD |
| “0x17” | ATSC 3.0 Wide Color Gamut Video 1 | Section TBD |
| “0x18” | ATSC 3.0 Coded Audio 1 (e.g. 5.1. channel | Section A.2.a1 |
| | surround audio) | |
| “0x19” | ATSC 3.0 Coded Audio 2 (e.g. Immersive/3D | Section TBD |
| | Audio) | |
| “0x1A” | Dialog level adjustment | Section TBD |
| “0x1B”-“0xFF” | Reserved for future ATSC use. | |

Capability Category: Internet Link

| | | |
|---|---|---|
| “0x00” | Internet link, downward rate 56,000 bps or | Section A.2.25 |
| | better | |
| “0x01” | Internet link, downward rate 512,000 bps or | Section A.2.26 |
| | better | |
| “0x02” | Internet link, downward rate 2,000,000 bps or | Section A.2.27 |
| | better | |
| “0x03” | Internet link, downward rate 10,000,000 bps or | Section A.2.28 |
| | better | |
| “0x04”-“0xFF” | Reserved for future ATSC use. | |

### Example Description of New Code Points

A.2.v1 Capability Code 0x0513/0x13: ATSC 3.0 HEVC Video 1
The capability_code value 0x0413 shall represent the receiver ability to support HEVC video encoded in conformance with the ATSC specification.

A.2.a1 Capability Code 0x0518/0x18: ATSC 3.0 Coded Audio 1

The capability_code value 0x0418 shall represent the receiver ability to support ATSC coded audio encoded in conformance with the ATSC specification.

<<Variant A1>>

A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and capability strings, each with a capability category code.

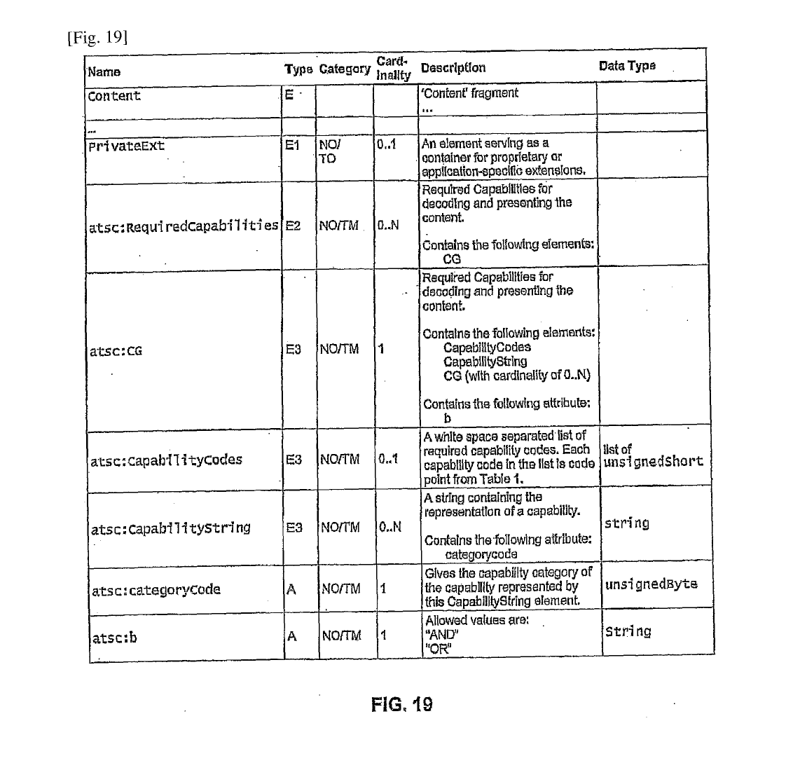

New elements for signaling required capability according to this variant are shown in FIG. 19.

With respect to FIG. 19, the list of code points in CapabilityCodes element (if present), the list of strings in CapabilityStrings element (if present) and other CG elements (if present) combined with the logical operation (AND/OR) as specified by the value of attribute b of the parent element CG specifies the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a RequiredCapabilities element, each string in the list of Strings in the CapabilityString element indicates a capability required in addition to those listed in the CapabilitieCodes element. Each string in the CapabilityString element shall conform to the pattern specified in XML schema for pString. Thus according to the pattern, for each string a capability category code (in the range of 0-255) shall be included in the string. This will be delimited with a specific delimiter (e.g. ‘=’ in the XML schema shown) followed by capability string. Capability string shall conform to the table 2. In alternate embodiment different delimiter (e.g. ‘-’ or ‘%’ or ‘,’ etc.) may be used. Also order of string and capability category code may be changed.

The required capability code list in atsc:CapabilityCodes sub-element shall contain at most one capability code of each capability category unless a particular capability code C1 allows multiple capability codes to be present for the capability category as described in its Reference section A.2.xx.

When the list of required capability codes in atsc:CapabilityCodes sub-element in an atsc:RequiredCapabilities element contains a capability code C1 such that V1 is equal to (C1 & 0x0F00)>>16 and V1 is in the range of 0x01 to 0x05, inclusive, any atsc:CapabilityString sub-element in the same atsc:RequiredCapabilities element shall not have atsc:categoryCode value equal to V1 unless the associated capability code C1 allowsmultiple capability codes to be present for the capability category as described in its Reference section A.2.xx. Where & being bit-wise AND operator and >> being binary right shift operator.

In yet another embodiment elements atsc:CapabilityStrings, and atsc:CapabilityCodes may instead be called atsc:CS, atsc:CCo respectively. Other such abbreviations are also considered to be in the scope of this invention. The benefit here is to save number of bytes required to signal the XML data. Thus when listing several strings the representation as an example <atsc:CS>String1</atsc:CS> will require less bytes than <atsc:CapabilityStrings>String1</atsc:CapabilityStrings>.

In an alternative embodiment the allowed values for the attribute atsc:b could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc:b | A | NO/TM | 1 | Allowed values are: | unsignedByte |
| | | | | “1” (represents AND | |
| | | | | operation) | |
| | | | | “0” (represents OR operation) | |

In another embodiment some other data type e.g. int or unsignedInt may be used in place of unsignedByte.

In an alternative embodiment in addition to AND, OR Boolean operations other type of Boolean operations e.g. NOT, NAND, NOR, XOR, XNOR may be supported. For example this may be done as follows:

| | | | | | |
|---|---|---|---|---|---|
| atsc:b | A | NO/TM | 1 | Allowed values are: | String |
| | | | | “AND” | |
| | | | | “OR” | |
| | | | | “NOT” | |
| | | | | “NAND” | |
| | | | | “NOR” | |
| | | | | “XOR” | |
| | | | | “XNOR” | |

Example XML Schema for this variant is shown below

```
<?xml version=“1.0” encoding=“UTF-8”?>
<xs:schema xmlns:xs=“http://www.w3.org/2001/XMLSchema” >
<xs:element name=“RequiredCapabilities”
type=“CapabilitiesOperType” />
<xs:complexType name=“CapabilitiesOperType”>
<xs:sequence>
<xs:element name=“CG” type=“RequiredCapabilitiesType”
minOccurs=“0” maxOccurs=“unbounded”/>
</xs:sequence>
</xs:complexType>
<xs:complexType name=“RequiredCapabilitiesType”>
            <xs:sequence>
                  <xs:element name=“CapabilityCodes”
type=“CCListType” minOccurs=“0” maxOccurs=“1”/>
                  <xs:element name=“CapabilityString”
type=“CCStringType” minOccurs=“0” maxOccurs=“unbounded”/>
                  <xs:element name=“CG”
type=“RequiredCapabilitiesType” minOccurs=“0”
maxOccurs=“unbounded”/>
            </xs:sequence>
            <xs:attribute name=“b” type=“bEnumType”
use=“required”/>
</xs:complexType>
<xs:simpleType name=“bEnumType”>
      <xs:restriction base=“xs:string”>
  <xs:enumeration value=“AND” />
  <xs:enumeration value=“OR” />
      </xs:restriction>
      </xs:simpleType>
<xs:simpleType name=“CCListType”>
      <xs:list itemType=“xs:unsignedShort”/>
</xs:simpleType>
<xs:complexType name=“CCStringType”>
      <xs:simpleContent>
            <xs:extension base=“xs:string”>
                  <xs:attribute name=“categorycode”
                  type=“xs:unsignedByte” use=“required”/>
            </xs:extension>
      </xs:simpleContent>
</xs:complexType>
</xs:schema>
```

Valid XML Data representation examples according to the above example XML schema is shown below.

### Example 1

```
            Required capabilities of
            ( (http AND hevc AND video/mp4) AND
            (5=audio/vorbis OR 5=audio/PCMA OR 5=audio/PCMU))
            i.e.
            ( (258 AND 1299 AND video/mp4) AND
            (5=audio/vorbis OR 5=audio/PCMA OR 5=audio/PCMU))
            are indicated as:
<RequiredCapabilities
xmlns:xsi=“http://www.w3.org/2001/XMLSchema-instance”
          xsi:noNamespaceSchemaLocation=“devcapBool1.xsd”>
      <CG b=“AND”>
            <CapabilityCodes>258 1299</CapabilityCodes>
            <CapabilityString categorycode=“3”>video/mp4
            </CapabilityString>
            <CG b=“OR”>
            <CapabilityString categorycode=“5”>audio/vorbis
            </CapabilityString>
            <CapabilityString categorycode=“5”>audio/PCMA
            </CapabilityString>
            <CapabilityString categorycode=“5”>audio/PCMU
            </CapabilityString>
            </CG>
      </CG>
</RequiredCapabilities>
```

### Example 2

```
            Required capabilities of
            ( (http AND video/mp4) AND (hevc OR avc) AND
(5=audio/vorbis OR 5=audio/PCMA OR 5=audio/PCMU))
            i.e.
            ( (258 AND video/mp4) AND (1299 OR 1282) AND
(5=audio/vorbis OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool1.xsd”>
      <CG b=“AND”>
            <CapabilityCodes>258</CapabilityCodes>
            <CapabilityString categorycode=“3”>video/mp4
            </CapabilityString>
            <CG b=“OR”>
                  <CapabilityCodes>1299 1282</CapabilityCodes>
            </CG>
            <CG b=“OR”>
                  <CapabilityString categorycode=“5”>audio/vorbis
                  </CapabilityString>
                  <CapabilityString categorycode=“5”>audio/PCMA
                  </CapabilityString>
                  <CapabilityString categorycode=“5”>audio/PCMU
                  </CapabilityString>
            </CG>
      </CG>
      </RequiredCapabilities>
```

### Example 3

```
            Required capabilities of
            ( ((http AND hevc AND video/mp4) OR (flute AND avc))
AND (5=audio/vorbis OR 5=audio/PCMA OR 5=audio/PCMU) )
            i.e.
            ( ((258 AND 1299 AND video/mp4) OR (257 AND 1282))
AND (5=audio/vorbis OR 5=audio/PCMA OR 5=audio/PCMU) )
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool1.xsd”>
      <CG b=“AND”>
            <CG b=“OR”>
                  <CG b=“AND”>
                        <CapabilityCodes>258 1299
                        </CapabilityCodes>
                        <CapabilityString categorycode=“3”>video/
                        mp4</CapabilityString>
                  </CG>
                  <CG b=“AND”>
                        <CapabilityCodes>257 1282
                        </CapabilityCodes>
                  </CG>
            </CG>
            <CG b=“OR”>
                  <CapabilityString categorycode=“5”>audio/vorbis
                  </CapabilityString>
                  <CapabilityString categorycode=“5”>audio/PCMA
                  </CapabilityString>
                  <CapabilityString categorycode=“5”>audio/PCMU
                  </CapabilityString>
            </CG>
      </CG>
</RequiredCapabilities>
```

### <<Variant A2>>

A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and a list of capability strings with capability category codes embedded in the string.

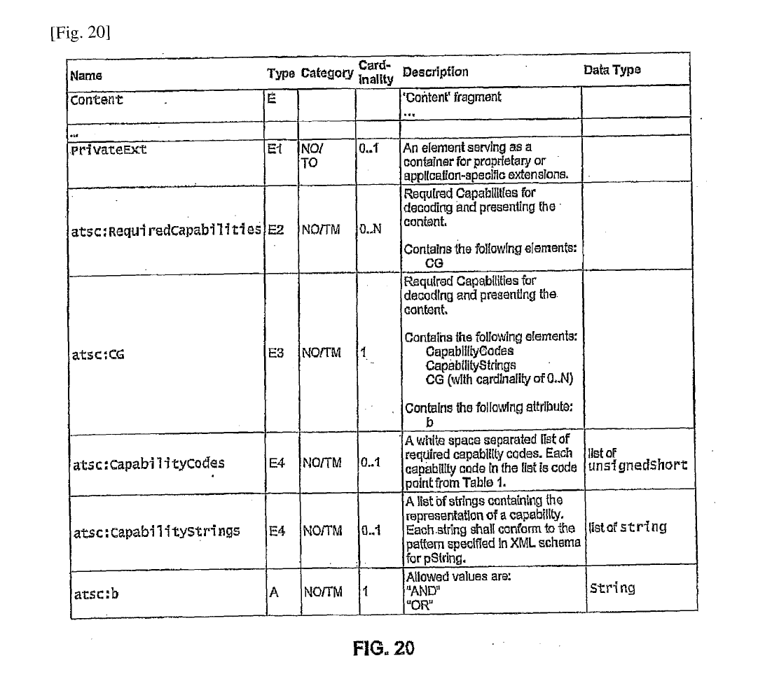

New elements for signaling required capability according to this variant are shown in FIG. 20.

With respect to FIG. 20, the list of code points in CapabilityCodes element (if present), the list of strings in CapabilityStrings element (if present) and other CG elements (if present) combined with the logical operation (AND/OR) as specified by the value of attribute b of the parent element CG specifies the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a RequiredCapabilities element, each string in the list of Strings in the CapabilityString element indicates a capability required in addition to those listed in the CapabilitieCodes element. Each string in the CapabilityString element shall conform to the pattern specified in XML schema for pString. Thus according to the pattern, for each string a capability category code (in the range of 0-255) shall be included in the string. This will be delimited with a specific delimiter (e.g. ‘=’ in the XML schema shown) followed by capability string. Capability string shall conform to the table 2. In alternate embodiment different delimiter (e.g. ‘-’ or ‘%’ or ‘,’ etc.) may be used. Also order of string and capability category code may be changed.

The required capability code list in atsc:CapabilityCodes sub-element shall contain at most one capability code of each capability category unless a particular capability code C1 allows multiple capability codes to be present for the capability category as described in its Reference section A.2.xx.

When the list of required capability codes in atsc:CapabilityCodes sub-element in an atsc:RequiredCapabilities element contains a capability code C1 such that V1 is equal to (C1 & 0x0F00)>>16 and V1 is in the range of 0x01 to 0x05, inclusive, any atsc:CapabilityString sub-element in the same atsc:RequiredCapabilities element shall not have atsc:categoryCode value equal to V1 unless the associated capability code C1 allowsmultiple capability codes to be present for the capability category as described in its Reference section A.2.xx. Where & being bit-wise AND operator and >> being binary right shift operator.

In yet another embodiment elements atsc:CapabilityStrings, and atsc:CapabilityCodes may instead be called atsc:CS, atsc:CCo respectively. Other such abbreviations are also considered to be in the scope of this invention. The benefit here is to save number of bytes required to signal the XML data. Thus when listing several strings the representation as an example <atsc:CS>String1</atsc:CS>will require less bytes than <atsc:CapabilityStrings>String1</atsc:CapabilityStrings>.

In an alternative embodiment the allowed values for the attribute atsc:b could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc:b | A | NO/TM | 1 | Allowed values are: | unsignedByte |
| | | | | “1” | |
| | | | | “0” | |

In another embodiment some other data type e.g. int or unsignedInt may be used in place of unsignedByte.

In an alternative embodiment in addition to AND, OR Boolean operations other type of Boolean operations e.g. NOT, NAND, NOR, XOR, XNOR may be supported. For example this may be done as follows:

| | | | | | |
|---|---|---|---|---|---|
| atsc:b | A | NO/TM | 1 | Allowed values are: | String |
| | | | | “AND” | |
| | | | | “OR” | |
| | | | | “NOT” | |
| | | | | “NAND” | |
| | | | | “NOR” | |
| | | | | “XOR” | |
| | | | | “XNOR” | |

Example XML Schema for this variant is shown below.

```
<?xml version=“1.0” encoding=“UTF-8”?>
<xs:schema xmlns:xs=“http://www.w3.org/2001/XMLSchema” >
<xs:element name=“RequiredCapabilities”
type=“CapabilitiesOperType” />
<xs:complexType name=“CapabilitiesOperType”>
<xs:sequence>
<xs:element name=“CG” type=“RequiredCapabilitiesType”
minOccurs=“0” maxOccurs=“1”/>
</xs:sequence>
</xs:complexType>
<xs:complexType name=“RequiredCapabilitiesType”>
            <xs:sequence>
                  <xs:element name=“CapabilityCodes”
type=“CCListType” minOccurs=“0” maxOccurs=“1”/>
                  <xs:element name=“CapabilityStrings”
type=“CCStringListType” minOccurs=“0” maxOccurs=“1”/>
                  <xs:element name=“CG”
type=“RequiredCapabilitiesType” minOccurs=“0”
maxOccurs=“unbounded”/>
            </xs:sequence>
            <xs:attribute name=“b” type=“bEnumType”
            use=“required”/>
</xs:complexType>
<xs:simpleType name=“bEnumType”>
      <xs:restriction base=“xs:string”>
  <xs:enumeration value=“AND” />
  <xs:enumeration value=“OR” />
      </xs:restriction>
      </xs:simpleType>
</xs:simpleType>
<xs:simpleType name=“CCListType”>
      <xs:list itemType=“xs:unsignedShort”/>
</xs:simpleType>
<xs:simpleType name=“pString”>
  <xs:restriction base=“xs:string”>
    <xs:pattern value=‘([0-9]|[1-9][0-9]|1[0-9][0-9]|2[0-4][0-9]|25[0-5])=
    [a-zA-Z0-9/]*’/>
  </xs:restriction>
</xs:simpleType>
<xs:simpleType name=“CCStringListType”>
      <xs:list itemType=“pString”/>
</xs:simpleType>
</xs:schema>
```

In an alternative embodiment the XML Schema may be as follows:

```
<?xml version=“1.0” encoding=“UTF-8”?>
<xs:schema xmlns:xs=“http://www.w3org/2001/XMLSchema” >
<xs:element name=“RequiredCapabilities”
type=“CapabilitiesOperType” />
<xs:complexType name=“CapabilitiesOperType”>
<xs:sequence>
<xs:element name=“CG” type=“RequiredCapabilitiesType”
minOccurs=“0” maxOccurs=“1”/>
</xs:sequence>
</xs:complexType>
<xs:complexType name=“RequiredCapabilitiesType”>
            <xs:sequence>
                  <xs:element name=“CapabilityCodes”
type=“CCListType” minOccurs=“0” maxOccurs=“1”/>
                  <xs:element name=“CapabilityStrings”
type=“CCStringListType” minOccurs=“0”
maxOccurs=“1”/>
                  <xs:element name=“CG”
type=“RequiredCapabilitiesType” minOccurs=“0”
maxOccurs=“unbounded”/>
            </xs:sequence>
            <xs:attribute name=“b” type=“bEnumType”
            use=“required”/>
</xs:complexType>
<!--1= AND, 0=OR -->
<xs:simpleType name=“bEnumType”>
      <xs:restriction base=“xs:byte”>
  <xs:enumeration value=“1” />
  <xs:enumeration value=“0” />
</xs:restriction>
</xs:simpleType>
<xs:simpleType name=“CCListType”>
      <xs:list itemType=“xs:unsignedShort”/>
</xs:simpleType>
<xs:simpleType name=“pString”>
  <xs:restriction base=“xs:string”>
    <xs:pattern value=‘([0-9]|[1-9][0-9]|1[0-9][0-9]|2[0-4][0-9]|25[0-5])=
    [a-zA-Z0-9/]*’/>
  </xs:restriction>
</xs:simpleType>
<xs:simpleType name=“CCStringListType”>
      <xs:list itemType=“pString”/>
</xs:simpleType>
</xs:schema>
```

Valid XML Data representation examples according to the above example XML schema is shown below.

### Example 1

```
            Required capabilities of
            ( (http AND hevc AND video/mp4) AND
            (5=audio/vorbis OR 5=audio/PCMA OR 5=audio/PCMU))
            i.e.
            ( (258 AND 1299 AND video/mp4) AND
            (5=audio/vorbis OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
            xsi:noNamespaceSchemaLocation=“devcapBool2.xsd”>
      <CG b=“AND”>
            <CapabilityCodes>258 1299</CapabilityCodes>
            <CapabilityStrings>3=video/mp4</CapabilityStrings>
            <CG b=“OR”>
                  <CapabilityStrings>5=audio/vorbis 5=audio/
                  PCMA 5=audio/PCMU</CapabilityStrings>
            </CG>
      </CG>
</RequiredCapabilities>
```

### Example 2

```
      Required capabilities of
      ( (http AND video/mp4) AND (hevc OR avc) AND
(5=audio/vorbis OR 5=audio/PCMA OR 5=audio/PCMU))
      i.e.
      ( (258 AND video/mp4) AND (1299 OR 1282) AND
(5=audio/vorbis OR 5=audio/PCMA OR 5=audio/PCMU))
      are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool2.xsd”>
      <CG b=“AND”>
            <CapabilityCodes>258</CapabilityCodes>
            <CapabilityStrings>3=video/mp4</CapabilityStrings>
            <CG b=“OR”>
                  <CapabilityCodes>1299 1282</CapabilityCodes>
            </CG>
            <CG b=“OR”>
                  <CapabilityStrings>5=audio/vorbis 5=audio/PCMA
                  5=audio/PCMU</CapabilityStrings>
            </CG>
      </CG>
</RequiredCapabilities>
```

### Example 3

```
            Required capabilities of
            ( ((http AND hevc AND video/mp4) OR (flute AND avc))
AND (5=audio/vorbis OR 5=audio/PCMA OR 5=audio/PCMU) )
            i.e.
( ((258 AND 1299 AND video/mp4) OR (257 AND 1282)) AND
(5=audio/vorbis OR 5=audio/PCMA OR 5=audio/PCMU) )
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool2.xsd”>
      <CG b=“AND”>
            <CG b=“OR”>
                  <CG b=“AND”>
                        <CapabilityCodes>258 1299
                        </CapabilityCodes>
                        <CapabilityStrings>3=video/mp4
                        </CapabilityStrings>
                  </CG>
                  <CG b=“AND”>
                        <CapabilityCodes>257 1282
                        </CapabilityCodes>
                  </CG>
            </CG>
            <CG b=“OR”>
                  <CapabilityStrings>5=audio/vorbis 5=audio/PCMA
                  5=audio/PCMU</CapabilityStrings>
</CG>
      </CG>
</RequiredCapabilities>
```

### <<Variant A3>>

A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and a list of capability strings with an attribute which is a list of capability category codes.

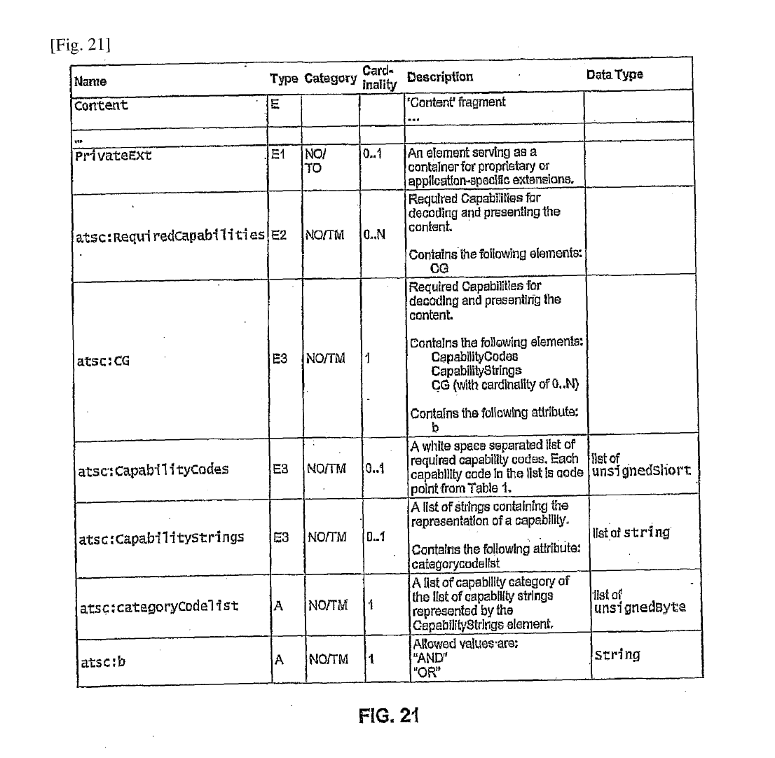

New elements for signaling required capability according to this variant are shown in FIG. 21.

With respect to FIG. 21, the list of code points in CapabilityCodes element (if present), the list of strings in CapabilityStrings element (if present) and other CG elements (if present) combined with the logical operation (AND/OR) as specified by the value of attribute b of the parent element CG specifies the total required capabilities required in the receiver to be able to create a meaningful presentation of the content. Multiple occurrences of RequiredCapabilities elements represent alternative sets of required capabilities, the support of any one of which is sufficient to create a meaningful presentation.

When atsc:CapabilityStrings sub-element is present in an atsc:RequiredCapabilities element, the atsc:categoryCodelist attribute shall be present and the length of the list atsc:CapabilityStrings shall be equal to the length of the list atsc:categorycodelist.

In this case there is one to one correspondence between elements in the two lists atsc:CapabilityStrings, atsc:categoryCodelist such that the i'th element in the list atsc:categorycodelist specifies the capability category code for the I'th element in the list atsc:CapabilityStrings.

Within a particular instance of a RequiredCapabilities element, each string in the list of Strings in the CapabilityString element indicates a capability required in addition to those listed in the CapabilitieCodes element. Capability string shall conform to the table 2.

The required capability code list in atsc:CapabilityCodes sub-element shall contain at most one capability code of each capability category unless a particular capability code C1 allows multiple capability codes to be present for the capability category as described in its Reference section A.2.xx.

When the list of required capability codes in atsc:CapabilityCodes sub-element in an atsc:RequiredCapabilities element contains a capability code C1 such that V1 is equal to (C1 & 0x0F00)>>16 and V1 is in the range of 0x01 to 0x05, inclusive, any atsc:CapabilityString sub-element in the same atsc:RequiredCapabilities element shall not have atsc:categoryCode value equal to V1 unless the associated capability code C1 allowsmultiple capability codes to be present for the capability category as described in its Reference section A.2.xx. Where & being bit-wise AND operator and >> being binary right shift operator.

In yet another embodiment elements atsc:CapabilityStrings, and atsc:CapabilityCodes may instead be called atsc:CS, atsc:CCo respectively. Other such abbreviations are also considered to be in the scope of this invention. The benefit here is to save number of bytes required to signal the XML data. Thus when listing several strings the representation as an example <atsc:CS>String1</atsc:CS>will require less bytes than <atsc:CapabilityStrings>String1</atsc:CapabilityStrings>.

In an alternative embodiment the allowed values for the attribute atsc:b could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc:b | A | NO/TM | 1 | Allowedvalues are: | unsignedByte |
| | | | | “1” | |
| | | | | “0” | |

In another embodiment some other data type e.g. int or unsignedInt may be used in place of unsignedByte.

In an alternative embodiment in addition to AND, OR Boolean operations other type of Boolean operations e.g. NOT, NAND, NOR, XOR, XNOR may be supported. For example this may be done as follows:

| | | | | | |
|---|---|---|---|---|---|
| atsc:b | A | NO/TM | 1 | Allowed values are: | String |
| | | | | “AND” | |
| | | | | “OR” | |
| | | | | “NOT” | |
| | | | | “NAND” | |
| | | | | “NOR” | |
| | | | | “XOR” | |
| | | | | “XNOR” | |

Example XML Schema for this variant is shown below.

```
<?xml version=“1.0” encoding=“UTF-8”?>
<xs:schema xmlns:xs=“http://www.w3.org/2001/XMLSchema” >
<xs:element name=“RequiredCapabilities”
type=“CapabilitiesOperType” />
<xs:complexType name=“CapabilitiesOperType”>
<xs:sequence>
<xs:element name=“CG” type=“RequiredCapabilitiesType”
minOccurs=“0” maxOccurs=“unbounded”/>
</xs:sequence>
</xs:complexType>
<xs:complexType name=“RequiredCapabilitiesType”>
            <xs:sequence>
            <xs:element name=“CapabilityCodes”
type=“CCuShortListType” minOccurs=“0” maxOccurs=“1”/>
                  <xs:element name=“CapabilityStrings”
type=“CCSLType” minOccurs=“0” maxOccurs=“1”/>
                  <xs:element name=“CG”
type=“RequiredCapabilitiesType” minOccurs=“0”
maxOccurs=“unbounded”/>
            </xs:sequence>
            <xs:attribute name=“b” type=“bEnumType”
            use=“required”/>
</xs:complexType>
<xs:simpleType name=“bEnumType”>
      <xs:restriction base=“xs:string”>
  <xs:enumeration value=“AND” />
  <xs:enumeration value=“OR” />
      </xs:restriction>
      </xs:simpleType>
<xs:simpleType name=“CCuShortListType”>
      <xs:list itemType=“xs:unsignedShort”/>
</xs:simpleType>
<xs:simpleType name=“CCuByteListType”>
      <xs:list itemType=“xs:unsignedByte”/>
</xs:simpleType>
<xs:simpleType name=“CCStringListType”>
      <xs:list itemType=“xs:string”/>
</xs:simpleType>
<xs:complexType name=“CCSLType”>
      <xs:simpleContent>
            <xs:extension base=“CCStringListType”>
                  <xs:attribute name=“categorycodelist”
                  type=“CCuByteListType” use=“required”/>
            </xs:extension>
      </xs:simpleContent>
</xs:complexType>
</xs:schema>
```

Valid XML Data representation examples according to the above example XML schema is shown below.

### Example 1

```
            Required capabilities of
            ( (http AND hevc AND video/mp4) AND (5=audio/vorbis
            OR 5=audio/PCMA OR 5=audio/PCMU))
            i.e.
            ( (258 AND 1299 AND video/mp4) AND (5=audio/vorbis
            OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool3.xsd”>
      <CG b=“AND”>
            <CapabilityCodes>258 1299</CapabilityCodes>
            <CapabilityStrings categorycodelist=“3”>video/
            mp4</CapabilityStrings>
            <CG b=“OR”>
                  <CapabilityStrings categorycodelist=“5 5 5”>audio/
vorbis audio/PCMA audio/PCMU</CapabilityStrings>
            </CG>
      </CG>
</RequiredCapabilities>
```

### Example 2

```
            Required capabilities of
            ( (http AND video/mp4) AND (hevc OR avc) AND
(5=audio/vorbis OR 5=audio/PCMA OR 5=audio/PCMU))
            i.e.
            ( (258 AND video/mp4) AND (1299 OR 1282) AND
(5=audio/vorbis OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool3.xsd”>
            <CG b=“AND”>
            <CapabilityCodes>258</CapabilityCodes>
            <CapabilityStrings categorycodelist=“3”>video/
            mp4</CapabilityStrings>
            <CG b=“OR”>
                  <CapabilityCodes>1299 1282</CapabilityCodes>
            </CG>
            <CG b=“OR”>
                  <CapabilityStrings categorycodelist=“5 5 5”>audio/
vorbisVaudio/PCMA audio/PCMU</CapabilityStrings>
            </CG>
      </CG>
</RequiredCapabilities>
```

### Example 3

```
            Required capabilities of
            ( ((http AND hevc AND video/mp4) OR (flute AND avc))
AND (5=audio/vorbis OR 5=audio/PCMA OR 5=audio/PCMU) )
            i.e.
            ( ((258 AND 1299 AND video/mp4) OR (257 AND 1282))
AND (5=audio/vorbis OR 5=audio/PCMA OR 5=audio/PCMU) )
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool3.xsd”>
      <CG b=“AND”>
            <CG b=“OR”>
                  <CG b=“AND”>
                        <CapabilityCodes>258
                        1299</CapabilityCodes>
                        <CapabilityStrings
                        categorycodelist=“3”>video/
                        mp4</CapabilityStrings>
                  </CG>
                  <CG b=“AND”>
                        <CapabilityCodes>257
                        1282</CapabilityCodes>
                  </CG>
            </CG>
            <CG b=“OR”>
                  <CapabilityStrings categorycodelist=“5 5 5”>audio/
vorbis audio/PCMA audio/PCMU</CapabilityStrings>
            </CG>
      </CG>
</RequiredCapabilities>
```

### <<Variant A4>>

A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability strings which can represent capability codes and/or capability strings, each with a capability category code.

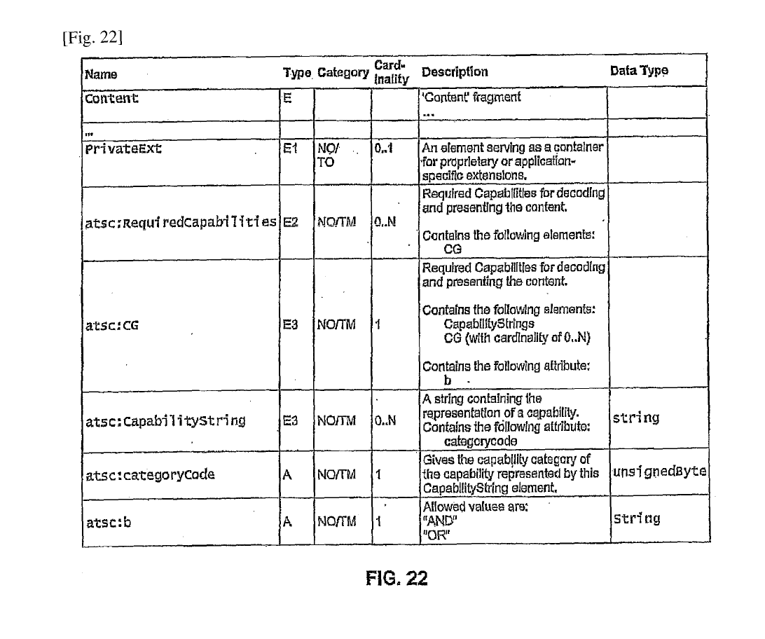

New elements for signaling required capability according to this variant are shown in FIG. 22.

With respect to FIG. 22, in an alternative embodiment the attribute atsc:categoryCode may be made optional as follows:

| | | | | | |
|---|---|---|---|---|---|
| atsc:categoryCode | A | NO/TM | 0 . . . 1 | Gives the capability category of | unsignedShort |
| | | | | the capability represented by this | |
| | | | | CapabilityString element. | |

The list of code points in CapabilityString elements (if present) and other CG elements (if present) combined with the logical operation (AND/OR) as specified by the value of attribute b of the parent element CG specifies the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a RequiredCapabilities element, each listed CapabilityString element indicates a capability required. Each CapabilityString element shall include a categoryCode attribute associating the string with a category and registration authority per Table 2 below.

The required capability code list in atsc:CapabilityCodes sub-element shall contain at most one capability code of each capability category unless a particular capability code C1 allows multiple capability codes to be present for the capability category as described in its Reference section A.2.xx.

When the list of required capability codes in atsc:CapabilityCodes sub-element in an atsc:RequiredCapabilities element contains a capability code C1 such that V1 is equal to (C1 & 0x0F00)>>16 and V1 is in the range of 0x01 to 0x05, inclusive, any atsc:CapabilityString sub-element in the same atsc:RequiredCapabilities element shall not have atsc:categoryCode value equal to V1 unless the associated capability code C1 allowsmultiple capability codes to be present for the capability category as described in its Reference section A.2.xx. Where & being bit-wise AND operator and >> being binary right shift operator.

In yet another embodiment elements atsc:CapabilityStrings, and atsc:CapabilityCodes may instead be called atsc:CS, atsc:CCo respectively. Other such abbreviations are also considered to be in the scope of this invention. The benefit here is to save number of bytes required to signal the XML data. Thus when listing several strings the representation as an example <atsc:CS>String1</atsc:CS>will require less bytes than <atsc:CapabilityStrings>String1</atsc:CapabilityStrings>.

In an alternative embodiment the allowed values for the attribute atsc:b could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc:b | A | NO/TM | 1 | Allowed values are: | unsignedByte |
| | | | | “1” | |
| | | | | “0” | |

In another embodiment some other data type e.g. int or unsignedInt may be used in place of unsignedByte.

In an alternative embodiment in addition to AND, OR Boolean operations other type of Boolean operations e.g. NOT, NAND, NOR, XOR, XNOR may be supported. For example this may be done as follows:

| | | | | | |
|---|---|---|---|---|---|
| atsc:b | A | NO/TM | 1 | Allowed values are: | String |
| | | | | “AND” | |
| | | | | “OR” | |
| | | | | “NOT” | |
| | | | | “NAND” | |
| | | | | “NOR” | |
| | | | | “XOR” | |
| | | | | “XNOR” | |

Example XML Schema for this variant is shown below.

```
<?xml version=“1.0” encoding=“UTF-8”?>
<xs:schema xmlns:xs=“http://www.w3.org/2001/XMLSchema” >
<xs:element name=“RequiredCapabilities” type=“CapabilitiesOperType” />
<xs:complexType name=“CapabilitiesOperType”>
<xs:sequence>
<xs:element name=“CG” type=“RequiredCapabilitiesType” minOccurs=“0” maxOccurs=“unbounded”/>
</xs:sequence>
</xs:complexType>
<xs:complexType name=“RequiredCapabilitiesType”>
            <xs:sequence>
                  <xs:element name=“CapabilityStrings” type=“CCStringType” minOccurs=“0”
maxOccurs=“unbounded”/>
                  <xs:element name=“CG” type=“RequiredCapabilitiesType” minOccurs=“0”
maxOccurs=“unbounded”/>
            </xs:sequence>
            <xs:attribute name=“b” type=“bEnumType” use=“required”/>
</xs:complexType>
<xs:simpleType name=“bEnumType”>
      <xs:restriction base=“xs:string”>
  <xs:enumeration value=“AND” />
  <xs:enumeration value=“OR” />
      </xs:restriction>
      </xs:simpleType>
<xs:simpleType name=“CCSSMixedType”>
            <xs:union memberTypes=“xs:unsignedShort xs:string”/>
</xs:simpleType>
<xs:complexType name=“CCStringType”>
      <xs:simpleContent>
            <xs:extension base=“CCSSMixedType”>
                  <xs:attribute name=“categorycode” type=“xs:unsignedByte” use=“required”/>
            </xs:extension>
      </xs:simpleContent>
</xs:complexType>
</xs:schema>
```

In an alternative embodiment the XML schema may use part of the following schema:

```
<?xml version=“1.0” encoding=“UTF-8”?>
<xs:schema xmlns:xs=“http://www.w3.org/2001/XMLSchema”>
<xs:element name=“RequiredCapabilities”
type=“RequiredCapabilitiesType” />
<xs:complexType name=“RequiredCapabilitiesType”>
<xs:sequence>
<xs:element name=“CapabilityStrings” type=“CCStringType”
minOccurs=“0” maxOccurs=“unbounded”/>
</xs:sequence>
</xs:complexType>
<xs:simpleType name=“CCSSMixedType”>
            <xs:union memberTypes=“xs:unsignedShort xs:string”/>
</xs:simpleType>
<xs:complexType name=“CCStringType”>
      <xs:simpleContent>
            <xs:extension base=“CCSSMixedType”>
                  <xs:attribute name=“categorycode”
                  type=“xs:unsignedByte” use=“optional”/>
            </xs:extension>
      </xs:simpleContent>
</xs:complexType>
</xs:schema>
```

Valid XML Data representation examples according to the above example XML schema is shown below.

### Example 1

```
            Required capabilities of
            ( (http AND hevc AND video/mp4) AND (5=audio/vorbis
            OR 5=audio/PCMA OR 5=audio/PCMU))
            i.e.
            ( (258 AND 1299 AND video/mp4) AND (5=audio/vorbis
            OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool4.xsd”>
      <CG b=“AND”>
            <CapabilityStrings
            categorycode=“1”>2</CapabilityStrings>
            <CapabilityStrings
            categorycode=“5”>19</CapabilityStrings>
            <CapabilityStrings
            categorycode=“3”>video/mp4</CapabilityStrings>
            <CG b=“OR”>
                  <CapabilityStrings
                  categorycode=“5”>audio/vorbis</CapabilityStrings>
                  <CapabilityStrings
                  categorycode=“5”>audio/PCMA</
                  CapabilityStrings>
                  <CapabilityStrings
                  categorycode=“5”>audio/PCMU</
                  CapabilityStrings>
            </CG>
      </CG>
      </RequiredCapabilities>
```

### Example 2

```
            Required capabilities of
            ( (http AND video/mp4) AND (hevc OR avc) AND
(5=audio/vorbis OR 5=audio/PCMA OR 5=audio/PCMU))
            i.e.
            ( (258 AND video/mp4) AND (1299 OR 1282) AND
(5=audio/vorbis OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool4.xsd”>
      <CG b=“AND”>
            <CapabilityStrings
            categorycode=“1”>2</CapabilityStrings>
            <CapabilityStrings
            categorycode=“3”>video/mp4</CapabilityStrings>
            <CG b=“OR”>
                  <CapabilityStrings
                  categorycode=“5”>2</CapabilityStrings>
                  <CapabilityStrings
                  categorycode=“5”>19</CapabilityStrings>
            </CG>
            <CG b=“OR”>
                  <CapabilityStrings
                  categorycode=“5”>audio/vorbis</CapabilityStrings>
                  <CapabilityStrings categorycode=
                  “5”>audio/PCMA</CapabilityStrings>
                  <CapabilityStrings categorycode=
                  “5”>audio/PCMU</CapabilityStrings>
            </CG>
      </CG>
</RequiredCapabilities>
```

### Example 3

```
            Required capabilities of
            ( ((http AND hevc AND video/mp4) OR (flute AND avc))
AND (5=audio/vorbis OR 5=audio/PCMA OR 5=audio/PCMU) )
            i.e.
            ( ((258 AND 1299 AND video/mp4) OR (257 AND 1282))
AND (5=audio/vorbis OR 5=audio/PCMA OR 5=audio/PCMU) )
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool4.xsd”>
      <CG b=“AND”>
            <CG b=“OR”>
                  <CG b=“AND”>
                        <CapabilityStrings
                        categorycode=“1”>2</CapabilityStrings>
                        <CapabilityStrings
                        categorycode=“5”>19</CapabilityStrings>
                        <CapabilityStrings categorycode=
                        “3”>video/mp4</CapabilityStrings>
                  </CG>
                  <CG b=“AND”>
                        <CapabilityStrings
                        categorycode=“1”>1</CapabilityStrings>
                        <CapabilityStrings categorycode=
                        “5”>2</CapabilityStrings>
                  </CG>
            </CG>
            <CG b=“OR”>
                  <CapabilityStrings
                  categorycode=“5”>audio/vorbis</CapabilityStrings>
                  <CapabilityStrings categorycode=
                  “5”>audio/PCMA</CapabilityStrings>
                  <CapabilityStrings categorycode=
                  “5”>audio/PCMU</CapabilityStrings>
            </CG>
      </CG>
</RequiredCapabilities>
```

### <<Variant A5>>

A capabilities coalescing Boolean operation element is proposed which can specify Boolean operations (e.g. AND, OR) for combining capabilities. The capabilities can be represented by capability codes and/or capability strings elements. A recursive structure is defined such that the Boolean operations can be nested to any desired level. This variant uses a list of capability codes and/or list of capability string elements together as a single element.

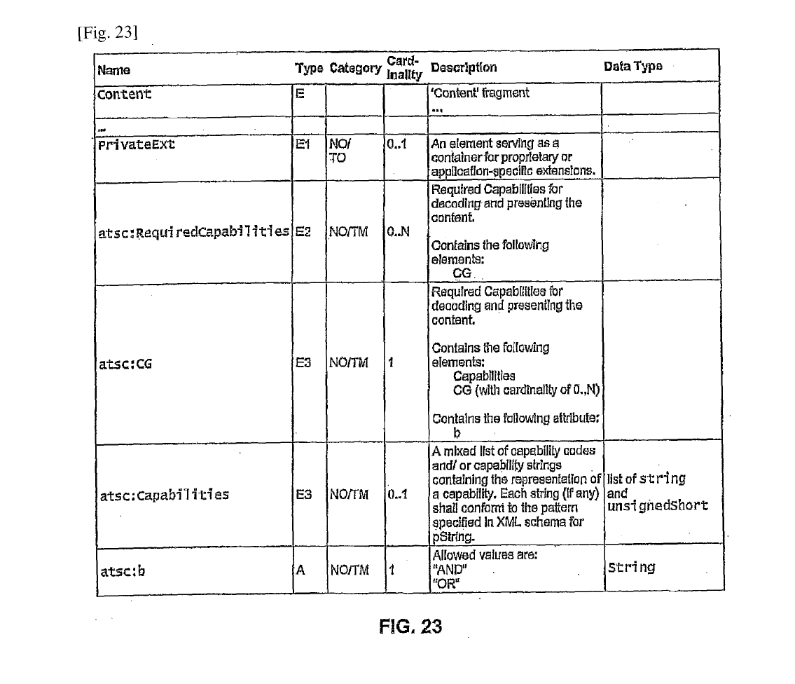

New elements for signaling required capability according to this variant are shown in FIG. 23.

With respect to FIG. 23, the list of code points (if any) and capability strings (if any) in one Capabilities element and other CG elements (if present) combined with the logical operation (AND/OR) as specified by the value of attribute b of the parent element CG specifies the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a RequiredCapabilities element, each listed CapabilityString element indicates a capability required in addition to those listed in the CapabilitieCodes element. Each CapabilityString element shall include a categoryCode attribute associating the string with a category and registration authority per Table 2.

The required capability code list in atsc:CapabilityCodes sub-element shall contain at most one capability code of each capability category unless a particular capability code C1 allows multiple capability codes to be present for the capability category as described in its Reference section A.2.xx.

When the list of required capability codes in atsc:CapabilityCodes sub-element in an atsc:RequiredCapabilities element contains a capability code C1 such that V1 is equal to (C1 & 0x0F00)>>16 and V1 is in the range of 0x01 to 0x05, inclusive, any atsc:CapabilityString sub-element in the same atsc:RequiredCapabilities element shall not have atsc:categoryCode value equal to V1 unless the associated capability code C1 allowsmultiple capability codes to be present for the capability category as described in its Reference section A.2.xx. Where & being bit-wise AND operator and >> being binary right shift operator.

In yet another embodiment elements atsc:CapabilityStrings, and atsc:CapabilityCodes may instead be called atsc:CS, atsc:CCo respectively. Other such abbreviations are also considered to be in the scope of this invention. The benefit here is to save number of bytes required to signal the XML data. Thus when listing several strings the representation as an example <atsc:CS>String1</atsc:CS>will require less bytes than <atsc:CapabilityStrings>String1</atsc:CapabilityStrings>.

In an alternative embodiment the allowed values for the attribute atsc:b could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc:b | A | NO/TM | 1 | Allowed values are: | unsignedByte |
| | | | | “1” (represents AND operation) | |
| | | | | “0” (represents OR operation) | |

In another embodiment some other data type e.g. int or unsignedInt may be used in place of unsignedByte.

In an alternative embodiment in addition to AND, OR Boolean operations other type of Boolean operations e.g. NOT, NAND, NOR, XOR, XNOR may be supported. For example this may be done as follows:

| | | | | | |
|---|---|---|---|---|---|
| atsc:b | A | NO/TM | 1 | Allowed values are: | String |
| | | | | “AND” | |
| | | | | “OR” | |
| | | | | “NOT” | |
| | | | | “NAND” | |
| | | | | “NOR” | |
| | | | | “XOR” | |
| | | | | “XNOR” | |

Example XML Schema for this variant is shown below.

In this example schema the element “Capabilities” is represented by element “C”.

```
<?xml version=“1.0” encoding=“UTF-8”?>
<xs:schema xmlns:xs=“http://www.w3.org/2001/XMLSchema” >
<xs:element name=“RequiredCapabilities”
type=“CapabilitiesOperType” />
<xs:complexType name=“CapabilitiesOperType”>
<xs:sequence>
<xs:element name=“CG” type=“RequiredCapabilitiesType”
minOccurs=“0” maxOccurs=“1”/>
</xs:sequence>
</xs:complexType>
<xs:complexType name=“RequiredCapabilitiesType”>
            <xs:sequence>
                  <xs:element name=“C” type=“CCSSType”
                  minOccurs=“0” maxOccurs=“1”/>
                  <xs:element name=“CG” type=
“RequiredCapabilitiesType” minOccurs=“0” maxOccurs=“unbounded”/>
            </xs:sequence>
            <xs:attribute name=“b” type=“bType” use=“required”/>
</xs:complexType>
<!--1= AND, 0=OR -->
<xs:simpleType name=“bType”>
            <xs:restriction base=“xs:byte”>
            <xs:minInclusive value=“0”/>
            <xs:maxInclusive value=“1”/>
            </xs:restriction>
</xs:simpleType>
<xs:simpleType name=“pString”>
  <xs:restriction base=“xs:string”>
    <xs:pattern value=‘([0-9]|[1-9][0-9]|1[0-9][0-9]|2[0-4][0-9]|25[0-5])=
    [a-zA-Z0-9/]*’/>
  </xs:restriction>
</xs:simpleType>
<xs:simpleType name=“CCSSMixedType”>
            <xs:union memberTypes=“xs:unsignedShort pString”/>
</xs:simpleType>
<xs:simpleType name=“CCSSType”>
            <xs:list itemType=“CCSSMixedType”/>
      </xs:simpleType>
</xs:schema>
```

Valid XML Data representation examples according to the above example XML schema is shown below.

### Example 1

```
            Required capabilities of
            ( (http AND hevc AND video/mp4) AND
            (5=audio/vorbis OR 5=audio/PCMA OR 5=audio/PCMU))
            i.e.
            ( (258 AND 1299 AND video/mp4) AND
            (5=audio/vorbis OR 5=audio/PCMA OR 5=audio/PCMU))
            are indicated as:
<?xml version=“1.0” encoding=“UTF-8”?>
<RequiredCapabilities
xmins:xsi=“http://www.w3.org/2001/XMLSchema-instance”
          xsi:noNamespaceSchemaLocation=“devcapBool5.xsd”>
            <CG b=“1”>
            <C>258 1299 3=video/mp4</C>
            <CG b=“0”>
                  <C>5=audio/vorbis 5=audio/
                  PCMA 5=audio/PCMU<C>
            </CG>
      </CG>
</RequiredCapabilities>
```

### Example 2

```
            Required capabilities of
            ( (http AND video/mp4) AND (hevc OR avc) AND
(5=audio/vorbis OR 5=audio/PCMA OR 5=audio/PCMU))
            i.e.
            ( (258 AND video/mp4) AND (1299 OR 1282) AND
(5=audio/vorbis OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool5.xsd”>
      <CG b=“1”>
            <C>258 3=video/mp4</C>
            <CG b=“0”>
                  <C>1299 1282</C>
            </CG>
            <CG b=“0”>
                  <C>5=audio/vorbis 5=audio/
                  PCMA 5=audio/PCMU<C>
            </CG>
      </CG>
</RequiredCapabilities>
```

### Example 3

```
            Required capabilities of
            ( ((http AND hevc AND video/mp4) OR (flute AND avc))
AND (5=audio/vorbis OR 5=audio/PCMA OR 5=audio/PCMU) )
            i.e.
            ( ((258 AND 1299 AND video/mp4) OR (257 AND 1282))
AND (5=audio/vorbis OR 5=audio/PCMA OR 5=audio/PCMU) )
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapBool5.xsd”>
      <CG b=“1”>
            <CG b=“0”>
                  <CG b=“1”>
                        <C>258 1299 3=video/mp4</C>
                  </CG>
                  <CG b=“1”>
                        <C>257 1282</C>
                  </CG>
            </CG>
            <CG b=“0”>
                  <C>5=audio/vorbis 5=audio/
                  PCMA 5=audio/PCMU</C>
            </CG>
      </CG>
</RequiredCapabilities>
```

### <<Variant B>>

A capabilities set element which can include capability codes and capability strings which could be grouped using Boolean AND/OR operations and a second level capability Boolean operation element which can flexibly represent further Boolean operations on initial AND/OR sets are defined.

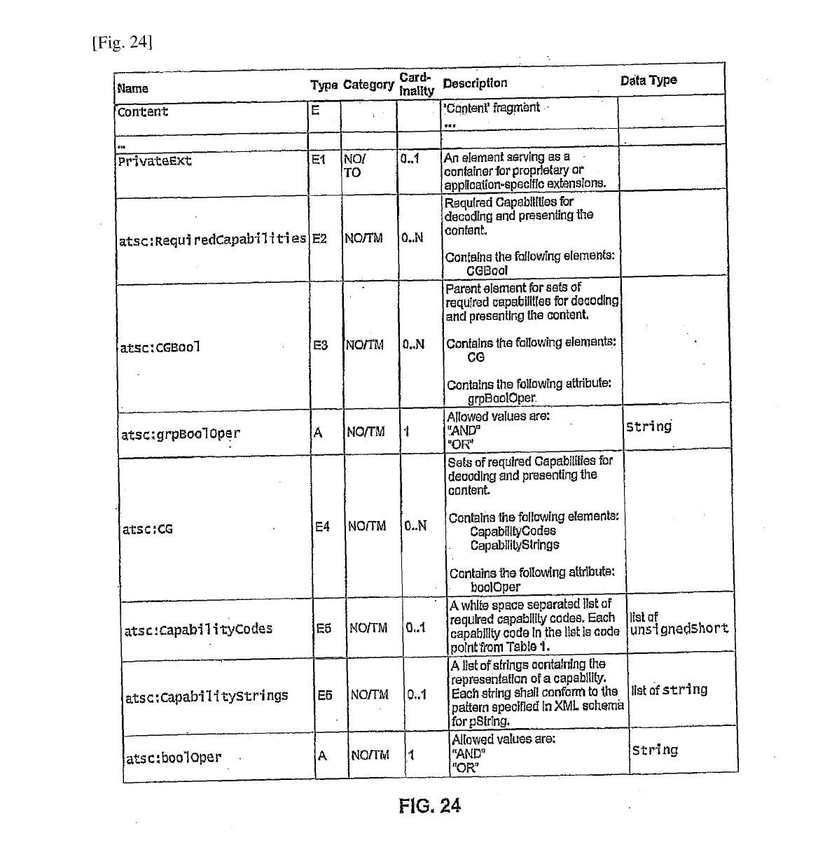

New elements for signaling required capability according to this variant are shown in FIG. 24.

With respect to FIG. 24, the list of code points in CapabilityCodes element (if present), the list of strings in CapabilityStrings element (if present) combined with the logical operation (AND/OR) as specified by the value of attribute boolOper of the parent element CG specifies a set of required capabilities. The set(s) of CG element(s) combined with the logical operation (AND/OR) as specified by the value of attribute grpBoolOper of the parent element CGBool specifies the required capabilities group. A logical AND operation of one or more CGBool elements inside the RequiredCapabilities element specified the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a RequiredCapabilities element, each string in the list of Strings in the CapabilityString element indicates a capability required in addition to those listed in the CapabilitieCodes element. Each string in the CapabilityString element shall conform to the pattern specified in XML schema for pString. Thus according to the pattern, for each string a capability category code (in the range of 0-255) shall be included in the string. This will be delimited with a specific delimiter (e.g. ‘=’ in the XML schema shown) followed by capability string. Capability string shall conform to the table 2. In alternate embodiment different delimiter (e.g. ‘-’ or ‘%’ or ‘,’ etc.) may be used. Also order of string and capability category code may be changed.

The required capability code list in atsc:CapabilityCodes sub-element shall contain at most one capability code of each capability category unless a particular capability code C1 allows multiple capability codes to be present for the capability category as described in its Reference section A.2.xx.

When the list of required capability codes in atsc:CapabilityCodes sub-element in an atsc:RequiredCapabilities element contains a capability code C1 such that V1 is equal to (C1 & 0x0F00)>>16 and V1 is in the range of 0x01 to 0x05, inclusive, any atsc:CapabilityString sub-element in the same atsc:RequiredCapabilities element shall not have atsc:categoryCode value equal to V1 unless the associated capability code C1 allowsmultiple capability codes to be present for the capability category as described in its Reference section A.2.xx. Where & being bit-wise AND operator and >> being binary right shift operator.

In yet another embodiment elements atsc:CapabilityStrings, and atsc:CapabilityCodes may instead be called atsc:CS, atsc:CCo respectively. Other such abbreviations are also considered to be in the scope of this invention. The benefit here is to save number of bytes required to signal the XML data. Thus when listing several strings the representation as an example <atsc:CS>String1</atsc:CS>will require less bytes than <atsc:CapabilityStrings>String1</atsc:CapabilityStrings>.

In an alternative embodiment the allowed values for the attribute atsc:grpBoolOper could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc: grpBoolOper | A | NO/TM | 1 | Allowed values are: | unsignedByte |
| | | | | “1” (represents AND | |
| | | | | operation) | |
| | | | | “0” (represents OR | |
| | | | | operation) | |

In another embodiment some other data type e.g. int or unsignedInt may be used in place of unsignedByte.

In an alternative embodiment the allowed values for the attribute atsc:boolOper could be 1 and 0 instead of “AND” and “OR”. Also the attribute could be named atsc:booleanoperation instead of atsc:b or some other name could be used.

In one embodiment this can be represented as:

| | | | | | |
|---|---|---|---|---|---|
| atsc: boolOper | A | NO/TM | 1 | Allowed values are: | unsignedByte |
| | | | | “1” (represents AND | |
| | | | | operation) | |
| | | | | “0” (represents OR | |
| | | | | operation) | |

In another embodiment some other data type e.g. int or unsignedInt may be used in place of unsignedByte.

In an alternative embodiment in addition to AND, OR Boolean operations other type of Boolean operations e.g. NOT, NAND, NOR, XOR, XNOR may be supported. For example this may be done as follows:

| | | | | | |
|---|---|---|---|---|---|
| atsc:b | A | NO/TM | 1 | Allowed values are: | String |
| | | | | “AND” | |
| | | | | “NOT” | |
| | | | | “NAND” | |
| | | | | “NOR” | |
| | | | | “XOR” | |
| | | | | “XNOR” | |

Example XML Schema for this variant is shown below.

```
<?xml version=“1.0” encoding=“UTF-8”?>
<xs:schema xmlns:xs=“http://www.w3.org/2001/XMLSchema” >
<xs:element name=“RequiredCapabilities”
type=“CapabilitiesGroupBoolType” />
<xs:complexType name=“CapabilitiesGroupBoolType”>
            <xs:sequence>
                  <xs:element name=“CGBool”
type=“CapabilitiesGroupType” minOccurs=“0”
maxOccurs=“unbounded”/>
            </xs:sequence>
</xs:complexType>
<xs:complexType name=“CapabilitiesGroupType”>
            <xs:sequence>
                  <xs:element name=“CG”
type=“RequiredCapabilitiesType” minOccurs=“0”
maxOccurs=“unbounded”/>
            </xs:sequence>
            <xs:attribute name=“grpBoolOper” type=“bEnumType”
            use=“required”/>
</xs:complexType>
<xs:complexType name=“RequiredCapabilitiesType”>
            <xs:sequence>
                  <xs:element name=“CapabilityCodes”
type=“CCListType” minOccurs=“0” maxOccurs=“1”/>
                  <xs:element name=“CapabilityStrings”
type=“CCStringListType” minOccurs=“0” maxOccurs=“1”/>
            </xs:sequence>
            <xs:attribute name=“boolOper” type=“bEnumType”
            use=“required”/>
</xs:complexType>
<xs:simpleType name=“bEnumType”>
            <xs:restriction base=“xs:string”>
                  <xs:enumeration value=“AND” />
                  <xs:enumeration value=“OR” />
            </xs:restriction>
</xs:simpleType>
<xs:simpleType name=“CCListType”>
      <xs:list itemType=“xs:unsignedShort”/>
</xs:simpleType>
<xs:simpleType name=“pString”>
  <xs:restriction base=“xs:string”>
    <xs:pattern value=‘([0-9]|[1-9][0-9]|1[0-9][0-9]|2[0-4][0-9]|25[0-5])=
    [a-zA-Z0-9/]*’/>
  </xs:restriction>
</xs:simpleType>
<xs:simpleType name=“CCStringListType”>
      <xs:list itemType=“pString”/>
</xs:simpleType>
</xs:schema>
```

Valid XML Data representation examples according to the above example XML schema is shown below.

### Example 1

```
            Required capabilities of
            ( (http AND hevc AND video/mp4) AND (5=audio/vorbis
            OR 5=audio/PCMA OR 5=audio/PCMU))
            i.e.
            ( (258 AND 1299 AND video/mp4) AND (5=audio/vorbis
            OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapVar2Bool2.xsd”>
<CGBool grpBoolOper=“AND”>
      <CG boolOper=“AND”>
      <CapabilityCodes>258 1299</CapabilityCodes>
      <CapabilityStrings>3=video/mp4</CapabilityStrings>
      </CG>
      <CG boolOper=“OR”>
      <CapabilityStrings>5=audio/vorbis 5=audio/PCMA 5=audio/
      PCMU</CapabilityStrings>
      </CG>
</CGBool>
</RequiredCapabilities>
```

### Example 2

```
            Required capabilities of
            ( (http AND video/mp4) AND (hevc OR avc) AND
(5=audio/vorbis OR 5=audio/PCMA OR 5=audio/PCMU))
            i.e.
            ( (258 AND video/mp4) AND (1299 OR 1282) AND
(5=audio/vorbis OR 5=audio/PCMA OR 5=audio/PCMU))
            are indicated as:
<?xml version=“1.0” encoding=“UTF-8”?>
<RequiredCapabilities
xmlns:xsi=“http://www.w3.org/2001/XMLSchema-instance”
          xsi:noNamespaceSchemaLocation=“devcapVar2Bool2.xsd”>
<CGBool grpBoolOper=“AND”>
      <CG boolOper=“AND”>
      <CapabilityCodes>258</CapabilityCodes>
      <CapabilityStrings>3=video/mp4</CapabilityStrings>
      </CG>
      <CG boolOper=“OR”>
      <CapabilityCodes>1299 1282</CapabilityCodes>
      </CG>
      <CG boolOper=“OR”>
      <CapabilityStrings>5=audio/vorbis 5=audio/PCMA 5=audio/
      PCMU</CapabilityStrings>
      </CG>
</CGBool>
</RequiredCapabilities>
```

### Example 3

Required capabilities of
( ((http AND hevc AND video/mp4) OR (flute AND avc))
AND (5=audio/vorbis OR 5=audio/PCMA

OR 5=audio/PCMU) )

i.e.
( ((258 AND 1299 AND video/mp4) OR (257 AND 1282))
AND (5=audio/vorbis OR

5=audio/PCMA OR 5=audio/PCMU) )

are indicated as:

<?xml version=“1.0” encoding=“UTF-8”?>
<RequiredCapabilities
xmlns:xsi=“http://www.w3.org/2001/XMLSchema-instance”

xsi:noNamespaceSchemaLocation=“devcapVar2Bool2.xsd”>

<CGBool grpBoolOper=“OR”>

<CG boolOper=“AND”>
<CapabilityCodes>258 1299</CapabilityCodes>
<CapabilityStrings>3=video/mp4</CapabilityStrings>
</CG>
<CG boolOper=“AND”>
<CapabilityCodes>257 1282</CapabilityCodes>
</CG>
</CGBool>

<CGBool grpBoolOper=“AND”>

<CG boolOper=“OR”>
<CapabilityStrings>5=audio/vorbis 5=audio/PCMA
5=audio/PCMU</CapabilityStrings>
</CG>

</CGBool>
</RequiredCapabilities>

In an alternative embodiment the data type unsigned Int may be used instead of unsigned short for elements in the list of capability codes (i.e. in CapabilityCodes element) and/or for the attribute of category code (i.e. categorycode) for the capability string (e.g. CapabilityString).

In alternative embodiment additional namespace qualifier may be added for an xml element/attributes/type. For example <xs:complexType name=“CCStringType”> may instead be called xs:complexType name=“atsc3:CCStringType”> or xs:complexType name=“atsc:CCStringType”> where atsc3 and atsc respectively indicate namespace.

Similarly for example <xs:element name=“CapabilityCodes” . . . may instead be called <xs:element name=“atsc3:CapabilityCodes” . . . or <xs:element name=“atsc:CapabilityCodes” . . . where atsc3 and atsc respectively indicate namespace.

In other embodiment some of the elements or sub-elements may instead be signalled as attributes.

In other embodiment some of the attributes may instead be signalled as elements or sub-elements.

In other embodiments some of the elements above may be changed from E2 to E1 or in general from any EN to E(N−i) or from any EM to E(M+j) for any i and j.

In other embodiments the cardinality of some of the elements may be changed. For example cardinality may be changed from “1” to “1 . . . N” or cardinality may be changed from “1” to “0 . . . N” or cardinality may be changed from “1” to “0 . . . 1”.

Additionally in some embodiments the XML schema pattern value:

<xs:pattern value=′([0-9]|[1-9][0-9]|1[0-9][0-9]|2[0-4][0-9]|25[0-5])=[a-zA-Z0-9/]*′/>
may instead be represented using alterative regular expression such as but not limited to the following

<xs:pattern value=′([0-9]|[1-9][0-9]|1[0-9][0-9]|2[0-4][0-9]|25[0-5])=[a-zA-Z0-9/]+′/>

or
<xs:pattern value=′\b([0-9]|[1-9][0-9]|1[0-9][0-9]|2[0-4][0-9]|25[0-5])=[a-zA-Z0-9/]*\b′/>
Or
<xs:pattern value=′\b([0-9]|[1-9][0-9]|1[0-9][0-9]|2[0-4][0-9]|25[0-5])=[a-zA-Z0-9/]+\b′/>All such exressions are

intended to be within the scope of this application. Where the first part of the pattern verifies that the value is between 0
to 255, inclusive. In other embodiments the value may instead be in some other range e.g. 0 to 127, inclusive or 0 to
1023, inclusive. Also in some embodiment a delimiter other than ‘=’ may be used (e.g. ‘,’ or ‘-‘, etc.).
Additionally an Augmented Backus-Naur Form (ANBF) syntax and semantics is described for device capabilities.

Formal ABNF/ BNF grammar is provided
Semantics for the reverse polish notation/ post-fix syntax is provided

A few variants may beincluded, such as for example,

Use of white-spaces as separators instead of a hex prefix code which can be easily parsed compared to prefix

code.

Use of ASCII (7 bit ASCII) or UTF-8 codes for capability strings

ABNF syntax for representing device capabilities is shown below.

The syntax is described using the Augmented Backus-Naur Form (ABNF) grammar defined in RFC 5234 (http://tools.ietf.org/html/rfc5234). Instead of a forward-slash “I” as in RFC 5234, the vertical bar symbol “|” is used to indicate alternatives. Rules are separated from definitions by an equal “=”, indentation is used to continue a rule definition over more than one line, literals are quoted with “ ”, parentheses “(” and “)” are used to group elements, optional elements are enclosed in “[” and “]” brackets, and elements may be preceded with <n>* to designate n or more repetitions of the following element; n defaults to 0.

ccode = “0x” 4hexdigit
capability_string_code = ubyte “=” 1*alphanum
profile_code = ccode
capability_code = ccode
ubyte = 1*3digit
boperator = and | or
and = “and”
or = “or”
expr = profile_code | capability_code | capability_string_code

| expr expr boperator

capabilities = expr
alphanum = alpha | digit
alpha = lalpha | ualpha
lalpha = “a” | “b” | “c” | “d” | “e” | “f” | “g” | “h” | “i” |
“j” | “k” | “l” | “m” | “n” | “o” | “p” | “q” | “r” |
“s” | “t” | “u” | “v” | “w” | “x” | “y” | “z”
ualpha = “A” | “B” | “C” | “D” | “E” | “F” | “G” | “H” | “I” |
“J” | “K” | “L” | “M” | “N” | “O” | “P” | “Q” | “R” |
“S” | “T” | “U” | “V” | “W” | “X” | “Y” | “Z”
digit = “0” | “1” | “2” | “3” | “4” | “5” | “6” | “7”
“8” | “9”
hexdigit = “0” | “1” | “2” | “3” | “4” | “5” | “6” | “7” |
“8” | “9” | “A” | “B” | “B” | “D” | “E” | “F”

Additional variations of the syntax are described below.

In a variant embodiment the syntax expression:

expr = profile_code | capability_code | capability_string_code

| expr expr boperator

may instead be expressed with any of the following varaints:

| ∘ | expr = profile_code WSP \| capability_code WSP \| |
|---|---|
| | capability_string_code WSP \| expr expr boperator |
| | WSP |
| ∘ | expr = profile_code WSP \| capability_code WSP \| |

capability_string_code WSP | expr WSP expr WSP
boperator WSP

where WSP is white space which may be expressed as:

| WSP | = SP / HTAB ; white space | |
|---|---|---|
| HTAB | = %x09 ; | horizontal tab |

In yet another embodiment the WSP may additionally include CRLF
(carriage return, line feed) and thus may be
expressed as:

| WSP | = SP \| HTAB \| CRLF ; whitespace | |
|---|---|---|
| HTAB | = %x09 | ; horizontal tab |

| | | |
|---|---|---|
| CRLF | = CR LF | ; carriage return line feed |

In yet another embodiment the occurrence of WSP in expressions may be changed to *WSP thus allowing multiple whitespaces.

In a variant embodiment instead of ASCII string being used to represent ca-pability_string_code, a UTF-8 string may be used. This may be represented as follows:

capability_string_code = ubyte “=” 1*utf8
where
utf8 = *( UTF8-char )

| | |
|---|---|
| UTF8-char | = UTF8-1 / UTF8-2 / UTF8-3 / UTF8-4 |

| | |
|---|---|
| UTF8-1 | = %x00-7F |
| UTF8-2 | = %xC2-DF UTF8-tail |
| UTF8-3 | = %xE0 %xA0-BF UTF8-tail / %xE1-EC 2( UTF8-tail ) / |
| | %xED %x80-9F UTF8-tail / %xEE-EF 2( UTF8-tail ) |
| UTF8-4 | = %xF0 %x90-BF 2( UTF8-tail ) / %xF1-F3 |
| | 3( UTF8-tail ) / |
| | %xF4 %x80-8F 2( UTF8-tail ) |
| UTF8-tail | = %x80-BF |

In a variant embodiment a predetermined prefix code may be used at the start of the capability_string_code. This code can help determine if a capability_string_code or ca-pability_code or profile_code is coded next.

For example when using a reserved prefix code of “0xFFFF” at the beginning of capability string, the representation capability_string_code will be as follows:

capability_string_code = “0xffff” ubyte “=” 1*alphanum
with alphanum defined as above.
Alternatively when using UTF-8 string the representation for
capability_string_code will be as follows
capability_string_code = “0xffff” ubyte “=” 1*utf8
with utf8 defined as above.

In a variant embodiment some of the definitions may be changed as follows:

alpha = %x41-5A / %x61-7A
digit = %x30-39
hexdigit = digit / A-to-F
A-to-F = “A” / “B” / “C” / “D” / “E” / “F”

In a variant embodiment some of the elements may be optional. For example the following representation may be used:

expr = [ profile_code | capability_code | capability_string_code
| expr expr boperator ]
In another embodiment following representation may be used
expr = [ profile_code | capability_code | capability_string_code ]
| expr expr boperator

Next a XML syntax and semantics to include the ABNF syntax described above are defined as follows.

TABLE X.1

| | | | Car- | | Data |
|---|---|---|---|---|---|
| Name | Type | Category | dinality | Description | Type |
| Content | E | | | ‘Content’ fragment | |
| | | | | . . . | |
| . . . | | | | | |
| PrivateExt | E1 | NO/TO | 0 . . . 1 | An element serving as a container for proprietary or | |
| | | | | application-specific extensions. | |
| atsc:RequiredCapabilities | E2 | NO/TM | 0 . . . N | Required Capabilities for decoding and presenting the content. | |
| | | | | Contains the following elements: | |
| | | | | Capabilities | |
| atsc:Capabilities | E3 | NO/TM | 0 . . . 1 | capability codes and/or capability strings containing the | string |
| | | | | representation of a capability. The Capabilities string shall | |
| | | | | conform to the normative ABNF syntax defined for | |
| | | | | capabilities. | |

The capabilities ABNF syntax represents required capabilities using a reverse polish notation.

The list of code points in capability_code (if present), the list of strings in ca-pability_string_code (if present) and other expr elements (if present) are combined with the logical operation (AND/OR) as specified by the value of boperator applied according to the reverse polish notation representation. The Capabilities XML element specifies the total required capabilities required in the receiver to be able to create a meaningful presentation of the content. Multiple occurrences of RequiredCapabilities elements represent alternative sets of required capabilities, the support of any one of which is sufficient to create a meaningful presentation.

Within a particular instance of a Capabilities element, each string in the ca-pability_string_code indicates a capability required in addition to those listed in the ca-pability_code (if present) and other expr elements (if present).

Additionally one or more of following constraints apply.

Each capability_code in the capabilities is code point from Table 1.
Each capability category code ubyte is a capability_category_code
associating the string with a category and

registration authority according to Table 2.

ubyte is in the range of 0 to 255, inclusive.

In some cases additionally one or more of following constraints may be applied:

Value 0x0000 is forbidden for ccode (i.e. for capability_code
and profile_code)
Value 0x0000 and 0xFFFF is forbidden for ccode (i.e. for
capability_code and profile_code).

In yet another embodiment some other values between 0x0000 and 0xFFFF may be kept reserved or forbidden.

XML Schema for Table X.1:

<?xml version=“1.0” encoding=“UTF-8”?>
<xs:schema xmlns:xs=“http://www.w3.org/2001/XMLSchema” >
<xs:element name=“RequiredCapabilities”
type=“RequiredCapabilitiesType” />
<xs:complexType name=“RequiredCapabilitiesType”>
<xs:sequence>

<xs:element name=“Capabilities” type=“xs:string”
minOccurs=“0” maxOccurs=“1”/>

</xs:sequence>
</xs:complexType>
</xs:schema>

A further variant of XML syntax and semantics is defined below.

In a variant embodiment the capabilities XML element may be included without a parent RequiredCapabilities element. This variant embodiment syntax and semantics is shown below.

TABLE X.2

| | | | Car- | | Data |
|---|---|---|---|---|---|
| Name | Type | Category | dinality | Description | Type |
| Content | E | | | ‘Content’ fragment | |
| | | | | . . . | |
| . . . | | | | | |
| PrivateExt | E1 | NO/TO | 0 . . . 1 | An element serving as a container for proprietary or | |
| | | | | application-specific extensions. | |
| atsc:Capabilities | E3 | NO/TM | 0 . . . 1 | Required capabilities for decoding and presenting the content signaled | string |
| | | | | using capability codes and/or capability strings. The Capabilities | |
| | | | | string shall conform to the normative ABNF syntax defined for | |
| | | | | capabilities. | |

The capabilities ABNF syntax represents required capabilities using a reverse polish notation.

The list of code points in capability_code (if present), the list of strings in ca-pability_string_code (if present) and other expr elements (if present) are combined with the logical operation (AND/OR) as specified by the value of boperator applied according to the reverse polish notation representation. The Capabilities XML element specifies the total required capabilities required in the receiver to be able to create a meaningful presentation of the content. Multiple alternative sets of required capabilities, the support of any one of which is sufficient to create a meaningful presentation could be signaled inside Capabilities XML element using a OR syntax inside capabilities string.

Additionally one or more of following constraints apply.

Each capability_code in the capabilities is code point from Table 1.
Each capability category code ubyte is a capability_category_code
associating the string with a category and

registration authority according to Table 2.

ubyte is in the range of 0 to 255, inclusive.

In some cases additionally one or more of following constraints may be applied:

Value 0x0000 is forbidden for ccode (i.e. for capability_code
and profile_code)
Value 0x0000 and 0xFFFF is forbidden for ccode (i.e. for
capability_code and profile_code).

In yet another embodiment some other values between 0x0000 and 0xFFFF may be kept reserved or forbidden.

XML Schema for Table X.2:

<?xml version=“1.0” encoding=“UTF-8”?>
<xs:schema xmlns:xs=“http://www.w3.org/2001/XMLSchema” >

<xs:element name=“Capabilities” type=“xs:string”
minOccurs=“0” maxOccurs=“1”/>

</xs:complexType>
</xs:schema>

An additional variant XML sytax and semantics to include the ABNF syntax described above is defined as follows.

In a variant embodiment the cardinality of Capabilities element may be 0 . . . N instead of 0 . . . 1 with alternate Capabilities elements representing alternative sets of required capabilities, the support of any one of which is sufficient to create a meaningful presentation.

This variant is shown below with corresponding XML schema.

TABLE X.3

| | | | Car- | | Data |
|---|---|---|---|---|---|
| Name | Type | Category | dinality | Description | Type |
| Content | E | | | ‘Content’ fragment | |
| | | | | . . . | |
| . . . | | | | | |
| PrivateExt | E1 | NO/TO | 0 . . . 1 | An element serving as a container for proprietary or | |
| | | | | application-specific extensions. | |
| atsc:Capabilities | E3 | NO/TM | 0 . . . 1 | Required capabilities for decoding and presenting the content signaled | string |
| | | | | using capability codes and/or capability strings. The Capabilities | |
| | | | | string shall conform to the normative ABNF syntax defined for | |
| | | | | capabilities. | |

The capabilities ABNF syntax represents required capabilities using a reverse polish notation.

The list of code points in capability_code (if present), the list of strings in ca-pability_string_code (if present) and other expr elements (if present) are combined with the logical operation (AND/OR) as specified by the value of boperator applied according to the reverse polish notation representation. The Capabilities XML element specifies the total required capabilities required in the receiver to be able to create a meaningful presentation of the content. Multiple occurrences of Capabilities elements represent alternative sets of required capabilities, the support of any one of which is sufficient to create a meaningful presentation.

Additionally one or more of following constraints apply.

Each capability_code in the capabilities is code point from Table 1.
Each capability category code ubyte is a capability_category_code
associating the string with a category and

registration authority according to Table 2.

ubyte is in the range of 0 to 255, inclusive.

In some cases additionally one or more of following constraints may be applied:

Value 0x0000 is forbidden for ccode (i.e. for capability_code and
profile_code)
Value 0x0000 and 0xFFFF is forbidden for ccode (i.e. for capability_code
and profile_code).

In yet another embodiment some other values between 0x0000 and 0xFFFF may be kept reserved or forbidden.

XML Schema for Table X.3:

<?xml version=“1.0” encoding=“UTF-8”?>
<xs:schema xmlns:xs=“http://www.w3.org/2001/XMLSchema”>

<xs:element name=“Capabilities” type=“xs:string” minOccurs=“0”
maxOccurs=“unbounded”/>

</xs:complexType>
</xs:schema>

Additionally syntax and semantics for indicating device capabilities may be as follows.

ABNF grammar syntax and semantics
XML element to encapsulate ABNF grammar

A few variants may be as follows.
Use of white-spaces as separators instead of a hex prefix code. This variant can be readily parsed compared to prefix code. Use of printing UTF-8 codes for capability strings

Device capabilities are signaled inside OMA BCAST service guide's Content fragment using private extension as described below.

Device Capabilities Related Content-Level Private Extensions

Elements from the ATSC 3 namespace may be used within the OMA PrivateExt element, to indicate ATSC 3 device capabilities related element, as listed in Table 5.x. The atsc:Capabilities XML element specifies the capabilities required in the receiver to be able to create an improved presentation of the content. Using this syntax multiple alternate sets of required capabilities may be expressed, the support for any one of which is sufficient to create an improved presentation. This can be done, for example, by using a logical or expression in the atsc:Capabilities element.

TABLE 5.x
Device Capabilities Related Content-Level Private Extensions

| | | | Car- | | Data |
|---|---|---|---|---|---|
| Name | Type | Category | dinality | Description | Type |
| Content | E | | | ‘Content’ fragment | |
| | | | | . . . | |
| . . . | | | | | |
| PrivateExt | E1 | NO/TO | 0 . . . 1 | An element serving as a container for proprietary or | |
| | | | | application-specific extensions. | |
| atsc:Capabilities | E3 | NO/TM | 0 . . . 1 | Required capabilities for decoding and presenting the content signaled | string |
| | | | | using capability codes, capability strings and Boolean operators | |
| | | | | (and/or). This string shall conform to the normative ABNF syntax | |
| | | | | defined for capabilities desribed in section 5.3.2.3.3.2 | |

Device Capabilities Syntax and Semantics

Device Capabilities Syntax and Semantics defines the syntax for the device capabilities indicated by capabilities. The syntax is described using the Augmented Backus-Naur Form (ABNF) grammar defined in RFC 5234 [1]. Instead of a forward-slash “/” as in RFC 5234, the vertical bar symbol “|” is used to indicate alternatives. Rules are separated from definitions by an equal “=”, indentation is used to continue a rule definition over more than one line, literals are quoted with “ ”, parentheses “(” and “)” are used to group elements, optional elements are enclosed in “[” and “]” brackets, and elements may be preceded with <n>* to designate n or more repetitions of the following element; n defaults to 0.

capabilities syntax may be as specified below.

| | |
|---|---|
| ccode | = 1*4HEXDIG |

capability_string_code = ubyte “=” 1*utf8

| | |
|---|---|
| ubyte | = 1*3DIGIT |

| | |
|---|---|
| utf8 | = *( UTF8-char ) |

| | |
|---|---|
| boperator | = and \| or |

| | |
|---|---|
| and | = “&” |

| | |
|---|---|
| or | = “\|” |

| | |
|---|---|
| expr | = ccode WSP \| capability_string_code WSP\| expr expr |
| | boperator WSP |

capabilities = expr

Additional constraints may include:

Each ccode is a code point from Table 1.
Each capability category code ubyte is a capability_category_code

associating the string with a category and registration authority according
to Table 2. ubyte is in the range of 0 to 255, inclusive.

UTF8-char shall obey syntax and semantics defined in RFC3629 [2].

Only visible (printing) utf-8 characters shall be used.

The final WSP at the end of capabilities ABNF string is removed

before including it inside XML atsc:Capabilities element.

Capabilities semantics may be as specified below.

ccode - This terminal symbol specifies a certain capability or capability
group. This symbol evaluates as “true” if and

only if the device has the capability identified.

capability_string_code - The first operand specifies the registry identified
by capability category code represented by

ubyte. The second operand specifies the capability or capability group
within that registry, and shall be as
specified in that registry. This symbol evaluates as true if and only if
the device has the capability identified.

boperator - This nonterminal symbol represents a Boolean operator
and - This terminal symbol is the logical-and symbol
or - This terminal symbol is the logical-or symbol
expr - This recursive nonterminal symbol represents the sequence of ccode
symbols, capability_string_code symbols,

and postfix logical operations. In a three operand case, when the third
operand is and, this symbol evaluates as
true if and only if both the first and second operands evaluate as true
and when the third operand is or, this
symbol evaluates as true if and only if one or both of the first and
second operands evaluate as true.

capabilities - This nonterminal represents required capabilities for

decoding and presenting the content signaled. If this
nonterminal evaluates as true, the required capabilities to be able
to create a meaningful presentation of the
content are present. Using this syntax it is possible to
express multiple alternate sets of required capabilities, t
he support for any one of which is sufficient to create a meaningful

presentation.

XML Schema

In an embodiment the XML schema as shown below may be used to represent the device capabilities XML element.

<?xml version=“1.0” encoding=“UTF-8”?>
<xs:schema xmlns:xs=“http://www.w3.org/2001/XMLSchema” >

<xs:element name=“Capabilities” type=“xs:string” minOccurs=“0”
maxOccurs=“1”/>

</xs:schema>

Variants:

A few variant embodiments are described below.

In a variant embodiment the syntax expression:

expr = ccode WSP | capability_string_code WSP| expr expr

boperator WSP may instead be expressed with any of the following
varaints:

expr = ccode “ ” | capability_string_code “ ” |
expr expr boperator “ ”
expr = ccode “ ” | capability_string_code “ ” |
expr expr boperator

In a variant embodiment the syntax expression:

| WSP is white space which may be expressed as: | |
|---|---|
| WSP | = SP ; white space |
| WSP is white space which may be expressed as: | |
| WSP | = SP / HTAB ; white space |
| HTAB | = %x09 ; horizontal tab |

In yet another embodiment the WSP may additionally include CRLF (carriage return, line feed) and thus may be expressed as:

| WSP | = SP \| HTAB \| CRLF ; whitespace | |
|---|---|---|
| HTAB | = %x09 | ; horizontal tab |

| | | |
|---|---|---|
| CRLF | = CR LF | ; carriage return line feed |

In yet another embodiment the occurrence of WSP in expressions may be changed to *WSP thus allowing multiple whitespaces.

In a variant embodiment the syntax may be further modified to avoid use of ubyte as follows:

| | |
|---|---|
| ccode | = 1*4HEXDIG |

capability_string_code = 1*3DIGIT “=” 1*utf8

| | |
|---|---|
| utf8 | = *( UTF8-char ) |

| | |
|---|---|
| boperator | = and \| or |

| | |
|---|---|
| and | = “&” |
| or | = “\|” |

| | |
|---|---|
| expr | = ccode WSP \| capability_string_code WSP\| expr expr |
| | boperator WSP |

capabilities = expr

In a variant embodiment the syntax may be further modified to avoid use of utf8 as follows:

| | |
|---|---|
| ccode | = 1*4HEXDIG |

capability_string_code = 1*3DIGIT “=” 1* UTF8-char

| | |
|---|---|
| boperator | = and \| or |

| | |
|---|---|
| and | = “&” |
| or | = “\|” |

| | |
|---|---|
| expr | = ccode WSP \| capability_string_code WSP\| expr expr |
| | boperator WSP |

capabilities = expr

In a variant embodiment the syntax may be further modified to use visible printing characters (VCHAR) instead of utf8 as follows:

| | |
|---|---|
| ccode | = 1*4HEXDIG |

capability_string_code = 1*3DIGIT “=” 1*VCHAR

| | |
|---|---|
| boperator | = and \| or |

| | |
|---|---|
| and | = “&” |

| | |
|---|---|
| or | = “\|” |

| | |
|---|---|
| expr | = ccode WSP \| capability_string_code WSP\| expr expr |
| | boperator WSP |

capabilities = expr

| | |
|---|---|
| VCHAR | = %x21-7E ; visible (printing) characters |

In a variant embodiment the syntax may be further modified to use different symbol for representing and or.

For example instead of using “&” and “|” to respectively represent

and and or, “&&” and “||” can be used to respectively represent and and
or.

For example instead of using “+” and “.” to respectively represent

and and or, “&&” and “||” can be used to respectively represent and and
or.

For example instead of using “and” and “or” to respectively represent

and and or, “&&” and “||” can be used to respectively represent and and
or.

Other different symbols could also be used instead of the examples given above to respectively represent and or.

In a variant embodiment UTF8-char shall obey syntax and semantics defined in RFC3629 but only single byte UTF characters may be used.

In a variant embodiment some of the definitions may be changed as follows:

alpha = %x41-5A / %x61-7A
digit = %x30-39
hexdigit = digit / A-to-F
A-to-F = “A” / “B” / “C” / “D” / “E” / “F”

In an alternative embodiment the name of various entities in ABNF syntax may be changed. For example instead of boperator, it may be called operator or b.

In another embodiment instead of ABNF syntax, BNF syntax or EBNF syntax may be used to represent required capabilities.

In an alternative embodiment in the syntax a forward-slash “/” may be used instead of the vertical bar symbol “|” to indicate alternatives.

In alternative embodiment additional namespace qualifier may be added for an xml element/attributes/type. For example <xs:complexType name=“CCStringType”> may instead be called xs:complexType name=“atsc3:CCStringType”> or xs:complexType name=“atsc:CCStringType”> where atsc3 and atsc respectively indicate namespace.

Similarly for example <xs:element name=“CapabilityCodes” . . . may instead be called <xs:element name=“atsc3:CapabilityCodes” . . . or <xs:element name=“atsc:CapabilityCodes” . . . where atsc3 and atsc respectively indicate namespace.

In other embodiment some of the elements or sub-elements may instead be signalled as attributes.

In other embodiment some of the attributes may instead be signalled as elements or sub-elements.

In other embodiments some of the elements above may be changed from E2 to E1 or in general from any EN to E(N−i) or from any EM to E(M+j) for any i and j.

In other embodiments the cardinality of some of the elements may be changed. For example cardinality may be changed from “1” to “1 . . . N” or cardinality may be changed from “1” to “0 . . . N” or cardinality may be changed from “1” to “0 . . . 1”.

It is to be understood that the claims are not limited to the precise configuration and components illustrated above. Various modifications, changes and variations may be made in the arrangement, operation and details of the systems, methods, and apparatus described herein without departing from the scope of the claims.

1. A method for receiving a device capability associated with a service guide:
(a) receiving a content fragment within said service guide;
(b) receiving capabilities syntax element within said content fragment that indicates required capabilities for decoding and presenting signaled content;
(c) wherein said capabilities syntax element includes:
(i) an element capability code (ccode) that represents a certain capability or capability group defined by 1 to 4 hexadecimal digits (1*4HEXDIG);
(ii) an element capability_string_code (capability_string_code) having a first operand (ubyte) that represents a registry identified by capability category code and a second operand (1*utf8) that specifies a capability or capability group within said registry, where said first operand (ubyte) is defined as 1 to 3 digits (1*3DIGIT) and said utf8 is defined as one or more UTF-8 characters (*(UTF8-char));
(d) decoding said service guide.

2. The method of claim 1, wherein said capabilities syntax element is expressed as follows:
<?xml version=“1.0” encoding=“UTF-8”?>
<!--Schema for device capabilities>
<xs:schema xmlns:xs=“http://www.w3.org/2001/XMLSchema” >
<xs:element name=“Capabilities” type=“xs:string” minOccurs=“0”
maxOccurs=“1”/>
</xs:schema>.
